(19) United States
(12) Patent Application Publication
(10) Pub. No.: US 2026/0241554 A1
(43) Pub. Date: Aug. 20, 2026

(54) GENERALIZABLE MOBILITY MODEL FOR ROBOTIC SYSTEMS

(71) Applicant: NVIDIA Corporation, Santa Clara, CA (US)

(72) Inventors: Wei LIU, Palo Alto, CA (US); Huihua ZHAO, San Jose, CA (US); Yan CHANG, San Jose, CA (US); Chenran LI, Emeryville, CA (US)

(73) Assignee: NVIDIA Corporation, Santa Clara, CA (US)

(21) Appl. No.: 19/219,628

(22) Filed: May 27, 2025

Related U.S. Application Data
(60) Provisional application No. 63/759,693, filed on Feb. 18, 2025.

(51) Int. Cl. B25J 9/16; B25J 9/00

(52) U.S. Cl. CPC B25J 9/163; B25J 9/0084; B25J 9/161

(57) ABSTRACT

In various examples, a generalizable mobility model can receive a state and identifier of a robot, and generate an action for the robot based on the state and the identifier. The state can identify a position, environment, and navigation goal of the robot while the identifier can indicate a type of the robot. The generalizable mobility model can use the identifier to generate an action for the robot to reach the navigation goal from its position based on the type of the robot, such as a humanoid, quadruped, or wheeled robot. The generalizable mobility model can be a distilled combination of multiple robot type-specific models, and can use the identifier to mimic type-specific actions output by the multiple robot type-specific models to transmit to the robot to move the robot.

### CROSS REFERENCE TO RELATED APPLICATIONS

This application claims the benefit of U.S. Provisional Application No. 63/759,693, filed on Feb. 18, 2025, the contents of which are hereby incorporated by reference in their entirety.

### BACKGROUND

Mobility models generate and transmit commands to move robots. A mobility model may be tailored to specific robot morphologies due to each morphology's unique kinematic constraints and complexities. Such models yield significant duplication of effort and data requirements for each, different robot morphology, and are specifically tailored for one morphology.

### SUMMARY

Embodiments of the present disclosure relate to generalizable mobility models for robotic systems. Systems and methods are disclosed that are applicable to various robots independent of the morphology of the robot. The systems and methods of the present disclosure distill morphology-specific policies into a single model which can mimic action outputs of each of the morphology-specific policies using a morphology-specific encoding, thereby enabling scalable and adaptive mobility of robotic systems. Each of the morphology-specific policies can be updated from a baseline imitation learning model using, e.g., residual reinforcement learning, to tailor output actions of each of the policies to a specific robot morphology.

In contrast to conventional systems, the systems and methods of the present disclosure include a system. The system can include one or more processors. The one or more processors can determine a state and an identifier of a robot, the identifier indicating a type of robot, from a plurality of types of robots, corresponding to the robot. The one or more processors can generate, based at least on a generalist action policy processing the state and the identifier, at least one action for the robot, wherein the generalist action policy was generated using a combination of a base action policy corresponding to the plurality of types of robots and one or more specialist action policies individually corresponding to different robot types of the plurality of types of robots. The one or more processors can cause the robot to move according to the at least one action.

In various embodiments, the base action policy is updated using imitation learning and a world model, the base action policy to receive at least one state of the robot as an input and output a base action to move the robot. The one or more specialist action policies can be updated using residual reinforcement learning, the one or more specialist action policies to receive the at least one state of the robot as an input and output a specialist action to move the robot. The one or more specialist action policies can be updated based at least on the base action policy, the specialist action being a combination of the base action and a residual action, the residual action to adapt the base action to a robot type of the robot. To generate the generalist action policy, the combination of the base action policy and the one or more specialist action policies can be distilled.

In various embodiments, to generate the generalist action policy, the one or more processors can generate, using the one or more specialist action policies, a plurality of specialist actions for the robot by inputting a plurality of states into the one or more specialist action policies. The one or more processors can generate, using each of the one or more specialist action policies, a plurality of normal distributions over the plurality of specialist actions. The one or more processors can combine the plurality of normal distributions. The one or more processors can distill the combination of the plurality of normal distributions into the generalist action policy by at least minimizing a divergence of the combination of the plurality of normal distributions. The state can include at least one of an environment of a robot, velocities of each joint of the robot, or a goal of the robot. The identifier can correspond to an embedding in an embedding space that identifies the robot as the type of robot from the plurality of types of robots.

In various embodiments, the at least one action can include a plurality of velocity commands each corresponding to a joint of the robot. To execute the at least one action, each of the plurality of velocity commands can be mapped to a respective joint of the robot. The plurality of types of robots can include at least a humanoid robot, an autonomous mobile robot (AMR), a wheeled robot, a warehouse vehicle or machine, or a quadruped robot.

In various embodiments, the one or more processors are included in at least one of: control system for an autonomous or semi-autonomous machine, a perception system for an autonomous or semi-autonomous machine, a system for performing one or more simulation operations, a system for performing one or more digital twin operations, a system for performing one or more light transport simulation, a system for performing collaborative content creation for 3D assets, a system for performing one or more wireless cellular transmissions using a wireless cellular network, a system that provides one or more cloud gaming applications, a system for performing one or more deep learning operations, a system implemented using an edge device, a system implemented using a robot, a system for performing one or more generative AI operations, a system for performing one or more conversational AI operations, a system for performing operations using one or more large language models (LLMs), a system for performing operations using one or more vision language models (VLMs), a system for performing operations using one or more multi-modal language models (MMLMs), a system for performing operations using one or more vision-language-action (VLA) models, a system for performing one or more conversational AI operations, a system for performing one or more synthetic data generation operations, a system for presenting at least one of virtual reality content, augmented reality content, or mixed reality content, systems using or deploying one or more inference microservices, systems that incorporate deploy one or more machine learning models in a service or microservice along with an OS-level virtualization package (e.g., a container), a system incorporating one or more virtual machines (VMs), a system implemented at least partially in a data center, or a system implemented at least partially using cloud computing resources.

The systems and methods of the present disclosure can include a method. The method can include determining, using one or more processors, a state and an embedding corresponding to a robot, the state determined using a world model and the embedding indicative of a type of the robot. The method can include generating, using the one or more processors and based at least on an action policy trained for deployment on a plurality of types of robots, a plurality of commands for individual joints of the robot, the state and the embedding being processed using the action policy to generate the plurality of commands. The method can include transmitting, using the one or more processors, the plurality of commands to the individual joints of the robot to direct and move the robot.

In various embodiments, the action policy can include a distilled combination of a plurality of robot type-specific action policies, wherein each of the plurality of robot type-specific action policies correspond to one type of the plurality of types of robots wherein, to generate the action policy. The method can further include generating, by the one or more processors, using each of the plurality of robot type-specific action policies, a plurality of normal distributions over a plurality of robot type-specific actions, where a plurality of states are input into each of the plurality of robot type-specific action policies and each of the plurality of robot type-specific action policies output the plurality of robot type-specific actions. The method can include combining, by the one or more processors, the plurality of normal distributions. The method can include distilling, by the one or more processors, the combination of the plurality of normal distributions into the action policy by at least minimizing a divergence of the combination of the plurality of normal distributions.

In various embodiments, the plurality of robot type-specific action policies are updated using reinforcement learning, the one or more processors further to, during the reinforcement learning, record an input and an output for each of the plurality of robot type-specific action policies, the input and the output used to generate the plurality of normal distributions. Weights of the plurality of robot type-specific action policies can be updated to convergence and frozen prior to generating the plurality of normal distributions, the plurality of robot type-specific action policies updated using a base model updated using imitation learning and the world model, where weights of the base model are frozen prior to updating the plurality of robot type-specific action policies.

The systems and methods of the present disclosure can include one or more processors. The one or more processors can include processing circuitry to cause performance of one or more control operations associated with a robot based at least on one or more actions generated using a generalist action policy, the generalist action policy generating the one or more actions (i) while conditioned using an embedding indicating a robot type from a plurality of robot types corresponding to the robot and (ii) based at least on the generalist action policy processing state information corresponding to the robot and an environment of the robot.

In various embodiments, the generalist action policy is trained using a teacher dataset generated using action outputs and latent states corresponding to specialist action policies associated with individual robot types of the plurality of robot types. The embedding can include a one-hot morphology encoding indicating the robot type. State information can be represented using at least a world model. The one or more control operations can correspond to one or more joints, actuators, or motors of the robot.

In various embodiments, the one or more processors are included in at least one of: control system for an autonomous or semi-autonomous machine, a perception system for an autonomous or semi-autonomous machine, a system for performing one or more simulation operations, a system for performing one or more digital twin operations, a system for performing one or more light transport simulation, a system for performing collaborative content creation for 3D assets, a system for performing one or more wireless cellular transmissions using a wireless cellular network, a system that provides one or more cloud gaming applications, a system for performing one or more deep learning operations, a system implemented using an edge device, a system implemented using a robot, a system for performing one or more generative AI operations, a system for performing one or more conversational AI operations, a system for performing operations using one or more large language models (LLMs), a system for performing operations using one or more vision language models (VLMs), a system for performing operations using one or more multi-modal language models (MMLMs), a system for performing operations using one or more vision-language-action (VLA) models, a system for performing one or more conversational AI operations, a system for performing one or more synthetic data generation operations, a system for presenting at least one of virtual reality content, augmented reality content, or mixed reality content, systems using or deploying one or more inference microservices, systems that incorporate deploy one or more machine learning models in a service or microservice along with an OS-level virtualization package (e.g., a container), a system incorporating one or more virtual machines (VMs), a system implemented at least partially in a data center, or a system implemented at least partially using cloud computing resources.

### BRIEF DESCRIPTION OF THE DRAWINGS

The present systems and methods for generalizable mobility models for robotic systems are described in detail below with reference to the attached drawing figures, wherein:

FIG. 1 is an example system for generating a generalizable mobility model for robotic systems, in accordance with at least some embodiments of the present disclosure;

FIG. 2 is an example specialist policy generator of FIG. 1, in accordance with at least some embodiments of the present disclosure;

FIG. 3 is an example general action policy generator of FIG. 1, in accordance with at least some embodiments of the present disclosure;

FIG. 4 is an example image generated by a simulation for the system of FIG. 1, in accordance with at least some embodiments of the present disclosure;

FIG. 5 illustrates various types of robots that the generalizable mobility model of FIG. 1 can generate actions for, in accordance with at least some embodiments of the present disclosure;

FIG. 6 illustrates simulation environments including multiple robots used to update policies of the system of FIG. 1, in accordance with at least some embodiments of the present disclosure;

FIG. 7 illustrates an experimental setup for the system of FIG. 1, in accordance with at least some embodiments of the present disclosure;

FIG. 8 illustrates results of the experimental setup of FIG. 7, in accordance with at least some embodiments of the present disclosure;

FIG. 9 illustrates an example base policy generator for the system of FIG. 1, in accordance with at least some embodiments of the present disclosure;

FIG. 10A illustrates an example of a generative world model for the system of FIG. 9, in accordance with at least some embodiments of the present disclosure;

FIG. 10B illustrates an example estimator model of FIG. 10A, in accordance with some embodiments of the present disclosure;

FIGS. 11A-C illustrates various processing operations of the generative world model of FIG. 10A, in accordance with at least some embodiments of the present disclosure;

FIG. 12 is a flow diagram of an example method for generating a base action, in accordance with at least some embodiments of the present disclosure;

FIG. 13 is an example data generation pipeline for the system of FIG. 9, in accordance with at least some embodiments of the present disclosure;

FIG. 14 illustrates example simulation data for the data generation pipeline of FIG. 13, in accordance with at least some embodiments of the present disclosure;

FIG. 15 is a flow diagram of an example method for generating simulated data, in accordance with at least some embodiments of the present disclosure;

FIG. 16A is a flow diagram of an example method for generating and transmitting an action to a robot using a generalizable mobility model, in accordance with at least some embodiments of the present disclosure;

FIG. 16B is a flow diagram of an example method for a robot moving according to commands provided by a generalizable mobility model, in accordance with at least some embodiments of the present disclosure;

FIG. 17A is an example of sensor locations having corresponding fields of view or sensory fields for example autonomous or semi-autonomous machines, in accordance with at least some embodiments of the present disclosure;

FIG. 17B is an illustration of an example of component and sensor locations on an autonomous or semi-autonomous vehicle, in accordance with at least some embodiments of the present disclosure;

FIG. 17C is a block diagram of an example system architecture for an autonomous or semi-autonomous vehicle, robot, and/or other machine type, in accordance with at least some embodiments of the present disclosure;

FIG. 17D is a block diagram of an example architecture of a computing system—such as a system-on-a-chip (SoC)—in accordance with at least some embodiments of the present disclosure;

FIG. 17E is a system diagram for communication between cloud-based server(s) and an example autonomous or semi-autonomous vehicle, robot, and/or other machine type, in accordance with at least some embodiments of the present disclosure;

FIG. 18 is a system diagram illustrating a three computer ecosystem, including a computing system for generating or creating artificial intelligence (AI)—such as AI training and validation data, a computing system for training artificial intelligence, and a computing system deploying the AI at the edge, in accordance with at least some embodiments of the present disclosure;

FIG. 19 is a block diagram of an example computing system for generative artificial intelligence (AI), in accordance with at least some embodiments of the present disclosure; and

FIG. 20 is a block diagram of an example computing device, in accordance with at least some embodiments of the present disclosure.

### DETAILED DESCRIPTION

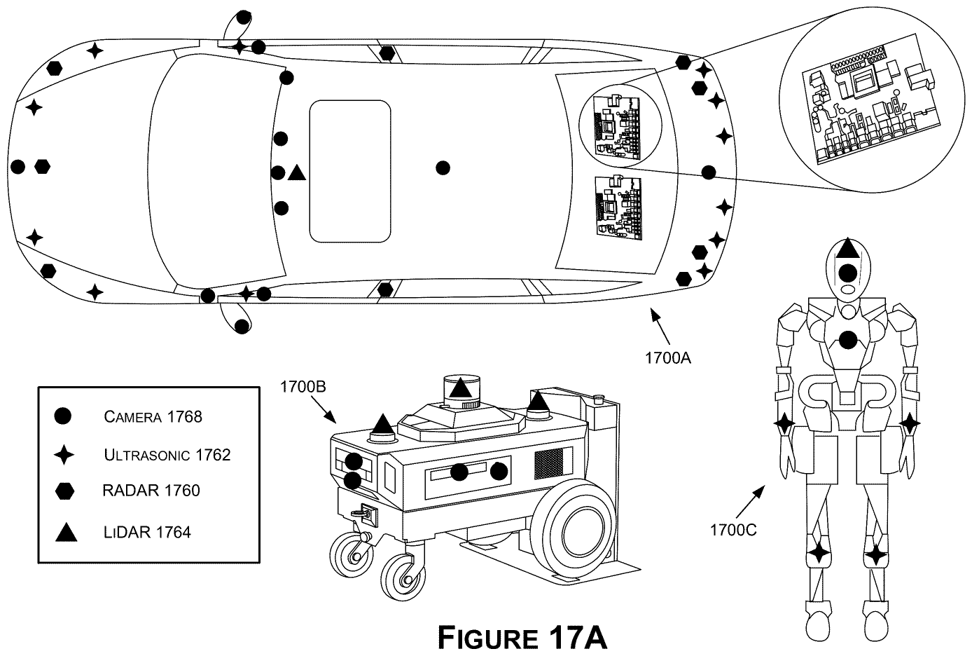

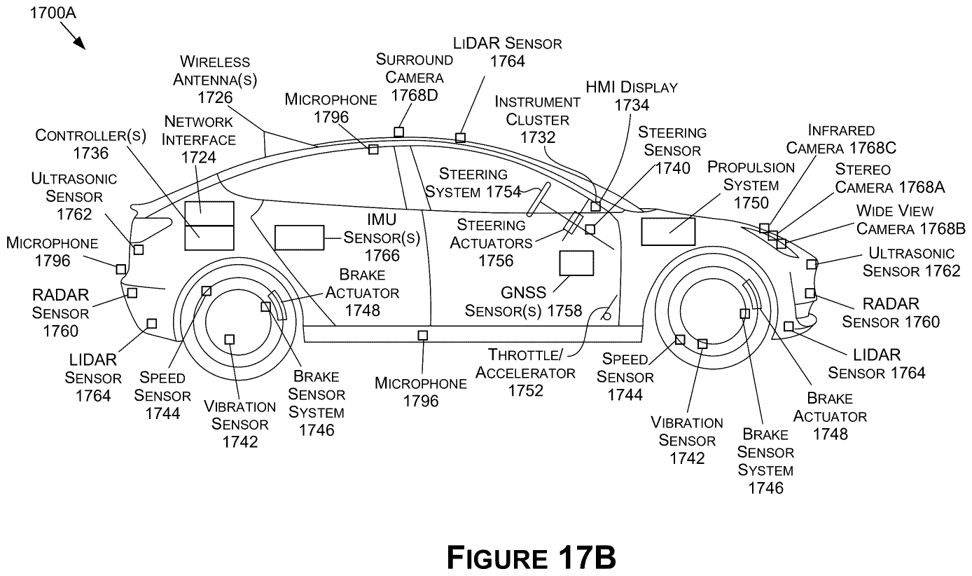

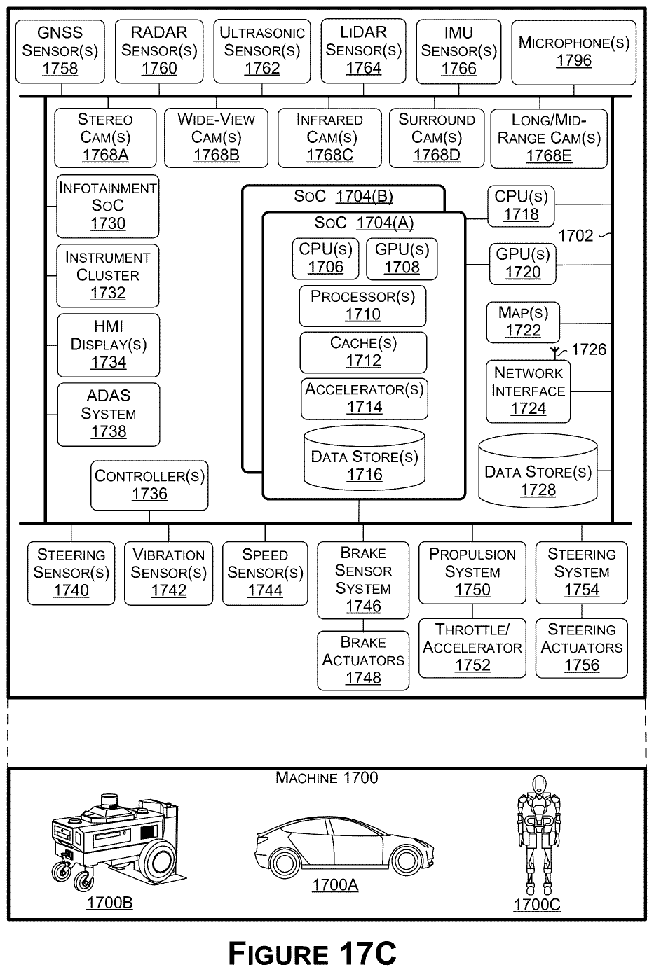

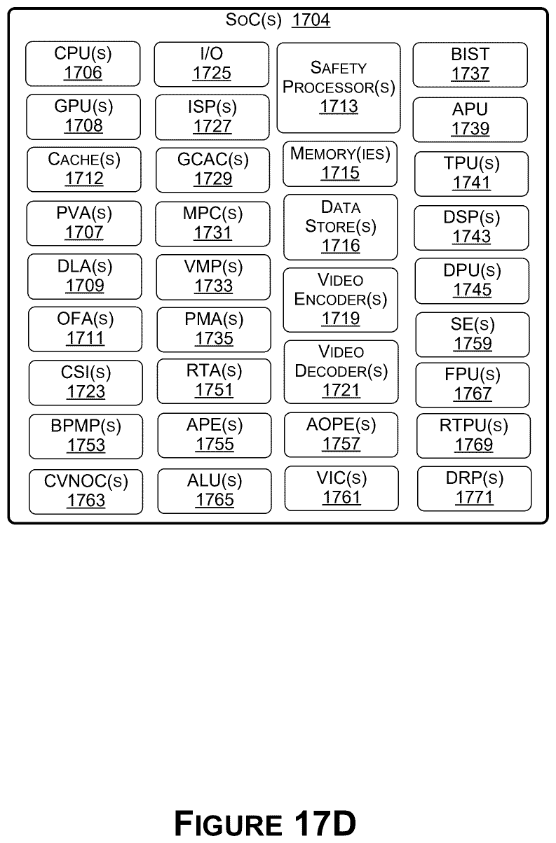

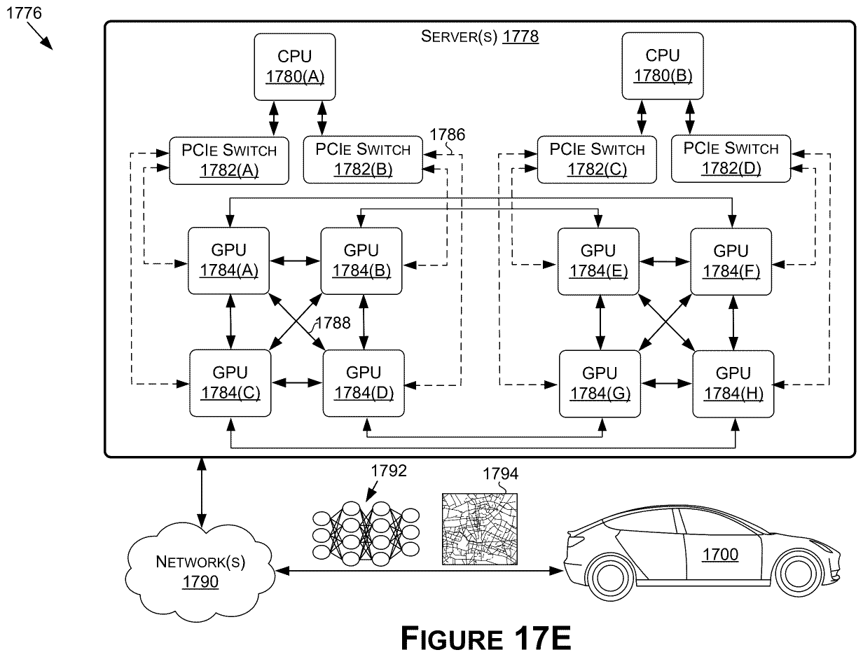

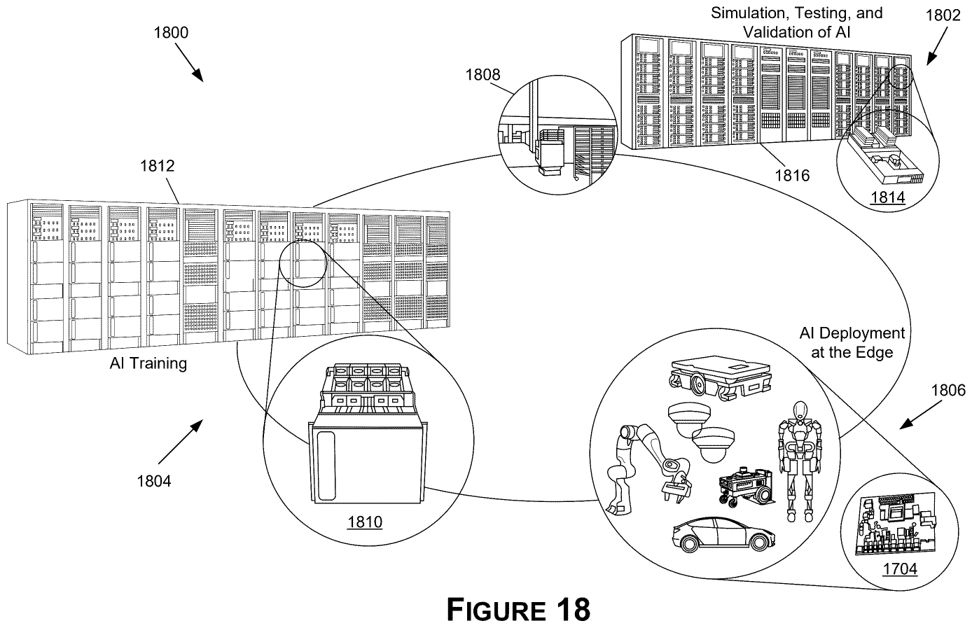

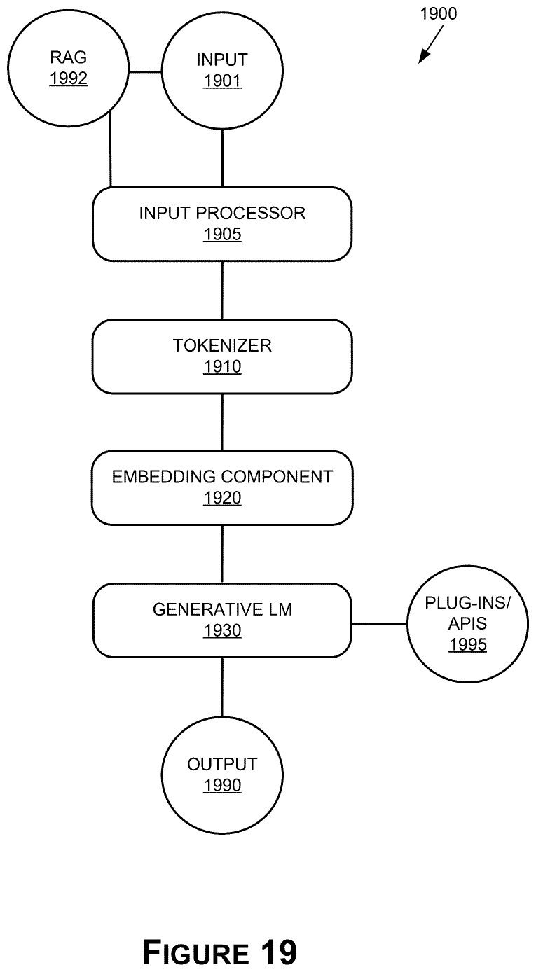

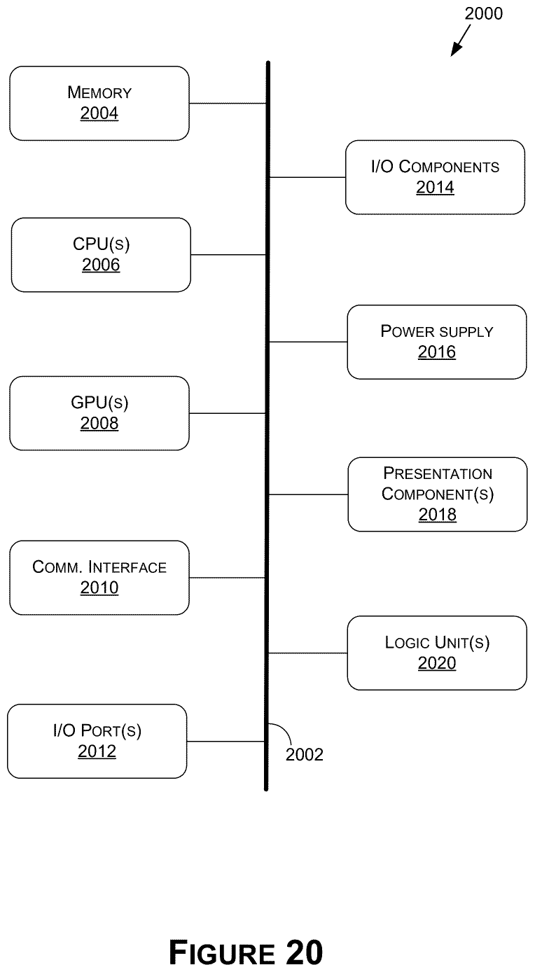

Systems and methods are disclosed related to generalizable mobility models for robotic systems. Although the present disclosure may be described with respect to an example autonomous or semi-autonomous vehicle, robot, and/or other machine type 1700 (alternatively referred to herein as “vehicle 1700,” “ego-vehicle 1700,” “machine 1700,” “ego-machine 1700,” “robot 1700,” and/or “ego-robot 1700,” an example of which is described with respect to FIGS. 17A-17E), this is not intended to be limiting. For example, the systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms (e.g., autonomous mobile robots (AMRs), humanoid robots, robotic arms and/or end-effectors, warehouse vehicles, off-road vehicles, vehicles coupled to one or more trailers, flying vessels, watercraft, shuttles (e.g., robotaxis), emergency response vehicles, motorcycles, electric or motorized bicycles, aircraft, construction vehicles, underwater craft (e.g., piloted or unpiloted submarines), drones, and/or other vehicle, robot, or machine types. In addition, although the present disclosure may be described with respect to mobility models for robotic systems, this is not intended to be limiting, and the systems and methods described herein may be used in augmented reality (AR), virtual reality (VR), mixed reality (MR), robotics, security and surveillance (e.g., smart cities), autonomous or semi-autonomous machine applications, industrial manufacturing, simulation, and/or any other technology spaces where mobility models may be used. In some embodiments, the systems, methods, and/or processes described herein may be executed using similar components, features, and/or functionality to those of example machine 1700 of FIGS. 17A-17E, example computing ecosystem 1800 of FIG. 18, example generative language model system 1900 of FIG. 19, and/or example computing device 2000 of FIG. 20.

Robotics has experienced significant advances in both industry and daily life, driving the need for collaborative robots to handle increasingly complex tasks. However, developing robust cross-robot type navigation policies remains challenging due to the many differences in morphological features, kinematics, articulation, control, and sensor configurations among diverse robotic platforms. These discrepancies complicate efforts to create a universal policy that is both robust and adaptable in real-world settings. Classical (e.g., decomposed or modular) navigation stacks excel on specific robots (e.g., wheeled platforms) but often require extensive retuning or redevelopment in response to being applied to new robot types with distinct sensor suites and physical constraints. This reliance on per-robot optimizations drives interest in end-to-end learning approaches, particularly for scaling across multiple robots.

Imitation learning (IL) can leverage existing expert demonstrations and teacher policies. Despite its intuitive appeal, IL can succumb to covariate shift, where the policy encounters out-of-distribution states not seen during demonstrations. While advances in machine learning architectures and data augmentation techniques help mitigate these issues, adding more robot-specific factors increases data requirements and training complexity. Generating high-quality demonstrations for complex modalities (e.g., humanoids) further complicates pure IL approaches.

Reinforcement learning (RL) offers another path to obtaining type-specific policies, especially for tasks like locomotion. Yet, navigational RL remains limited by large search spaces and scarce rewards in natural environments. Residual RL addresses these issues by refining a pre-trained policy in a data-driven manner, leading to faster convergence and greater stability. In parallel, emerging Visual-Language-Action (VLA) models have shown promise for cross-robot type tasks but typically operate through a low-dimensional waypoint-based action space or open-loop planning stages, making them less effective for platforms with higher-dimensional dynamics.

To address at least the aforementioned shortcomings, this disclosure relates to systems and methods of deploying a single, generalizable mobility model (e.g., generalist policy, framework) to direct robots with different morphologies (e.g., embodiments, types, platforms), such as wheeled, humanoid, or quadruped robots. Conventional methods have attempted to provide a single policy to account for the kinematic and dynamic constraints of each type of robot, but have struggled to handle the wide variability, leading to suboptimal performance, lengthy training times of the model, or inefficiencies such as retraining the model for each robot. Such methods can include training a single network on multiple tasks or robot morphologies, transfer learning, using separate reinforcement learning (RL) models for each morphology, fine-tuning feedback controllers, or relying solely on imitation learning (IL). However, these existing methods can be time-consuming, data-intensive, and limited in its task performance, thereby failing to adapt to the constraints of each robot morphology. Additionally, conventional generalist models can fail to match performance of models specialized for each robot morphology without significant retraining overhead.

Systems and methods in accordance with the present disclosure can build upon an IL model and refine the IL model for each robot morphology using residual RL (e.g., residual RL network, model). The residual RL can add or correct (e.g., modify or refine) actions of the robot produced by the IL model (e.g., action policy), and can preserve navigation knowledge of the robot from the IL model while adapting to robot morphology-specific constraints. For example, the systems and methods of the present disclosure can enable collision avoidance while providing stable walking for humanoids and leg coordination for quadrupeds. The IL model can include a world model (e.g., environment model, simulation model, etc.) to provide perception and state representation of the environment of the robot to the residual RL model. Refining the IL model using residual RL can reduce training time and complexity compared to existing generalist models. To preserve the variability in control across different robot morphologies, the systems and methods can distill morphology-specific knowledge into the single model by using an entire Gaussian parameter set from each robot morphology. The IL model can be refined for each robot morphology using residual RL which can then be unified into a single, generalizable model to avoid joint multi-morphology training complexities and improve data and time efficiency compared to a continuous multi-morphology training.

To deploy the single, generalizable model across different robot morphologies, the single model can receive a one-hot morphology encoding (e.g., embedding) indicating a type of the robot. Based on the embedding, the single model can select the robot morphology-specific actions and behavior. The single model can receive a policy state (e.g., position, location, etc. of the robot) from the world model, and combine the policy state with the embedding to direct and move the robot.

The systems and methods in accordance with the present disclosure provides a general action policy that inherits the expertise of each specialist, enabling it to adapt seamlessly across various robot types. The framework and resulting action policy as described herein leverages imitation learning, residual reinforcement learning, and policy distillation. The initial IL step provides a strong baseline, while residual RL quickly adapts the model to each robot type's dynamics, and a final distillation step merges specialized policies into a single, generalist policy. The systems and methods described herein enable effective scaling to various robot types and environments.

The systems and methods in accordance with the present disclosure may be applied to various technical fields, such as robotic control and mobility, autonomous vehicles or machines, semi-autonomous vehicles or machines, or any other device with autonomous mobility. For example, the systems and methods of the present disclosure can be refined using residual RL for vehicles, flying vessels, watercrafts, bicycles, aircrafts, and/or any other type of vehicle as well as humanoid, tracked, modular, soft, industrial, service, medical, and/or any other type of robot. In various embodiments, the model can control one or more robots in parallel (e.g., at one time). The model can transmit instructions to multiple robots with different types to navigate within an environment.

In some embodiments, the systems and methods described herein may be performed within a simulation environment (e.g., NVIDIA's DriveSIM, ISAAC Sim, ISAAC Gym, ISAAC Lab, etc.) using simulated data (e.g., simulated environmental data and simulated sensor data of simulated sensors of a virtual or simulated vehicle, robot, or machine within the simulated environment). For example, simulated input data (e.g., map data, perception data, ego-motion data, tactile data, and/or any other data described herein) may be used to determine environments and navigation goals for various types of robots within a simulation which can be used to update the type-specific mobility models, etc., and this information may be used to perform operations associated with the virtual machine within the simulation environment. For example, the simulation can include a simulated controller to execute actions on the robots within the simulation. These simulated operations may be used to test performance of and update the underlying algorithms, systems, and/or processes prior to deploying them in the real-world. In some instances, the simulation may be used to generate synthetic training data—e.g., movement of the simulated robot, varying environments—from within the simulation. The synthetic training data (in addition to or alternatively from real-world data) may then be used or processed to update the mobility models till convergence of weights of the mobility models at which the mobility models are distilled into a single generalizable mobility model.

In any example, such as where a simulation environment is used for testing, validation, training, etc., the simulation environment and/or associated training data may be rendered or otherwise generated using one or more light transport simulation algorithms—such as one or more ray-tracing and/or path-tracing algorithms. Where light transport simulation is used, the simulation system may employ one or more dedicated ray-tracing hardware accelerators and/or processors (e.g., NVIDIA's RTX, or another real-time ray-tracing GPU, such as those that include one or more ray tracing (RT) cores) optimized for performing real-time or near real-time light transport simulation operations in conjunction with one or more other processors of the system (e.g., GPUs, CPUs, accelerators, etc.). In some embodiments, the simulation environment and/or one or more objects, features, or components thereof may be generated or managed within a three-dimensional (3D) content collaboration platform (e.g., NVIDIA's OMNIVERSE) that may be optimized or suitable for industrial digitalization, generative physical artificial intelligence, and/or other use cases, applications, and/or services. For example, the content collaboration platform or system may include a system for using or developing universal scene descriptor (USD) (e.g., OpenUSD) data for managing objects, features, scenes, etc. within a simulated environment, digital environment, etc. The platform may include real physics simulation (e.g., using NVIDIA's PhysX software developer kit (SDK)), in order to simulate real physics and physical interactions with simulations hosted by the platform. The platform may integrate OpenUSD along with ray tracing/path tracing/light transport simulation (e.g., NVIDIA's RTX rendering technologies) into software tools and simulation workflows for building, training, deploying, and/or testing AI systems—such as systems for testing, validating, training (e.g., machine learning models, neural networks, etc.), and/or other tasks related to automobiles, robots, other machine types, and/or other systems and applications. In some examples, the simulation environment may include a digital twin of a real environment, such as a digital twin of a specific stretch of roadway, a warehouse, a data center, an airport, a geographic area, a marine area, and/or any other real environment where autonomous or semi-autonomous vehicles or machines may operate. The simulated robot may be positioned in the simulation environment and provided a navigation goal within the simulation environment. The mobility models can generate actions for the simulated robots to reach the navigation goal within the simulated environment, and results of the movement of the simulated robot can be recorded and used to update the mobility models.

In some embodiments, teleoperation or remote control of a vehicle, robot, and/or other machine may be performed using a remote control or teleoperation system. For example, the systems and methods described herein may be used to transmit movement commands to robots that may be included in a visualization or mapping of an environment to aid a remote operator in controlling—or providing waypoints or other indications of control or navigation—an autonomous or semi-autonomous machine through an environment. As such, the remote operator may use the visual, audible, textual, and/or other clues or indicators generated using the systems and methods described herein to aid in navigating the vehicle, robot, machine, etc. through a real-world environment using the teleoperation system.

In some embodiments, the system and methods described herein may be deployed in a robotics application. For example, a robot or robotic system may include one or more onboard processors (e.g., CPUs, GPUs, hardware-based deep learning accelerators (DLAs), deep learning accelerator clusters (XNNs), neural processing units (NPUs), neural network accelerators (NNAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). The robotic system may use these processors to execute one or more machine learning models (e.g., language models, vision language models (VLMs), large language models (LLMs), vision-language-action (VLA) models, multi-modal language models (MMLMs), etc.) that allow it to perform complex tasks autonomously or semi-autonomously, such as interacting with and/or manipulating static and/or dynamic objects, or navigating environments using sensors such as cameras, LiDAR, RADAR, ultrasonic sensors, and more. For example, the robot system can execute at least one of the type-specific mobility models or the single generalizable mobility model to autonomously or semi-autonomously move in an environment. The system may use sensor fusion techniques to combine data from multiple sensors (e.g., cameras, infrared, LiDAR, RADAR, accelerometers) to create a comprehensive model of the robot's surroundings. This data may be processed locally on the robot or sent to remote servers for more computationally intensive tasks, such as 3D mapping or SLAM (Simultaneous Localization and Mapping). In one or more embodiments, data from individual robots (e.g., sensor data, task status, or environmental conditions) may be uploaded to the cloud, where centralized AI models can analyze and distribute optimized commands to an entire fleet. In some embodiments, the machine learning model(s) (e.g., language models, VLMs, VLAS, LLMs, MMLMs, diffusion models, NeRF models, DNNs, etc.) described herein may be used to allow the robot to perceive and reason about the environment and/or communicate with one or more other robots and/or persons in an environment. In some embodiments, the robot may communicate (e.g., using one or more network interface cards (NICs) and/or data processing units (DPUs)) with one or more locally hosted servers/computing devices and/or with one or more remotely located servers/computing devices (e.g., in one or more data centers).

In some embodiments, the system and methods described herein may be deployed in an in-vehicle infotainment (IVI) system or in-cabin experience (IX) application. For example, the infotainment system within a vehicle (e.g., cars, trucks, drones, construction equipment, robots, semi-autonomous vehicles, or autonomous vehicles) may include one or more onboard processors (e.g., CPUs, GPUs, hardware-based deep learning accelerators (DLAs), deep learning accelerator cluster (XNNs), neural processing units (NPUs), neural network accelerators (NNAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). and memory and/or storage (e.g., for storing entertainment content, navigation data, and user preferences). The system may use these processors to execute one or more machine learning models (e.g., language models) to enable features such as voice control, personalized media recommendations, dynamic navigation, and real-time communication with other services through network connectivity. For example, the mobility model may be applicable to vehicles, and can be executed by the system to perform dynamic navigation. The in-vehicle infotainment system may also use natural language processing (NLP) models to enable voice-based interaction. The one or more machine learning models may be stored locally or accessed through one or more APIs that connect to cloud services, enabling the system to process requests in real time or near real-time.

In some examples, the machine learning model(s) (e.g., deep neural networks, language models, LLMs, VLMs, multi-modal language models, vision-language-action (VLA) models, perception models, tracking models, fusion models, transformer models, diffusion models, encoder-only models, decoder-only models, encoder-decoder models, neural rendering field (NERF) models, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs—such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

Although examples may be described herein with respect to using machine learning models, such as neural networks, this is not intended to be limiting. For example, and without limitation, any of the various machine learning models and/or neural networks described herein may include any type of machine learning model, such as a machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoder neural networks, artificial neural networks (ANNs), convolutional neural networks (CNNs), recurrent neural networks (RNNs), perceptrons, Long/Short Term Memory (LSTM) networks, multi-layer perceptron (MLP) networks, deep stacking networks (DSNs), generative pre-training (GPT) models or networks, feed forward networks, radial basis function ANNs, self-organizing maps (SOMs), Kohonen maps, Hopfield networks, Boltzmann machine, deep belief neural networks, deconvolutional neural networks, generative adversarial networks (GANs), imitation learning models, world models, reinforcement learning models, residual reinforcement learning models, liquid state machines, modular neural networks, liquid state machines, sequence-to-sequence models, networks using transformer architectures, state space models (SSMs) (e.g., networks using Mamba architectures (e.g., Mamba-1, Mamba 2, etc.), networks using selective state space models, networks using structured state space sequence models, etc.), diffusion models (e.g., diffusion probabilistic models, score-based generative models, etc.), neural radiance field (NeRF) models, Gaussian splat models, Kolmogorov-Arnold networks (KANs), models with encoder-only architectures, models with decoder-only architectures, models with encoder-decoder architectures, generative machine learning models, language models, large language models (LLMs), vision language models (VLMs), multi-modal language models (MMLMs), large action models (LAMs), vision-language-action (VLA) models, etc.), and/or other types of machine learning models.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, watercraft, shuttles (e.g., robotaxis), emergency response vehicles, motorcycles, electric or motorized bicycles, aircraft, construction vehicles, underwater craft (e.g., piloted or unpiloted submarines), drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets (e.g., NVIDIA's Omniverse), cloud computing, and/or any other suitable applications.

Disclosed embodiments may be comprised in a variety of different systems such as automotive systems (e.g., a control system for an autonomous or semi-autonomous machine, a perception system for an autonomous or semi-autonomous machine, etc.), systems implemented using a robot, aerial systems, medial systems, boating systems, smart area monitoring systems, systems for performing deep learning operations, systems for performing simulation operations, systems for performing digital twin operations, systems implemented using an edge device, systems implementing language models—such as large language models (LLMs), vision language models (VLMs), vision-language-action (VLA) models, and/or multi-modal language models, systems using or deploying one or more inference microservices, systems that incorporate deploy one or more machine learning models in a service or microservice along with an OS-level virtualization package (e.g., a container), a system for performing one or more wireless cellular transmissions using a wireless cellular network, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

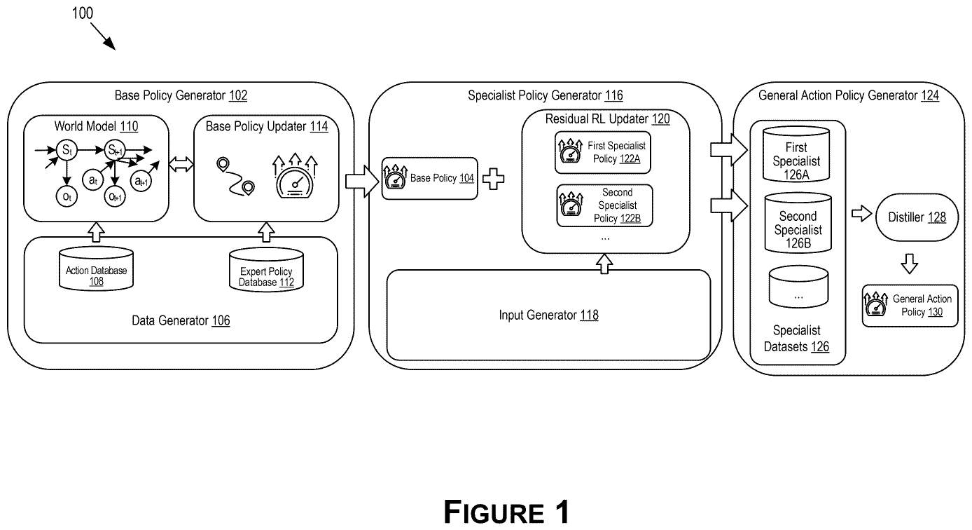

With reference to FIG. 1, FIG. 1 is an example system 100 for generating a single generalizable mobility model, in accordance with some embodiments of the present disclosure. It should be understood that this and other arrangements described herein are set forth only as examples. Other arrangements, components, features, and elements (e.g., machines, interfaces, functions, orders, groupings of functions, etc.) may be used in addition to or instead of those shown, and some elements may be omitted altogether. Further, many of the arrangements, components, features, elements, etc. described herein are functional entities that may be implemented as discrete or distributed components or in conjunction with other components, and in any suitable combination and location (e.g., on a local device, vehicle, or machine at the edge, on-premises—such as locally hosted servers, remotely located—such as in one or more computing or server devices in one or more data centers in the cloud, and/or at other locations). Various functions described herein as being performed by entities may be carried out by hardware, firmware, and/or software. For instance, various functions may be carried out using one or more processors (e.g., central processing units (CPU(s)), graphics processing units (GPU(s)), microprocessors, microcontrollers, embedded processors, digital signal processors (DSPs), image signal processors (ISPs), physics processing units (PPUs), field-programmable gate arrays (FPGAs), accelerator(s) (e.g., deep learning accelerators (DLAs), deep learning accelerator cluster (XNNs), neural network accelerators (NNAs), and/or neural processing units (NPUs), programmable vision accelerators (PVAs), optical flow accelerators (OFAs), etc.), application specific integrated circuits (ASICs), data processing units (DPUs), quantum processors, etc.) executing instructions stored in memory. In some embodiments, the systems, methods, and processes described herein may be executed using similar components, features, and/or functionality to those of example machine 1700 of FIGS. 17A-17E, example computing ecosystem 1800 of FIG. 18, example generative language model system 1900 of FIG. 19, and/or example computing device 2000 of FIG. 20.

The system 100 can generate a policy ne (e.g., general action policy 130) that can generate actions to provide point-to-point navigation across different robotic types (e.g., robot type 304, morphologies, embodiments, etc.), each characterized by different kinematics and dynamics. At time step t, a robot (e.g., robot 1700) can observe a state:

$${x}_{t} = ( {I}_{t} , {v}_{t} , {r}_{t} , e ) , \qquad ( 1 )$$

where Iₜ denotes current camera input (e.g., red green blue (RGB) images, image 202), vₜ is the measured velocity, rₜ provides route or goal-related information (e.g., an encoded waypoint or global plan), and e is an embodiment (e.g., type, morphology, etc.) embedding (e.g., indicator, encoding, identifier, type embedding 306, one-hot morphology encoding, etc.) that specifies the robot's morphology. e can be constant for a single robot during an action, and can vary across different types of robots. The type embedding can be the same for robots of a plurality of robots of a same type.

The policy π_{θ} can map xₜ to a velocity command uₜ=(vₜ, ωₜ) (e.g., command, control operation, etc.), which can then transmit to a controller (e.g., low-level controller, controller 220) of the robot for joint-level actuation (e.g., actuation of each of the joints, actuators, or motors of the robot). Transition dynamics of the environment, p(xₜ₊₁ | xₜ, uₜ), can depend on both the type of the robot and external factors in the environment, such as obstacles. A reward function R(•) can be defined that encourages generation of actions that provide efficient, collision-free progress to the goal. The objective can be to maximize the expected discounted return as defined by:

$$J ( θ ) = 𝔼 [ {\sum }_{t = 0}^{T} {γ}^{t} R ( {x}_{t} , {u}_{t} ) ] . \qquad ( 2 )$$

The systems and methods of the present disclosure can generate a single policy π_{θ} that leverages the type embedding e, thereby allowing shared knowledge across robot types while accommodating for distinct morphological constraints.

The system 100 can include at least one base policy generator 102. The base policy generator 102 can generate a base policy 104 (e.g., model, first action policy, action policy, first policy, locomotion policy, etc.). The base policy 104 can be a machine learning model (e.g., neural network, etc.), such as a multi-layer perceptron (MLP). The base policy 104 can generate actions for a plurality of robots with different types (e.g., morphologies, embodiments, etc.). The types of robots can include, but not limited to, humanoid, quadruped, wheeled, tracked, snaked, hexapod, aerial, aquatic, or swarm robots. The base policy generator 102 can apply imitation learning (IL) to acquire a general navigation baseline (e.g., general policy, etc.) for environmental states and actions applicable to a variety of robot types.

To generate the base policy 104, the base policy generator 102 can include at least one data generator 106. The data generator 106 can generate states (e.g., state 204, simulated states, etc.) for a robot. The states (e.g., xₜ) can include at least one of a position in the environment (e.g., position of the robot in a simulation), velocities of each joint, navigation goal (e.g., goal of the robot), route, position of each joint of the robot, environment of the robot, or type of the robot. The base policy 104 can receive the state as an input and output a base action to move at least one of the plurality of robots.

The data generator 106 can generate different environments in simulation, such as an office, warehouse, factory, construction zone, road, and/or outdoor space with various obstacles and components within the simulated environment. The data generator 106 can generate different positions of the robot within the simulated environment. The data generator 106 can include at least one action database 108 which can include one or more actions for the base policy 104 to generate the base action according to. For example, the action database 108 can include one or more routes or navigation goals for the robot to achieve and follow. Information (e.g., data, etc.) generated by the data generator 106 can be used to generate and update the base policy 104. The actions included in the action database 108 can include current actions or states of the robot. For example, the actions can indicate velocities on at least one of joints, actuators, or motors of the robot which can be used to generate an action for the robot.

The base policy generator 102 can include at least one world model 110 (e.g., environmental representation, cognitive, predictive model, world tokenizer, etc.) The world model 110 can receive the environment, states, and actions of the robot from the data generator 106, and generate representations of the environment (e.g., latent space, etc.) to capture dynamics of the environment, and predict transitions in the latent state. The latent state can be an internal representation of the robot and can be, for example, an encoding or vector respecting a layout of the environment, positions of objects in the environment, and a location (e.g., position) of the robot in the environment. Specifically, the world model can predict transitions in the latent space using:

$${s}_{t} = {f}_{ϕ} ( {s}_{t - 1} , {u}_{t - 1} ) , {\hat{o}}_{t} = {g}_{ψ} ( {s}_{t} ) , \qquad ( 3 )$$

where sₜ is the latent state (e.g., learned latent state), or is raw observations (e.g., red, green, blue (RGB) images, robot velocities, etc.), f_{φ} updates the latent state based on a previous action, and g_{ψ} attempts to reconstruct or predict oₜ. sₜ can encapsulate environment dynamics and constraints (e.g., environment information).

The world model 110 can encode the state of the robot and generate an encoding (e.g., policy token 208, token, policy state, etc.) indicative of the state of the robot. For example, the data generator 106 can provide the world model 110 with an action from the action database 108 and a state of the robot, and the world model can encode and generate an encoding of the state of the robot. The action of the robot can include at least a navigation goal for the robot. The world model 110 can use both the action and the state of the robot to predict the transitions of the robot within the simulated environment. For example, the robot can be in a moving state, and the world model 110 can predict transitions and further movement of the robot based on the moving state. In various embodiments, the simulated environment can include moving objects, and the world model 110 can predict transitions of the moving objects within the environment. The world model 110 can generalize out-of-distribution states of the robot (e.g., states robot has not encountered during training) by predicting future observations (e.g., RGB images) and latent transitions. Consequently, the world model 110 can generate an encoding indicative of the state of the robot as well as the out-of-distribution states to provide a robust encoded representation. The world model 110 can be an autoregressive world model (e.g., predicts transitions sequentially). In various embodiments, the world model 110 can generate the latent state and an encoding for a route (e.g., action) of the robot, and can combine the latent state and the route encoding into a single encoding indicative of the state of the robot.

The data generator 106 can include an expert policy database 112, which can include one or more expert policies (e.g., teacher, supervisor, target, reference policy, classical navigation stacks, etc.) which can be a ground truth for the robot. For example, an expert policy can generate ground truth or ideal actions for a robot given the state of the robot. The ground truth action can refer to a best or optimal route for a robot to take within a given environment to reach a given goal as well as velocities for each joint of the robot. The expert policy can be applicable to standard mobile robots, such as a wheeled robot. The expert policy database 112 can include one or more teacher datasets (e.g., training dataset, ground truth, etc.). The teacher dataset can correspond at least output actions to latent states of the robot. The teacher dataset can correspond output actions and latent states to a type of the robot.

The base policy generator 102 can include at least one base policy updater 114 (e.g., base policy trainer, etc.). The base policy updater 114 can receive at least one expert policy from the expert policy database 112, and can input the encoding from the world model 110 into the expert policy to generate an expert action. Weights of the world model 110 can be updated to minimize reconstruction and predictive losses using the expert actions. For example, the weights of the world model 110 can be updated to minimize losses over a dataset of expert demonstrations (e.g., actions):

$$𝒟 = \{ ( {o}_{0} , {u}_{0}^{*} , … , {o}_{T} , {u}_{T}^{*} ) \} , \qquad ( 4 )$$

where

$${u}_{t}^{*}$$

are the expert (e.g., teacher) actions generated by the expert policy. For example, as the base policy updater 114 is updating the base policy 104 based on the expert actions generated by the expert policy, the base policy updater 114 can provide the expert actions to the world model 110 to update weights of the world model 110. The world model 110 can be updated to better (e.g., more accurately or precisely) generate the latent state of the robot.

The base policy updater 114 can include a policy

$${π}_{θ}^{IL}$$

(e.g., first policy, first action policy, etc.), and can update the policy

$${π}_{θ}^{IL}$$

using mutation learning (e.g., the policy

$${π}_{θ}^{IL}$$

can be an imitation learning model). For example, the policy

$${π}_{θ}^{IL}$$

can observe and copy (e.g., mimic) the expert policy to produce a mapping of the encoding to the generated expert action. In various embodiments, the base policy updater 114 can begin updating the policy

$${π}_{θ}^{IL}$$

using imitation learning following convergence of the weights of the world model 110. The policy

$${π}_{θ}^{IL}$$

can receive sₜ (e.g., encoding of state of robot) and route information rₜ (e.g., navigation goal, route, route 206) to predict uₜ (e.g., action of robot) which can be represented by:

$${u}_{t} = {π}_{θ}^{IL} ( {s}_{t} , {r}_{t} ) . \qquad ( 5 )$$

The discrepancy between uₜ output by the policy

$${π}_{θ}^{IL}$$

and the expert action output by the expert policy can be minimized using:

$${min}_{θ} {\sum }_{t} ℓ ( {π}_{θ}^{IL} ( {s}_{t} , {r}_{t} ) , {u}_{t}^{*} ) , \qquad ( 6 )$$

where [symbol] (•) can be a simple regression loss. The base policy updater 114 can receive the encoding from the world model 110, provide the encoding to the policy

$${π}_{θ}^{IL} ,$$

and the policy

$${π}_{θ}^{IL}$$

can output uₜ. The route information can be received from the data generator 106. Once output, the base policy updater 114 can determine a loss, and update weights of the policy

$${π}_{θ}^{IL}$$

according to Equation (6). Once weights of the policy

$${π}_{θ}^{IL}$$

converge, the base policy updater 114 can generate the base policy 104 which can be an updated (e.g., trained) policy

$${π}_{θ}^{IL} .$$

Consequently, the base policy 104 can be an imitation learning based general navigation policy (e.g., common sense navigation) for a variety of types of robots. For example, rather than being refined specifically for a type of robot, the base policy 104 can provide a navigation and action baseline to maneuver in an environment while avoiding obstacles (e.g., collision avoidance) to reach a navigation goal. The base policy 104 can be a velocity-prediction action model. For example, the base policy 104 can generate a base action (e.g., base action 212) including velocities for each joint of a robot to move the robot, thereby producing an action of the robot. The base action output by the base policy 104 can be indicative of predicted transitions of the robot within the environment, such as predictions of a current direction and movement of joints of the robot. For example, the base policy 104 can generate the base action based on movement of the robot indicated by the state generated by the world model 110. The base policy updater 114 can integrate the world model 110 and the base policy 104 to generate actions for different robots, and the base policy 104 can combine the latent state sₜ and route information to generate actions (e.g., navigation commands, etc.).

The system 100 can include at least one specialist policy generator 116 (e.g., type-specific policy, second action policy generator, etc.). Following convergence of weights of at least one of the base policy 104 or the world model 110, the specialist policy generator 116 can receive the base policy 104 from the base policy generator 102, and update (e.g., refine, adapt, etc.) the base policy 104 for specific types of robots. For example, the specialist policy generator 116, using the base policy 104, can output a plurality of specialist policies (e.g., type-specific policy, second action policy, residual reinforcement learning model, etc.). The weights of at least one of the base policy 104 or the world model 110 can be frozen prior to the specialist policy generator 116 receiving the base policy 104. Each specialist policy can correspond to one type of robot. The specialist policy generator 116 can apply residual RL to the base policy 104 and incrementally refine the base policy 104 into specialist policies. Since the specialist policy generator 116 uses the base policy 104 updated based on imitation learning to generate the specialist policies, the specialist policy generator 116 can use fewer interactions to integrate type-specific constraints and sensor streams effectively compared to generating the specialist policies without the base policy 104 updated based on imitation learning. Using residual RL, the specialist policy generator 116 can generate the specialist policies to address robot type-specific kinematics, sensor configurations, and constraints that may not be captured by the base policy 104.

To generate the specialist policies, the specialist policy generator 116 can include at least one input generator 118. The input generator 118 can generate at least one state (e.g., xₜ) of the robot in a simulation. The state can include, as described above, at least camera input of the simulated robot, measured velocity (e.g., of each joint), route information, and a type embedding that indicates a type of the robot. The state can further include, but not limited to, a position of the robot in the environment. The state can include at least the latent state of the robot and the route information. For example, the input generator 118 may input the state into the world model 110, and the world model 110 can generate an encoding indicative of at least the latent state of the robot and the route information.

The specialist policy generator 116 can include at least one residual RL updater 120. The residual RL updater 120 can receive the state from the input generator 118 and use the base policy 104 to generate and update specialist policies 122 (e.g., robot-type specific action policies, second policy, etc.). The specialist policy 122 can be a machine learning model (e.g., neural network, etc.), such as a multi-layer perceptron (MLP). Each of the specialist policies 122 can correspond to one type of the plurality of types of robots. For example, the residual RL updater 120 can receive the base policy 104, and use the base policy 104 as a base for each of the specialist policies 122, such as a first specialist policy 122A and a second specialist policy 122B. The first specialist policy 122A can, for example, correspond to quadruped robots, and can output actions for quadruped robots. The second specialist policy 122B can, for example, correspond to humanoid robots, and can output actions for humanoid robots. Each of the specialist policies 122 can receive at least one state of one of a plurality of robots as an input and output a specialist action (e.g., second action, robot type-specific action, etc.) to move the at least one of the plurality of robots. The specialist policies 122 can be residual RL models, and can output the specialist action using residual RL. The specialist polices 122 can be tuned for a particular robot type.

The specialist policy 122 can be based on the base policy 104. For example, the specialist policy 122 can share a same feature-extraction layers as the base policy 104, and weights of the base policy 104 can be copied to the specialist policy 122, and a final output layer of the specialist policy 122 can have reinitialized weights (e.g., reset) from the base policy 104. The specialist policy generator 116 reinitializing weights of only the final output layer can ensure stable training and focuses the updates to each specialist policy 122 on the residual reinforcement learning updates and corrections to the base policy 104 necessary for type-specific performance for the specialist policy 122. By leveraging the base policy 104, the specialist policy generator 116 can reduce issues such as sparse rewards and sample complexity while accelerating convergence of the weights of each specialist policy 122.

To refine at least one of the specialist policies 122 for a specific robot type (e.g., update weights of the final output layer), the residual RL updater 120 can receive the state from the input generator 118 which can indicate the type embedding, and apply the state to the specialist policy 122 to update weights of the specialist policy 122 (e.g., weights in the final output layer). Each of the specialist policies 122 can receive the state as an input, and output a specialist (e.g., residual) action (e.g., specialist action 214) using residual RL. The specialist policies 122 can be residual RL models. The specialist policies 122 can output a specialist action that refines (e.g., adapts, modifies) a base action output by the base policy 104 to a respective type of robot. For example, let

$${u}_{t}^{base} = {π}_{θ}^{base} ( {x}_{t} )$$

be the base output (e.g., base action, first action, etc.) by the base policy 104. A residual policy

$${π}_{ϕ}^{res}$$

(e.g., specialist policy 122) can be introduced that outputs

$${u}_{t}^{res}$$

(e.g., fourth action, specialist action). The final action (e.g., combination of actions, second action) can be:

$${u}_{t} = {u}_{t}^{base} + {u}_{t}^{res} . \qquad ( 7 )$$

In various embodiments, a mixing or gating mechanism can be used (e.g., a weighted sum). For example, the final action can be a weighted sum of the base action and the specialist action. The role of πᵣₑₛ can be to adapt the base policy 104 to nuances of a specific robot type dynamics, kinematics, and constraints. For example,

$${u}_{t}^{res}$$

can adapt

$${u}_{t}^{base}$$

to the respective type of the robot to adapt the

$${u}_{t}^{base}$$

to specific dynamics, kinematics, and constraints of the respective type of the robot. In various embodiments, the base policy 104 outputs the base action in parallel with the specialist policy 122 outputting the specialist action.

The input generator 118 can generate one or more states which can be input into the specialist policies 122. The specialist policies 122 can output the specialist action which can be combined with the base action output by the base policy 104 into a final action (e.g., uₜ). The final action (e.g., a combination of the first action and the second action) can be transmitted to the simulated robot to move the robot, and results of the simulated robot can be recorded and used to update weights of the specialist policies 122. Each specialist policy 122 can correspond to different types of robots, and can be trained separately. Consequently, each specialist policy 122 can generate a specialist action for the one type of the robot. In various embodiments, the specialist policies 122 can be updated in parallel. In various embodiments, the specialist policy generator 116 includes the world model 110 which can receive the states from the input generator 118, and generate an encoding indicative of the state. In such situations, the encoding is input into the base policy 104 and the specialist policies 122 to output the base action and the specialist action, respectively.

The system 100 can include at least one general action policy generator 124. Once weights of each of the specialist policies 122 converge, the input generator 118 can provide additional states to each of the specialist policies 122, and record at least the input and output of each of the specialist policies 122. For example, the residual RL updater 120 can record at least the latent state and route information (e.g., included in the encoding) from the world model 110, the embodiment identifier, and a mean and variance of a Gaussian action distribution of the specialist action. The residual RL updater 120 can log each recording into a specialist dataset 126 for each respective specialist policy 122. For example, the first specialist policy 122A can have a corresponding first specialist dataset 126A and the second specialist policy 122B can have a corresponding second specialist dataset 126B. The residual RL updater 120 can record specialist actions generated by each specialist policy 122 into a respective specialist dataset 126 in response to the state being provided by the input generator 118. In various embodiments, the residual RL updater 120 can log the specialist dataset 126 as weights of the specialist policies 122 are being updated.

The general action policy generator 124 can generate at least one general action policy 130 (e.g., third action policy, etc.) by a combination of the base policy 104 and the specialist policies 122. For example, the general action policy generator 124 can include at least one distiller 128 (e.g., compressor, condenser, extractor, etc.). The general action policy 130 can be a machine learning model (e.g., neural network, etc.), such as a multi-layer perceptron (MLP). The general action policy generator 124 can input the specialist datasets 126 into the distiller 128, and the distiller 128 can distill the specialist datasets 126 into the general action policy 130. By distilling the specialist datasets 126 into the general action policy 130, the distiller 128 can maintain a latent processing pipeline provided by the specialist policy generator 116 while further conditioning on the type embedding to output the action. The distiller 128 can implement a simulation platform, such as NVIDIA's Omniverse System for Modular Operations (OSMO) using at least one computing system, such as NVIDIA's DGX systems to generate the general action policy 130.

The general action policy 130 can be applicable to various robot types (e.g., a plurality of types of robots) while maintaining specialist policy 122 performance for each type of robot. For example, the general action policy 130 can receive a state and identifier (e.g., type embedding, embodiment embedding, encoding, etc.) of the robot, and generate an action for the robot. The action can then be transmitted to a controller to move the robot based on the action. The general action policy 130 can generate the action based on the state and the identifier.

The action output by the general action policy 130 can include a plurality of velocity commands, and each of the velocity commands can correspond to a joint of the robot. Therefore, to execute the action on the robot, the general action policy 130 can map at least one of the velocity commands to a respective joint of the robot. In various embodiments, at least one of: the action can include the mapping, or the controller can map the velocity commands to the respective joint. The velocity commands can include at least one of an identifier, association, or correspondence to the respective joint. The velocity commands can be transmitted to each of the joints to direct and move the robot.

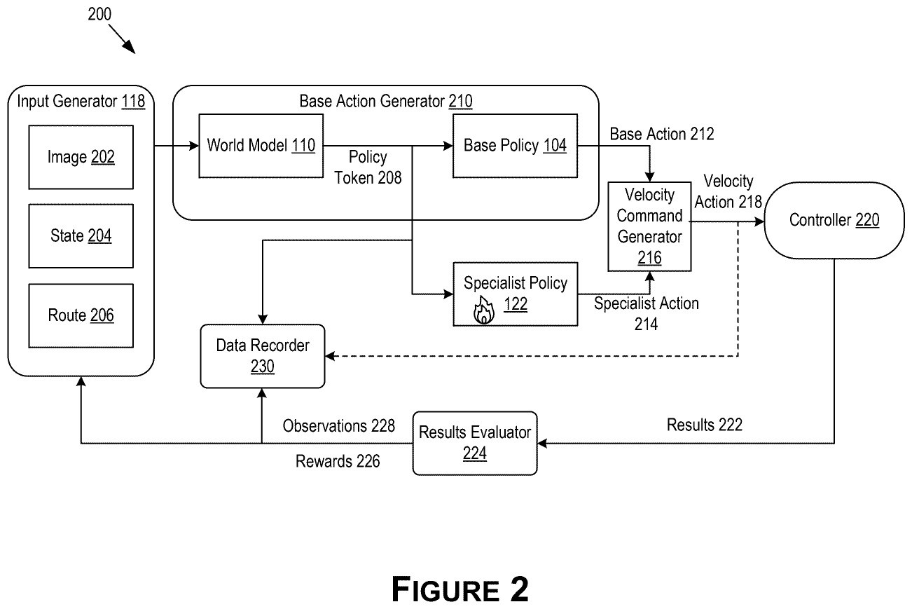

With reference to FIG. 2, FIG. 2 is an example system 200 for updating specialist policies 122, in accordance with some embodiments of the present disclosure. It should be understood that this and other arrangements described herein are set forth only as examples. Other arrangements, components, features, and elements (e.g., machines, interfaces, functions, orders, groupings of functions, etc.) may be used in addition to or instead of those shown, and some elements may be omitted altogether. Further, many of the arrangements, components, features, elements, etc. described herein are functional entities that may be implemented as discrete or distributed components or in conjunction with other components, and in any suitable combination and location (e.g., on a local device, vehicle, or machine at the edge, on-premises—such as locally hosted servers, remotely located—such as in one or more computing or server devices in one or more data centers in the cloud, and/or at other locations). Various functions described herein as being performed by entities may be carried out by hardware, firmware, and/or software. For instance, various functions may be carried out using one or more processors (e.g., central processing units (CPU(s)), graphics processing units (GPU(s)), microprocessors, microcontrollers, embedded processors, digital signal processors (DSPs), image signal processors (ISPs), physics processing units (PPUs), field-programmable gate arrays (FPGAs), accelerator(s) (e.g., deep learning accelerators (DLAs), deep learning accelerator cluster (XNNs), neural network accelerators (NNAs), and/or neural processing units (NPUs), programmable vision accelerators (PVAs), optical flow accelerators (OFAs), etc.), application specific integrated circuits (ASICs), data processing units (DPUs), quantum processors, etc.) executing instructions stored in memory. In some embodiments, the systems, methods, and processes described herein may be executed using similar components, features, and/or functionality to those of example machine 1700 of FIGS. 17A-17E, example computing ecosystem 1800 of FIG. 18, example generative language model system 1900 of FIG. 19, and/or example computing device 2000 of FIG. 20.

The system 200 can be included in the system 100. For example, the system 200 can be an example of the specialist policy generator 116. In various embodiments, the specialist policy generator 116 can be or include the system 200.

To update the weights of the final output layer of the specialist policy 122 (e.g., refine specialist policy 122 per robot type), the system 200 can include the input generator 118. The input generator 118 can include a plurality of inputs to provide to the world model 110. For example, the input generator 118 can include at least one image 202 (e.g., raw observations of the robot), at least one state 204 of the robot, and at least one route 206 (e.g., route information, navigation goal, etc.) for the robot. The state 204 of the robot can include, but not limited to, a current position and velocities of the joints of the robot in the simulated environment. The image 202 can correspond to the state 204, and the input generator 118 can generate various combinations of the route 206 and the state 204 to provide to the world model 110. For example, the image 202 can include a perspective of the robot in its current state 204.

Weights of the world model 110 and the base policy 104 can be updated and frozen by the base policy generator 102 prior to updating weights of the specialist policy 122. In the system 200, the weights of the world model 110 and the base policy 104 can be frozen. The world model 110 can receive at least one of the image 202, the state 204, or the route 206 from the input generator 118, and output a policy token 208 (e.g., encoding, latent state). The world model 110 can determine a latent state for the robot based on at least one of the image 202, the state 204, or the route 206, and can encode the latent state to generate the policy token 208. The policy token 208 can be indicative of at least the latent state (e.g., state) of the robot. The world model 110 can determine the latent state of the robot and encode the route 206 of the robot provided by the input generator 118, and can generate the policy token 208 including the latent state and the route encoding.

The system 200 can include at least one base action generator 210. The base action generator 210 can include the world model 110 and the base policy 104. The world model 110 can provide the policy token 208 indicative of the state and route encoding to the base policy 104 as an input. Using the policy token 208, the base policy 104 can generate a base action 212 (e.g., nominal action, first action, etc.). The policy token 208 can be input into the base policy 104, and the base policy 104 can output the base action 212. The base action 212 can be a navigational baseline for various types of robots, such as to avoid obstacles, and can be applied to different types of robots. The base action 212 can be represented by

$${u}_{t}^{base} = {π}_{θ}^{base} ( {x}_{t} )$$

where

$${u}_{t}^{base}$$

is the base action 212,

$${π}_{θ}^{base}$$

is the base policy 104, and xₜ can be the policy token 208 indicative of at least one of the image 202, the state 204, or the route 206.

The system 200 can include at least one of the specialist policy 122, and the specialist policy 122 can receive the policy token 208 from the world model 110. In various embodiments, the specialist policy 122 receives the policy token 208 in parallel or sequentially from the base policy 104 receiving the policy token 208. Using the policy token 208, the specialist policy 122 can generate a specialist action 214 (e.g., residual action, correction term, adaptive action, etc.). The specialist policy 122 can generate the specialist action 214 using residual reinforcement learning, and the specialist action 214 can be directed to one type of robot. For example, the system 200 can include a plurality of the specialist policies 122, each for (e.g., corresponding to) a different type of robot. The system 200 can update the plurality of specialist policies 122 in parallel or sequentially. The system 200 can include and update one specialist policy 122 per type of robot. The specialist action 214 can be represented by

$${u}_{t}^{res} = {π}_{θ}^{res} ( {x}_{t} )$$

where

$${u}_{t}^{res}$$

is the specialist action 214,

$${π}_{θ}^{res}$$

is the specialist policy 122, and xₜ can be the policy token 208 indicative of at least one of the image 202, the state 204, or the route 206. The specialist policy 122 can be a residual reinforcement learning policy (e.g., model).

The system 200 can include at least one velocity command generator 216 (e.g., velocity action generator, etc.) The velocity command generator 216 can receive the base action 212 from the base policy 104 and the specialist action 214 from the specialist policy 122. The velocity command generator 216 can combine the base action 212 and the specialist action 214 to generate a velocity action 218 (e.g., velocity command, action, third action, velocity for each joint, etc.) For example, the velocity command generator 216 can combine the base action 212 and the specialist action 214 by

$${u}_{t} = {u}_{t}^{base} + {u}_{t}^{res} .$$

In various embodiments, the velocity command generator 216 combines the base action 212 and the specialist action 214 using a weighted sum to generate the velocity action 218. The velocity action 218 can include a velocity for each joint of the robot as well as mappings for each velocity to a respective joint of the robot. The velocity action 218 can be a combination of the base action 212 and the specialist action 214.

The system 200 can include at least one controller 220. The controller 220 can be a controller 220 of the simulated robot in the simulation. The controller 220 can control the joints of the robot and subsequently movement of the robot. The velocity command generator 216 can transmit the velocity action 218 to the controller 220. The controller 220 can execute the velocity action 218 on the simulated robot in simulation, and cause the simulated robot to move according to the velocity action 218. The controller 220 can transmit the velocity action 218 for different types of robots. The controller 220 can record movement of the robot as the robot moves according to the velocity action 218, and can record a starting position and ending position of the robot as well as a route the robot took. The controller 220 can record interactions of the robot with the simulated environment. The controller 220 can generate and output results 222 indicative of the movement of the robot. The results 222 can include, but not limited to, the starting position, the ending position, the route, and contact of the robot with other objects in the simulated environment.

In various embodiments, the controller 220 can be pretrained to map velocity commands to joints of the robot. For example, the controller 220 receives the velocity action 218, and is configured to map the velocity action 218 to a respective joint of the robot. In such situations, the velocity command generator 216 may not generate the velocity action 218 to include mappings of the velocity action 218 to the joints of the robot.

The system 200 can include at least one results evaluator 224 (e.g., results analyzer, etc.) The results evaluator 224 can receive the results 222 from the controller 220. The results evaluator 224 can generate rewards 226 based on at least one of, but not limited to, progress to a goal (e.g., navigation goal, route information), collision avoidance (e.g., contact with other objects), or goal completion (e.g., reaching the navigation goal). The progress to the goal can be a positive reward proportional to a distance of the simulated robot from the goal indicated in at least one of the route information or state. Collision avoidance can be a negative reward (e.g., penalty) for contacting (e.g., colliding) with an object or other hazardous actions (e.g., joints of the robot pinching). The goal completion can be a positive reward greater than the reward for progress to the goal for reaching the navigation goal. The results evaluator 224 can calculate (e.g., determine, generate, etc.) the rewards 226 based on, for example, a sum or weighted sum of the progress to the goal, the collision avoidance, and goal completion.

The results evaluator 224 can generate observations 228. The observations 228 can include but not limited to, an efficiency of a route the robot took to reach the goal, speed of the robot, complexity of the environment (e.g., number of objects, stairs, etc.), or a number of moving objects in the environment, such as other simulated robots. The observations 228 can include a next state (e.g., xₜ₊₁) of the robot following completion of the velocity action 218.

The results evaluator 224 can transmit the rewards 226 to the specialist policy 122 which can be used to update the weights of one layer (e.g., final output layer) of the specialist policy 122. The results evaluator 224 can, in some embodiments, provide the rewards 226 to the input generator 118 which can provide the specialist policy 122 with the rewards 226. The weights of the specialist policy 122 can be adjusted to maximize the positive rewards (e.g., goal completion) and reduce the negative rewards (e.g., collision avoidance). Weights of the specialist policy 122 can be updated using proximal policy optimization (PPO). For example, weights of the specialist policy 122 can be updated using gradients (e.g., gradient-based methods). In various embodiments, the results evaluator 224 can update the weights of the specialist policy 122 based on a complexity of the policy token 208. For example, the results evaluator 224 can determine a difficulty of at least one of the environment, complexity of the state, etc. encoded in the policy token 208, and weigh the rewards 226 according to the complexity of the policy token 208 to update weights of the specialist policy 122.

The system 200 can include at least one data recorder 230 (e.g., storer, etc.). The data recorder 230 can include at least one database, array, table, or other storage medium or can be communicatively coupled to a storage medium. The data recorder 230 can record at least one of the policy token 208 output by the world model 110, the velocity action 218, the rewards 226, or the observations 228. In various embodiments, the data recorder 230 additionally records at least one of the image 202, the state 204, the route 206, the base action 212, the specialist action 214, or the results 222. The data recorder 230 can record and associate each output of the system 200. For example, the data recorder 230 can record the policy token 208, the velocity action 218, the observations 228, the rewards 226, and an association between each of the policy token 208, the velocity action 218, the observations 228, the rewards 226. Specifically, the data recorder 230 can record an association between the policy token 208 and at least one of the base action 212, the specialist action 214, the velocity action 218, the results 222, the rewards 226, or the observations 228. The data recorder 230 can record both the input (e.g., policy token 208) into the base policy 104 and the specialist policy 122 and the output (e.g., velocity action 218 and results 222).

The data recorder 230, during updating of the specialist policies 122, can record input and output distributions for each of the specialist policies 122. For example, the data recorder 230 can record at least one of the latent state and route encoding output by the world model (e.g., in the policy token 208), a type identifier e of the robot, and a mean and variance of a Gaussian action distributed used in PPO (e.g., updating of the weights of the specialist policy 122). Each of the specialist policies 122 can output normal (e.g., state-action) distributions over the specialist action 214. In various embodiments, the type identifier e is indicated in and a part of the policy token 208. The data recorder 230 can record the input and output distributions to generate the specialist datasets 126 corresponding to each of the specialist policies 122.

In various embodiments, the system 200 updates specialist policies 122 in parallel. In such situations, based on the type identifier e, the system 200 provides the policy token 208 to the specialist policy 122 corresponding to the robot type of the type identifier e. Consequently, the input generator 118 can generate states 204 with varying type identifiers, and the specialist policies 122 can be updated in parallel. In various embodiments, the specialist policies 122 are updated sequentially, and the input generator 118 can generate a same type identifier for the state 204 until weights of the specialist policy 122 corresponding to the same type identifier converge. Following convergence, the input generator 118 can generate a different type identifier for the state 204 to update another specialist policy 122 corresponding to a different robot type.

In various embodiments, the input generator 118 provides the image 202, the state 204, and the route 206 after weights of the specialist policy 122 converge to record the velocity action 218 and results 222 for each of the specialist policies 122 corresponding to different types of the robot.

The data recorder 230 can record the input and the output for each iteration of the system 200. For example, the input generator 118 can provide the image 202, the state 204, and the route 206 until weights of the specialist policy 122 (e.g., each of the specialist policies 122) converge. Each iteration of the system 200 can include receiving xₜ, then obtaining

$${u}_{t}^{base}$$

from the base policy 104 and

$${u}_{t}^{res}$$

from the specialist policy 122, executing a combined action (e.g., velocity action 218) uₜ in simulation, observing a next state xₜ₊₁ and reward R, and updating

$${π}_{ϕ}^{res}$$

with gradient-based methods while keeping

$${π}_{θ}^{base}$$

frozen.

In various embodiments, the system 200 can continuously update the specialist policies 122 until convergence of weights of each of the specialist policies 122. For example, the system 200 can be automated and can include, for example, the input generator 118 generating at least one of the image 202, the state 204, or the route 206 after receiving the rewards 226 from the results evaluator 224. To do so, the system 200 can include or implement at least one simulation platform (e.g., NVIDIA's ISAAC Lab, OSMO, Omniverse Extensions (OVX). to generate the at least one of the image 202, the state 204, or the route 206, the robot, and include the controller 220 to execute the velocity action 218 and record the results 222.

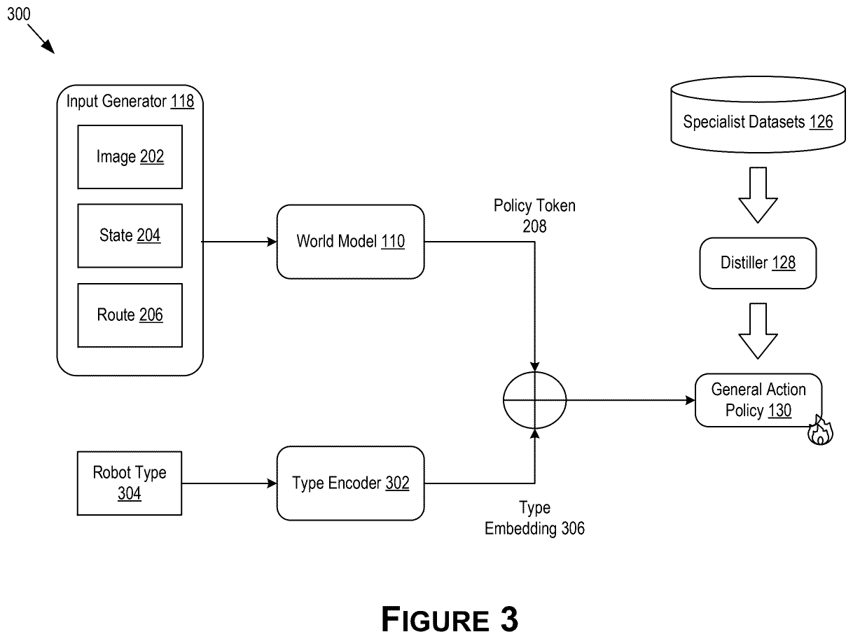

With reference to FIG. 3, FIG. 3 is an example system 300 for generating and updating the general action policy 130, in accordance with some embodiments of the present disclosure. It should be understood that this and other arrangements described herein are set forth only as examples. Other arrangements, components, features, and elements (e.g., machines, interfaces, functions, orders, groupings of functions, etc.) may be used in addition to or instead of those shown, and some elements may be omitted altogether. Further, many of the arrangements, components, features, elements, etc. described herein are functional entities that may be implemented as discrete or distributed components or in conjunction with other components, and in any suitable combination and location (e.g., on a local device, vehicle, or machine at the edge, on-premises—such as locally hosted servers, remotely located—such as in one or more computing or server devices in one or more data centers in the cloud, and/or at other locations). Various functions described herein as being performed by entities may be carried out by hardware, firmware, and/or software. For instance, various functions may be carried out using one or more processors (e.g., central processing units (CPU(s)), graphics processing units (GPU(s)), microprocessors, microcontrollers, embedded processors, digital signal processors (DSPs), image signal processors (ISPs), physics processing units (PPUs), field-programmable gate arrays (FPGAs), accelerator(s) (e.g., deep learning accelerators (DLAs), deep learning accelerator cluster (XNNs), neural network accelerators (NNAs), and/or neural processing units (NPUs), programmable vision accelerators (PVAs), optical flow accelerators (OFAs), etc.), application specific integrated circuits (ASICs), data processing units (DPUs), quantum processors, etc.) executing instructions stored in memory. In some embodiments, the systems, methods, and processes described herein may be executed using similar components, features, and/or functionality to those of example machine 1700 of FIGS. 17A-17E, example computing ecosystem 1800 of FIG. 18, example generative language model system 1900 of FIG. 19, and/or example computing device 2000 of FIG. 20.

The system 300 can be included in the system 100. For example, the system 300 can be an example of the general action policy generator 124. In various embodiments, the general action policy generator 124 can be or include the system 300. The system 300 can receive outputs from the system 200 which can be an example of the specialist policy generator 116.

The system 300 can include the specialist datasets 126 for different robot types which can be consolidated by the distiller 128 into a single general action policy 130. The specialist datasets 126 can be provided by the specialist policy generator 116. The general action policy 130 can capture collective knowledge of all the specialist policies 122 and use the type embedding to generate an action based on the type of the robot, as described further herein.

To generate the general action policy 130, the distiller 128 can combine and distill the specialist datasets 126 into the general action policy 130. For example,

$${π}_{ϕ}^{( i )}$$

can denote the specialist policy 122 for an i-th type of the robot. Each specialist policy 122 can produce a normal distribution [symbol] (μ⁽ⁱ⁾(z), σ²) (e.g., plurality of normal distributions) over actions (e.g., at least one of specialist action 214 or velocity action 218), where z is the latent state and route encoding. The general action policy 130 can be defined as

$${π}_{θ}^{dist}$$

which can output μ_{θ}(z, e) given z and an embodiment embedding e. To match the normal distributions of each specialist policy 122, Kullback-Leibler (KL) divergence can be minimized by:

$${min}_{θ} {\sum }_{i ϵε} {\sum }_{( z , {μ}^{( i )} ) ∈ {𝒟}_{i}} K L ( 𝒩 ( {μ}^{( i )} ( z ) , {σ}^{2} ) ‖ 𝒩 ( {μ}_{θ} ( z , {e}_{i} ) , {σ}_{θ}^{2} ) ) \qquad ( 8 )$$

where [symbol] ᵢ is the dataset of recorded state-action distributions from the i-th specialist policy 122 (e.g., first specialist dataset 126A), and eᵢ is a corresponding type embedding. eᵢ can be a type embedding corresponding to the robot type of the i-th specialist policy 122. Consequently, the combination of the normal distributions output by the specialist policies 122 (e.g., specialist datasets 126) can be distilled into the general action policy 130 by at least minimizing a divergence of the combination of the plurality of normal distributions.

In various embodiments, weights of the specialist policies 122 are updated to convergence and frozen prior to generating the normal distributions. In other embodiments, the normal distributions, as well as the input and output of each of the specialist policies 122, is recorded while weights of the specialist policies 122 are being adjusted and converging.

The general action policy 130 can maintain the same latent processing pipeline as the base policy 104 and the specialist policies 122 and further condition on the type embedding prior to producing a final action. For example, the general action policy 130 can maintain the expert actions mimicked by the base policy 104 while adapting the actions according to the robot type.

As shown in FIG. 3, the system 300 can include the input generator 118 which can provide the world model 110 with at least one of, but not limited to, the image 202, the state 204, or the route 206. The world model 110 can receive at least one of, but not limited to, the image 202, the state 204, or the route 206 and output the policy token 208 as described with reference to FIG. 2.

The system 300 can include at least one type encoder 302. The type encoder 302 can receive a robot type 304 (e.g., types of robot), and generate a type embedding 306 (e.g., embedding e, identifier, etc.) based on the robot type 304. The robot type 304 can be associated with the state 204 generated by the input generator 118. The robot type 304 can include a plurality of robot types associated with each of the specialist policies 122. For example, the robot type 304 can include each robot type 304 corresponding to the specialist policies 122. As another example, in response to the first specialist policy 122A corresponding to quadruped robots and the second specialist policy 122B corresponding to humanoid robots, the robot type 304 can include at least quadruped and humanoid robots. The robot type 304 can be a database of robot types 304 corresponding to the specialist policies 122 or specialist datasets 126. In various embodiments, the type encoder 302 can randomly select (e.g., extract, etc.) the robot type 304 in parallel or sequentially to the input generator 118 providing an input to the world model 110. In some embodiments, the state 204 includes the type embedding 306.

The type encoder 302 can generate the type embedding 306 based on the robot type 304. The type embedding 306 can include the embedding e associated with each of the specialist datasets 126. The type embedding 306 can correspond to the robot type 304, and the type embedding 306 can be same for robots of the same robot type 304. To generate the type embedding 306, the type encoder 302 can include, for example, a table or guidelines. For example, the type encoder 302 can include a table corresponding the robot type 304 to the type embedding 306. In various embodiments, the robot type 304 can correspond to the state 204, and the type encoder 302 can generate the type embedding 306 according to the state 204 generated by the input generator 118.

The general action policy 130 can receive the policy token 208 and the type embedding 306 from the world model 110 and the type encoder 302, respectively. Using the policy token 208 and the type embedding 306, the general action policy 130 can generate an action. The general action policy 130 can maintain the latent processing (e.g., of the world model 110 and base policy 104) and adjust based on the type embedding 306 to produce the action. For example, the general action policy 130 can be conditioned to generate decisions based on the robot type 304 by using the type embedding 306. The action output by the general action policy 130 can be the base action 212 altered by a specialist action selected using the type embedding 306, and the action can be tuned for specific kinematics and constraints of the robot type 304 associated with the type embedding 306. The general action policy 130 can generate an action encompassing a base action according to the policy token 208, and refinements to the base action according to the type embedding 306. The general action policy 130 can be used to generate actions for any robot type 304 associated with the specialist datasets 126, and can tune the generated action using the type embedding 306. The general action policy 130 can mimic the specialist actions 214 corresponding to the robot type 304 by using the type embedding 306.

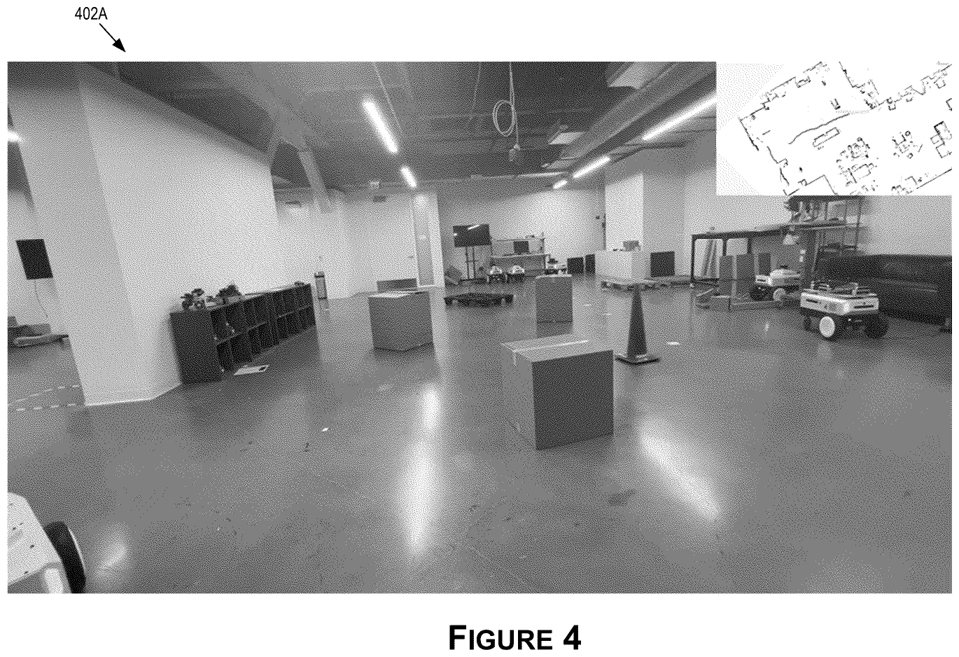

FIG. 4 depicts image 402A which can be an example of the image 202 in a simulation. The image 402A can be input into the world model 110 and the world model 110 can use the image 402A to determine the latent state, generate the route encoding, and generate the policy token 208 which can include both the latent state and the route encoding.

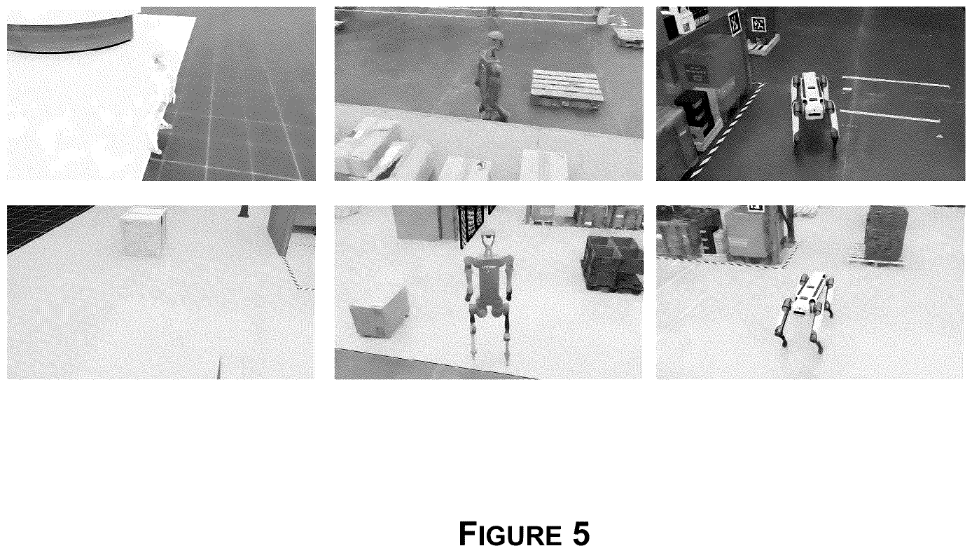

FIG. 5 depicts examples of the different robot types 304. The robot types 304 can include at least humanoid and quadruped robots, as shown in FIG. 5.

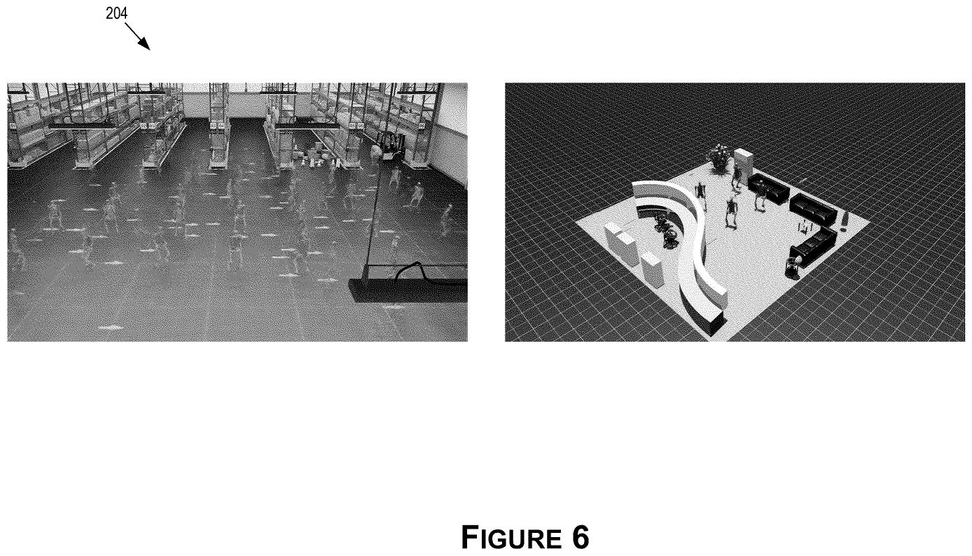

FIG. 6 depicts states 204 where the simulated environment of the robot includes multiple robots. In such cases, the world model 110 can predict transitions of the multiple robots in the environment to generate the policy token 208. Actions output by at least one of the base policy 104, the specialist policy 122, or the general action policy 130 can reflect predictions of movement in the robots. For example, using the predicted movements of the multiple robots, the general action policy 130 can generate the action to avoid the multiple robots in the environment. The specialist policies 122 can be updated with scenarios including multiple robots such that the weights of the specialist policies 122 are optimized for scenarios with multiple moving objects.

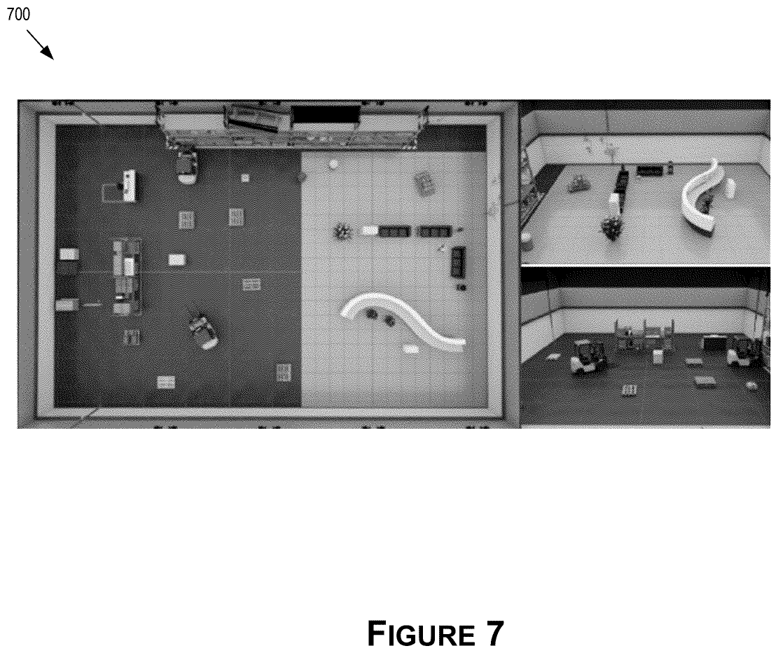

FIG. 7 depicts an experimental setup 700 of an example residual RL updating environment for the specialist policies 122. The environment can include multiple tiled areas, and the areas can be run in parallel to accelerate sampling and updates to each of the specialist policies 122. The environment can be generated by a simulator such as NVIDIA's ISAAC Lab and can be a scalable visual RL environment. The task (e.g., action from action database 108) provided to the simulated robots can include point-to-point indoor navigation in diverse settings (e.g., warehouse, office, lab, etc.). In the experimental setup 700, robot types 304 wheeled, humanoid, and quadruped were evaluated to cover a wide range of physical characteristics. For the initial imitation learning stage (e.g., base policy generator 102), a pre-trained base policy 104 for standard wheeled navigation was used. The base policy 104 weights were frozen for subsequent RL refinements. During the RL phase (e.g., specialist policy generator 116), each robot type 304 was trained in a unified environment containing randomized obstacle layouts and goal placements. Each training episode (e.g., iteration) can include up to 256 time steps. The movement of the robot can terminate early upon collision or reaching a maximum length (e.g., 256 time steps). In this experimental setup, about 320 trajectories per robot type 304 were recorded from the specialist policies 122. Each trajectory can be logged for 128 steps, resulting in about 40 k frames per robot type 304. Distillation can then be performed (e.g., by the distiller 128) by matching the output distributions of each specialist policy 122.

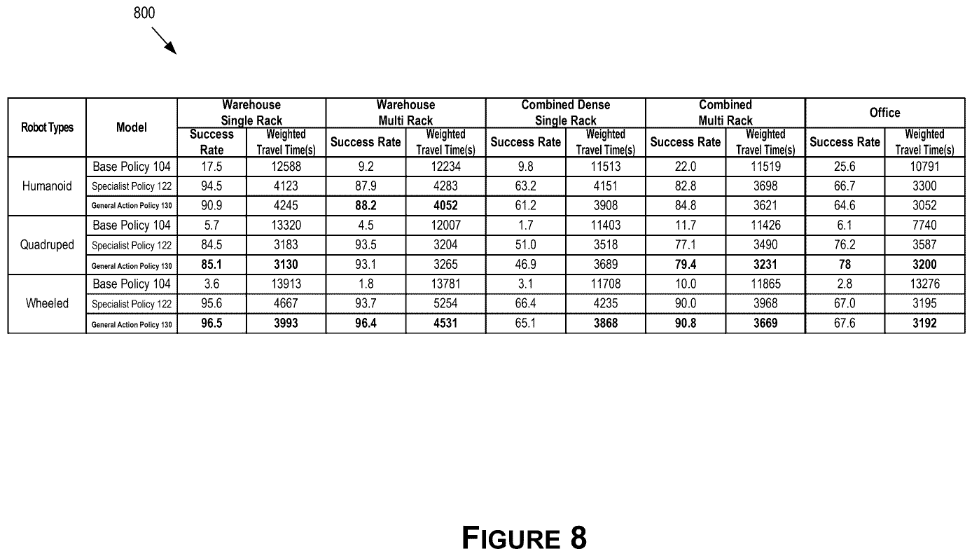

FIG. 8 depicts a table 800 of results of the experimental setup 700 of FIG. 7. The table 800 includes results based on a success rate (SR) and a weighted travel time (WTT). The SR can indicate a fraction of runs to reach the goal without collision or timeouts (e.g., maximum time steps). The WTT can indicate an average time or steps to reach the goal if successful (e.g., goal completed), and can be weighed by SR. As shown by the table 800, the general action policy 130 performed better than the base policy 104 and the specialist policy 122 across different robot types 304 and different simulated environments.

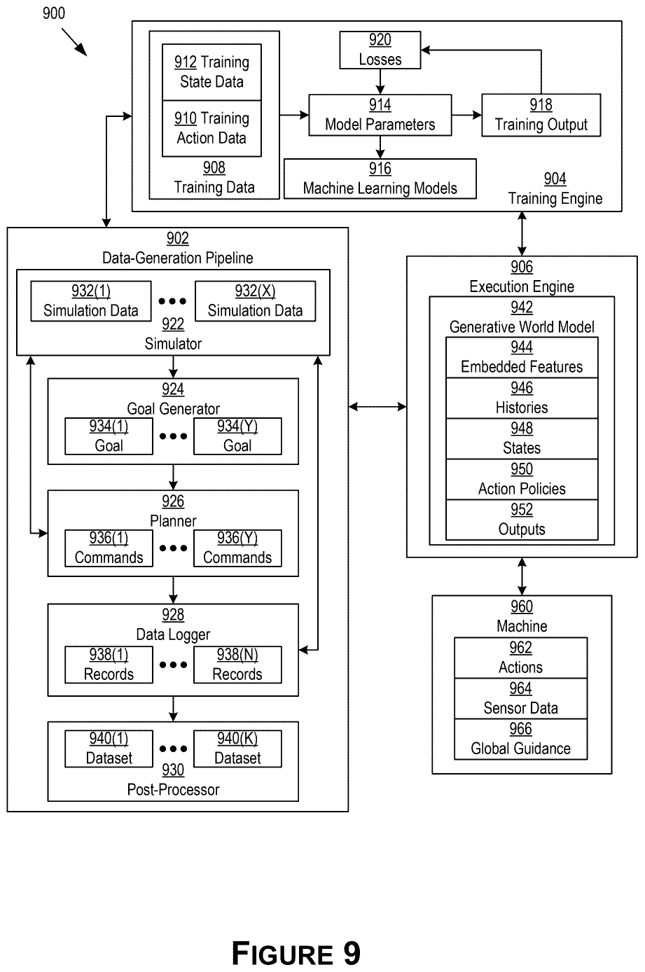

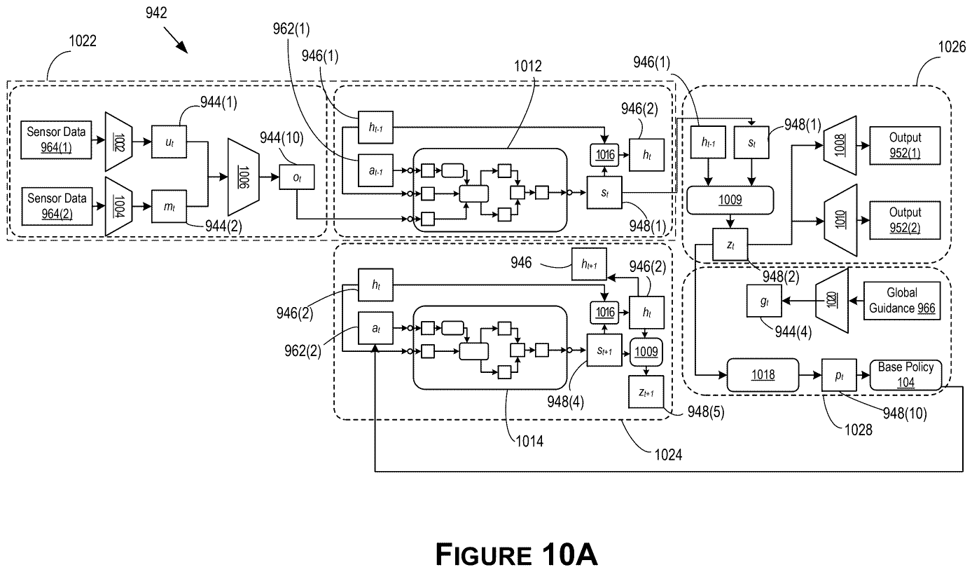

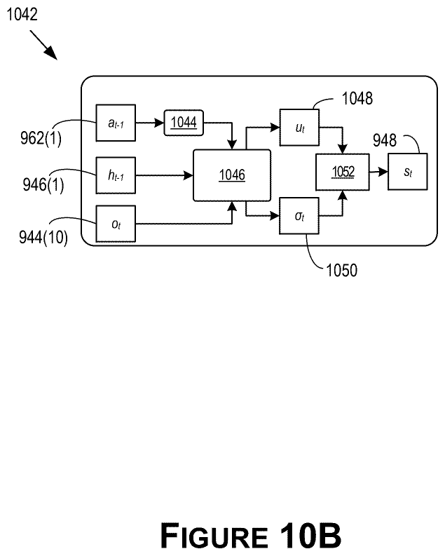

With reference to FIGS. 9-10, FIGS. 9-10 is an example system 900 for generating and updating the base policy 104, in accordance with some embodiments of the present disclosure. It should be understood that this and other arrangements described herein are set forth only as examples. Other arrangements, components, features, and elements (e.g., machines, interfaces, functions, orders, groupings of functions, etc.) may be used in addition to or instead of those shown, and some elements may be omitted altogether. Further, many of the arrangements, components, features, elements, etc. described herein are functional entities that may be implemented as discrete or distributed components or in conjunction with other components, and in any suitable combination and location (e.g., on a local device, vehicle, or machine at the edge, on-premises—such as locally hosted servers, remotely located—such as in one or more computing or server devices in one or more data centers in the cloud, and/or at other locations). Various functions described herein as being performed by entities may be carried out by hardware, firmware, and/or software. For instance, various functions may be carried out using one or more processors (e.g., central processing units (CPU(s)), graphics processing units (GPU(s)), microprocessors, microcontrollers, embedded processors, digital signal processors (DSPs), image signal processors (ISPs), physics processing units (PPUs), field-programmable gate arrays (FPGAs), accelerator(s) (e.g., deep learning accelerators (DLAs), deep learning accelerator cluster (XNNs), neural network accelerators (NNAs), and/or neural processing units (NPUs), programmable vision accelerators (PVAs), optical flow accelerators (OFAs), etc.), application specific integrated circuits (ASICs), data processing units (DPUs), quantum processors, etc.) executing instructions stored in memory. In some embodiments, the systems, methods, and processes described herein may be executed using similar components, features, and/or functionality to those of example machine 1700 of FIGS. 17A-17E, example computing ecosystem 1800 of FIG. 18, example generative language model system 1900 of FIG. 19, and/or example computing device 2000 of FIG. 20. The detailed description, including figures and example, of U.S. patent application Ser. No. 18/921,863, filed Oct. 21, 2024, is hereby incorporated by reference in its entirety.

FIG. 9 illustrates a system 900 for performing end-to-end navigation that includes a data-generation pipeline 902, a training engine 904, and an execution engine 906, according to various embodiments. The system 900 can be included in the system 100. For example, the base policy generator 102 can include or be the system 900. The system 900 can be an example of the base policy generator 102. As discussed herein, data-generation pipeline 902 generates synthetic data that can be used to train, evaluate, test, and/or otherwise operate a multimodal generative world model 942, other types of machine learning models that can be used by autonomous mobile robots (AMRs) (e.g., robot 1700) and/or other machine types to perform tasks, hardware configurations for the machines, and/or other components of the machines. The generative world model 942 can correspond to the world model 110. The generative world model 942 can be an example of the world model 110. In some embodiments, the generative world model 942 is an example of the base action generator 210. The data-generation pipeline 902 can be an example of the data generator 106 and/or the input generator 118. The training engine 904 and the execution engine 906 can be an example of the base policy updater 114.

In some embodiments, data-generation pipeline 902 generates a synthetic dataset for training (e.g., updating), evaluating, and/or testing the multimodal generative world model 942, other types of machine learning models that can be used by AMRs and/or other machine types to perform tasks, hardware configurations for the machines, and/or other components of the machines. As discussed herein, data-generation pipeline 902 may be configured and/or customized via various parameters to generate data that captures different scenarios related to navigation and/or other types of tasks performed by machines in environments. For example, at least one of the data generator 106 or the input generator 118 can include the data-generation pipeline 902 to generate at least actions, images 202, state 204, and routes 206 to update the base policy 104 and the specialist policy 122, respectively.

In some embodiments, training engine 904 and execution engine 906 can include functionality to train and execute the multimodal generative world model 942 to perform end-to-end navigation and/or other tasks for an AMR and/or another type of machine. The multimodal generative world model 942 can directly map inputs such as, but not limited to, camera images (e.g., images 202), velocities, global guidance, and/or robot states (e.g., state 204) to multimodal outputs such as (but not limited to) semantic segmentations, paths, and/or navigation commands (e.g., base action 212). These multimodal outputs can then be used to perform navigation for the machine, generate predictions of future states associated with the machine, simulate operation of the machine, and/or perform other tasks related to the machine.

The data-generation pipeline 902 can include at least one simulator 922 that generates multiple sets of simulation data 932(1)-932(X) (each of which is referred to individually herein as simulation data 932, where X can be a number (e.g., integer)). For example, simulator 922 may perform physics simulations of various environments around an AMR and/or another type of machine. During these physics simulations, simulator 922 may generate simulation data 932 that includes (but is not limited to) rendered images of the environment around the machine (e.g., from the perspective of one or more cameras on the machine and/or a birds-eye visualization), semantic labels (e.g., segmentation maps, detected objects, bounding shapes, etc.) associated with the images, a state of the machine (e.g., position, heading, velocity, etc.), and/or an occupancy map of free and/or occupied space within the environment.

The data-generation pipeline 902 can include at least one goal generator 924 that determines a set of goals 934(1)-934(Y) (each of which is referred to individually herein as goal 934, where Y can be a number) associated with simulation data 932. For example, goal generator 924 may generate, within a given occupancy map output by simulator 922, a target location to navigate to within a corresponding environment.

The data-generation pipeline 902 can include at least one planner 926 that generates various commands 936(1)-936(Z) that can cause the machine to take (e.g., receive) one or more corresponding actions based on simulation data 932 and/or goals 934. Z can be a number. For example, planner 926 may generate commands 936 that include (but are not limited to) a linear and/or angular velocity that move the machine toward a certain goal 934 from goal generator 924 while avoiding obstacles in an environment represented by simulation data 932 from simulator 922.

At least one set of commands 936 output by planner 926 may be sent to simulator 922. The simulator 922 can update the state of the machine, rendered images, semantic labels, occupancy map, and/or other simulation data 932 based on the commands 936 provided by the planner 926. Simulator 922 may then send some or all of the updated simulation data 932 to planner 926 to allow planner 926 to generate a new set of commands 936 based on the updated simulation data 932 and the corresponding goal 934 received from goal generator 924. This process may be repeated until goal 934 is reached, a certain number of time steps has been executed within a given simulation, and/or another condition indicating the end of the simulation is met.

The data-generation pipeline 902 can include at least one data logger 928 that aggregates simulation data 932, goals 934, commands 936, and/or other data generated by simulator 922, goal generator 924, and planner 926 into multiple records 938(1)-938(N) (each of which is referred to individually herein as record 938, where N can be a number). For example, data logger 928 may log, in records 938, data from simulator 922, goal generator 924, and/or planner 926 in the order in which the corresponding events occur (e.g., in time steps, “frames” of simulation data 932, and/or other discrete representations of time) within the corresponding simulations. Data logger 928 may also, or instead, downsample and/or resample some or all of the data (e.g., on a spatial and/or temporal basis) in records 938 to reduce and/or modify the size of the logged data.

At least one post-processor 930 in data-generation pipeline 902 can adapt simulation data 932, goals 934, commands 936, records 938, and/or other data generated by the other components of data-generation pipeline 902 to various machine learning models and/or use cases. For example, post-processor 930 may resample, compress, format, and/or otherwise convert data in a given set of records 938 into a form that can be used to train and/or evaluate a machine learning model, hardware configuration, and/or other components of one or more machines. Each set of records 938 that is post-processed for a given purpose and/or in a certain way may be stored in one or more datasets 940(1)-940(K) (each of which is referred to individually herein as dataset 940, where K can be a number) for subsequent retrieval and use.

In some embodiments, data-generation pipeline 902 can be configured and/or customized via different types of configuration parameters. For example, the configuration parameters may include a unique name and/or identifier for a given scenario (e.g., a combination of a particular environment, machine, goal, policy, etc.) under which data is to be generated and collected. The configuration parameters may also be used to customize the environment and/or type of machine to be simulated, the goal, the type of planner, the type of data to log, the frequency with which the data is logged, and/or the way in which the logged data is converted into a format that is suitable for training and/or evaluating a machine learning model and/or another component of the machine. Different sets of configuration parameters can be used to launch different instances of the data-generation pipeline (e.g., in parallel on multiple nodes of a distributed system) to generate data that captures different scenarios related to navigation and/or other types of tasks performed by machines in environments.

Training engine 904 can update one or more machine learning models 916 using training data 908 that is derived from one or more datasets 940 generated by data-generation pipeline 902, data collected by machines in real-world environments, simulation using, for example, the simulator 922, and/or other data sources. The machine learning models 916 can be included in the expert policy database 112. As shown in FIG. 9, training data 908 can include training state data 912 representing states associated with machines and/or environments. The training data 908 can include the action database 108. For example, training state data 912 may include sensor data (e.g., images, LiDAR, RADAR, audio data, ultrasonic data, inertial measurement unit (IMU) data, etc.) captured by virtual and/or real sensors on the machines, representations of environments around the machines (e.g., visualizations, semantic segmentations, point clouds, meshes, environment types, environment descriptions, scene description using Universal Scene Descriptor (USD) data (e.g., OpenUSD), etc.), linear and/or angular velocities of the machines, machine types and/or machine models associated with the machines, global guidance associated with navigation and/or other tasks or goals 934 of the machines, and/or other information that can be used to characterize the states of the machines and/or environments around the machines.

Training data 908 can include training action data 910 representing actions to be performed by machines in environments. For example, training action data 910 may include “ground truth” actions, “teacher” action policies, commands, routes, trajectories, paths, and/or other indications of actions to be performed during perception, planning, control, prediction, navigation, manipulation, and/or other tasks using the machines. For example, the training action data 910 may include the expert policy database 112.

In some embodiments, machine learning models 916 can be used to perform and/or guide tasks using the machines. For example, machine learning models 916 may include tree-based models such as decision trees, random forests, and gradient-boosted trees; feedforward neural networks, convolutional neural networks (CNNs), recurrent neural networks (RNNs), residual neural networks, long short-term memory networks (LSTMs), graph neural networks, transformer neural networks, diffusion models, generative adversarial networks (GANs), language models (large language models (LLMs), vision language models (VLMs), multi-modal language models (MMLMs), etc.), neural rendering field (NeRF) models, and/or other types of neural networks; and/or support vector machines (SVMs), logistic regression models, hierarchical models, ensemble models, Bayesian networks, naïve Bayes classifiers, and/or other types of model architectures. Machine learning models 916 may also, or instead, include rules, filters, heuristics, logic programming, semantic nets, search techniques, named entity recognition techniques, and/or other symbolic models. Each machine learning model may be used to generate embeddings, semantic segmentations, reconstructions and/or predictions of sensor data, classification output, safety alerts, trajectories, commands, and/or other output related to one or more corresponding tasks.

During training of machine learning models 916, training engine 904 can input at least one training state data 912 into machine learning models 916. Training engine 904 can use model parameters 914 (e.g., neural network weights) of machine learning models 916 to process the input training state data 912 and obtains training output 918 that includes predictions associated with training state data 912 from one or more layers, blocks, or components of machine learning models 916. Training engine 904 can compute one or more losses 920 using training output 918, training state data 912, and/or training action data 910. Training engine 904 can use a training technique (e.g., gradient descent and backpropagation) to iteratively update model parameters 914 of machine learning models 916 in a way that reduces losses 920.

In one or more embodiments, execution engine 906 can use at least one trained machine learning models 916 to implement a generative world model 942 that can be used to perform end-to-end navigation and/or other tasks for a machine 960 in a real-world, simulated, digital twin, and/or another type of environment. For example, machine 960 may include a quadruped robot, a humanoid robot, a differential drive system, an Ackermann drive system, a warehouse robot, a delivery robot, a forklift, and/or another type of AMR. Machine 960 may also, or instead, include an autonomous or semi-autonomous vehicle, drone, submarine, watercraft, and/or another type of vehicle with navigation capabilities. Generative world model 942 may be deployed for real-time inference on machine 960 using a runtime platform (e.g., NVIDIA's TensorRT) that accelerates and optimizes performance using quantization, layer and tension fusion, kernel tuning, GPU-based execution, streaming audio and/or video, and/or concurrent execution.

Generative world model 942 can operate on inputs such as (but not limited to) sensor data 964 from machine 960 (e.g., camera images, LiDAR data, RADAR data, audio data, velocities, states, etc.), global guidance 966 associated with the tasks (e.g., paths, trajectories, routes, destinations, etc.), and/or other representations of machine 960 and/or the environment around machine 960. Given these inputs, generative world model 942 can generate embedded features 944, histories 946, states 948, action policies 950, and/or outputs 952 related to machine 960 and/or the environment around machine 960. Embedded features 944, histories 946, states 948, action policies 950, and/or outputs 952 generated by generative world model 942 may additionally be used to determine one or more actions 962 to be carried out by machine 960 during execution of the tasks. At least one of the action policies 950 can correspond to the base policy 104.

FIGS. 10A-B is a more detailed illustration of generative world model 942 of FIG. 9, according to various embodiments. As shown in FIG. 10A, generative world model 942 includes an observing module 1022 (e.g., observer), a predicting module 1024 (e.g., predicter), a decoding module 1026 (e.g., decoder), and an action policy module 1028 (e.g., action policy generator). Each of these components is described in further detail herein.

Observing module 1022 can iteratively generate and/or update a set of states 948(1)-948(10) based on observations in the form of sensor data 964(1)-964(2) received from the machine 960. Within observing module 1022, a first encoder 1002 can convert a first type of sensor data 964(1) into a first set of embedded features 944(1), and a second encoder 1004 can convert a second type of sensor data 964(2) into a second set of embedded features 944(2).

In one or more embodiments, encoder 1002 can convert sensor data 964(1) in the form of one or more images (e.g., from one or more cameras on machine 960, one or more cameras external to machine 960, a visualization that is generated by combining multiple camera views of the environment around machine 960, etc.) associated with a current time step t into a vector, matrix, and/or another set of embedded features 944(1) uₜ in a lower-dimensional latent space. Encoder 1004 can convert sensor data 964(2) in the form of one or more machine states (e.g., machine type, machine model, linear velocity, angular velocity, position, orientation, configuration, etc.) associated with the machine at the same time step into another vector, matrix, and/or another set of embedded features 944(1) mt in a different lower-dimensional latent space.

A feature compressor 1006 can convert embedded features 944(1)-944(2) into a third set of embedded features 944(10) of associated with the same time step. For example, feature compressor 1006 may include a neural network and/or another type of machine learning model that converts both sets of embedded features 944(1)-944(2) into a new vector, matrix, and/or another representation of embedded features 944(10) in a latent space that differs from those of embedded features 944(1)-944(2). In another example, feature compressor 1006 may generate embedded features 944(10) as a concatenation, sum, average, and/or another aggregation or combination of embedded features 944(1)-944(2).

A posterior estimator 1012 in observing module 1022 can generate a set of states 948(1)-948(2) representing the world around the machine at the current time step t. As shown in FIG. 10A, posterior estimator 1012 can generate a first state 948(1) sₜ based on input that can include at least one of (i) the set of embedded features 944(10) from the feature compressor, (ii) one or more actions 962(1) aₜ₋₁ performed by the machine at a preceding time step t−1, or (iii) a history 946(1) of latent states hₜ₋₁ up to the preceding time step. During a certain number of initial time steps in the execution of generative world model 942, state 948(1) may be generated without action 962(1) and history 946(1) because of a lack of information related to any preceding time steps. After state 948(1) is produced, state 948(1) can be concatenated and/or otherwise combined with history 946(1) by a concatenator 1009 up to the preceding time step (e.g., in response to history 946(1) being available) to produce a second latent state 948(2) zₜ that can be associated with the current time step and captures the “world” around the machine up to the current time step. Decoding module 1026 can include a set of decoders 1008 and 1010 that convert the latent state 948(2) into a set of multimodal outputs 952. More specifically, decoder 1008 can convert state 948(2) into a first output 952(1) that corresponds to a reconstruction of image-based sensor data 964(1). Decoder 1010 can convert state 948(2) into a second output 952(2) that corresponds to a semantic segmentation of the image-based sensor data 964(1). These outputs 952(1)-952(2) may be used to train components of generative world model 942 and/or perform other tasks, as discussed in further detail herein.

Action policy module 1028 can include an encoder 1020 that converts a route, trajectory, path, heading, and/or other global guidance 966 associated with a task to be performed by the machine into a set of embedded features 944(4) gₜ for the current time step. These embedded features 944(4) and state 948(2) for the same time step can be input into a self-attention module 1018. Self-attention module 1018 can convert the input embedded features 944(4) and state 948(2) into a fused policy state 948(10) pₜ. The fused policy state 948(10) can be decoded by a neural network (or another type of machine learning model) implementing base action policy 104 (e.g., action policy 950) into one or more actions 962(2) for the current time step.

Predicting module 1024 can include a prior estimator 1014 that generates a state 948(4) sₜ₊₁ for a next time step t+1 that follows the current time step based on input that can include a least one of (i) a history 946(2) hₜ for the current time step or (ii) one or more actions 962(2) at associated with the current time step (e.g., as generated by action policy module 1028). History 946(2) can be generated by a gated recurrent unit (GRU) 1016 from input that includes history 946(1) hₜ₋₁ up to the preceding time step and state 948(1) sₜ. The prior estimator 1014 can correspond to the posterior estimator 1012 such that the prior estimator 1014 can have a same model architecture as the posterior estimator 1012. State 948(4) can be combined (e.g., concatenated) with history 946(2) by the concatenator 1009 to produce a latent state 948(5) zₜ₊₁ that is associated with the next time step and represents a prediction of the “future” world around the machine at the next time step. State 948(5) can be used to train the multimodal generative world model 942, decoded (e.g., using decoders 1008 and/or 1010 in decoding module 1026) into corresponding outputs (not shown) associated with the next time steps, and/or perform other tasks related to the next time step.

The predictive process associated with predicting module 1024 may be repeated for additional future time steps t+2, t+10, . . . that follow t+1. For example, state 948(4) sₜ₊₁ and history 946(2) hₜ may be processed by GRU 1016 to generate an updated history 946 hₜ₊₁ for the next time step. The latent state 948(5) zₜ₊₁ may also be processed using action policy module 1028 to generate a new fused policy state pₜ₊1 for the next time step. The new fused policy state may then be converted into new set of actions aₜ₊₁ for the next time step, and the updated history and new set of actions may be used to generate a new state sₜ₊₂ and corresponding latent state zₜ₊₂ for the future time step t+2. This latent state may then be decoded by decoding module 1026 into outputs 952 corresponding to future time step t+2. The process may be repeated to generate additional predictions for each subsequent future time step using states 948 associated with the preceding time step, history 946 up to the preceding time step, and actions 962 associated with the preceding time step.

In one or more embodiments, the operation of generative world model 942 can be represented as a Partially Observable Markov Decision Process (POMDP), which models probabilistic belief states and solves decision-making problems by interleaving observations and actions. This POMDP may be defined by the tuple { [symbol] , [symbol] , O, T, O, R, y}, where [symbol] represents a state space associated with one or more states 948, [symbol] denotes an action space associated with one or more actions 962, and [symbol] is an observation space associated with sensor data 964. A transition function T(s′, s, a)=Pr(s′ | s, a) can model the probability of transitioning to a state s′ in response to an action a being taken from a state s. An observation function O(o, s′, a)=Pr(o | s′, a) can represent the probability of observing o after applying action a and transitioning to state s′. A reward function R(s, a) can define the reward for performing action a in state s, and γ∈[0,1) is a discount factor. A solution to the POMDP may include an optimal policy π* that maximizes the expected accumulated reward

$$E ( {\sum }_{t = 0}^{∞} {γ}^{t} R ( {a}_{t} , {s}_{t} ) ) ,$$

where sₜ and aₜ represent the state and action of machine 960 at time t.

In some embodiments, observing module 1022 and predicting module 1024 can learn the transition function T(s′, s, a) for model prediction and the observation function O(o, s′, a) for observation correction. Action policy module 1028 can aim to solve the POMDP by imitating a teacher policy that closely approximates the optimal policy π*.

More specifically, prior estimator 1014 can learn state transitions by modeling a given state 948(4) as a normal distribution with diagonal covariance:

$${s}_{t + 1} ∼ 𝒩 ( {μ}_{θ} ( {h}_{t} , {a}_{t} ) , {σ}_{θ} ( {h}_{t} , {a}_{t} ) I ) \qquad ( 9 )$$

where the history transition is denoted by:

$${h}_{t} = {f}_{θ} ( {h}_{t - 1} , {s}_{t} ) . \qquad ( 10 )$$

Posterior estimator 1012 can capture both state transition and observation correction, with a corresponding state 948(1) that is also estimated as a normal distribution with diagonal covariance:

$${s}_{t} ∼ 𝒩 ( {μ}_{θ} ( {h}_{t - 1} , {a}_{t - 1} , {o}_{t} ) , {σ}_{θ} ( {h}_{t - 1} , {a}_{t - 1} , {o}_{t} ) I ) \qquad ( 11 )$$

where oₜ represents embedded features 944(10) generated by encoders 1002 and 1004 and feature compressor 1006 from sensor data 964 and/or other input observations. History 946(1) hₜ₋₁ and state 948(1) sₜ can be concatenated to form a 1-D latent state 948(2) zₜ=[hₜ₋₁, sₜ] that can be used for multi-task decoding.

In one or more embodiments, transitions that are learned by prior estimator 1014 and posterior estimator 1012 and represented by Equations 9-11 can be modeled using neural networks. For example, f_{θ} may be implemented as GRU 1016, and (μ_{θ}, σ_{θ}) in prior estimator 1014 and posterior estimator 1012 may include multi-layer perceptrons (MLPs). Prior estimator 1014 and posterior estimator 1012 can be discussed in further detail herein with respect to FIG. 10B.

FIG. 10B further illustrates an estimator model 1042 of FIG. 10A, according to various embodiments. More specifically, FIG. 10B illustrates a model architecture for estimator model 1042 that can correspond to posterior estimator 1012 and/or prior estimator 1014 of FIG. 10A.

In response to estimator model 1042 corresponding to posterior estimator 1012, one or more actions 962(1) aₜ₋₁ associated with a previous time step can be processed by an MLP 1044 to generate a higher-dimensional feature state. The feature state output by MLP 1044, history 946(1) hₜ₋₁, and embedded features 944(10) oₜ for the current time step t can be input into a normal distribution model 1046 in posterior estimator 1012.

Normal distribution model 1046 can include an MLP that estimates a mean 1048 μₜ and a standard deviation 1050 σₜ for the current time step. A sampler 1052 can sample from the normal distribution with mean 1048 and standard deviation 1050 to generate a corresponding state 948 sₜ for the current time step. State 948 sₜ can be combined with history 946(1) hₜ₋₁ to produce a corresponding latent state 948(2) zₜ, as discussed herein.

In response to estimator model 1042 corresponding to prior estimator 1014, one or more actions 962(1) at associated with the current time step (e.g., as determined by action policy module 1028 based on latent state 948(2) zₜ received from decoding module 1026) can be processed by MLP 1044 to generate a higher-dimensional feature state. The feature state output by MLP 1044 and history hₜ 946(2) up to the current time step can be input into normal distribution model 1046. Embedded features oₜ₊₁ for the next time step can be omitted as input into normal distribution model 1046 due to observations for future time steps not being available. Normal distribution model 1046 can generate mean 1048 μₜ₊₁ and standard deviation 1050 σₜ₊₁ for the next time step, and sampler 1052 can sample from the corresponding distribution to generate a corresponding state 948 sₜ₊₁ for the next time step. The process may be repeated for additional time steps following the next time step.

Encoder 1002 may correspond to a machine learning model that generates a set of embedded features 944(1) for one or more input images included in sensor data 964(1). For example, encoder 1002 may include a vision transformer (ViT) (or another type of machine learning model) that is trained using self-supervised techniques. A one-dimensional vector uₜ∈ [symbol] corresponding to embedded features 944(1) may be generated by concatenating a class token generated by the ViT from the input image(s) with a set of average-pooled patch tokens generated by the ViT from the input image.

Encoder may correspond to a machine learning model that generates a different set of embedded features 944(2) for one or more machine states included in sensor data 964(2). For example, encoder 1004 may include a fully connected neural network (or another type of machine learning model) that converts a linear velocity, angular velocity, and/or another representation of machine state included in sensor data 964(2) into another vector mₜ∈ [symbol] corresponding to embedded features 944(2).

Feature compressor 1006 may include neural network layers and/or operations that concatenate and/or otherwise combine both sets of embedded features 944(1) and 944(2) into a third vector oₜ=[uₜ, mt] corresponding to a third set of embedded features 944(10). These embedded features 944(10) may include a latent representation of observations associated with time step t.

In some embodiments, decoders 1008 and 1010 can generate decoded outputs 952(1) and 952(2), respectively, to ensure that the latent space associated with the latent state 948(2) zₜ captures information that can be used by machine 960 to perform navigation and/or other tasks. For example, decoder 1008 may include a diffusion model (or another type of machine learning model) that reconstructs one or more input images included in sensor data 964(1). The denoising process of the diffusion model may be conditioned on the latent state 948(2) zₜ. A mean squared error (MSE) and/or another measure of differences between the input image(s) and the corresponding reconstruction(s) output by the diffusion model may be used to train decoder 1008, posterior estimator 1012, feature compressor 1006, and/or encoder 1002 in an end-to-end fashion.

In another example, decoder 1010 may include a generative adversarial network (GAN) (or another type of machine learning model) that can convert the latent state 948(2) zₜ into a semantic segmentation included in outputs 952(2). The semantic segmentation may correspond to one or more images included in sensor data 964(1), a perspective view associated with machine 960, and/or another representation of the environment around machine 960. A cross-entropy loss (or another measure of difference between the outputted semantic segmentation and a corresponding ground truth semantic segmentation of the environment) may be computed on a per-pixel basis at each upsampled resolution outputted by decoder 1010. The computed loss may then be used to train decoder 1010, posterior estimator 1012, feature compressor 1006, encoder 1002, and/or encoder 1004 in an end-to-end fashion.

In one or more embodiments, a Kullback-Leibler (KL) divergence can be computed between a prior distribution output by prior estimator 1014 and a corresponding posterior distribution output by posterior estimator 1012 (e.g., for the same time step). The KL divergence may be used to train (e.g., update weights of) prior estimator 1014 such that the prior distribution to match the posterior distribution, thereby allowing generative world model 942 to predict future states that align with observed data.

As discussed herein, action policy module 1028 can use the latent state 948(2) zₜ and an encoded representation of global guidance 966 to generate one or more actions 962(2) aₜ~Pr(aₜ | zₜ, gₜ). To incorporate route information, a global route included in global guidance 966 may be transformed into a local frame of reference for machine 960 and truncated into a regional route segment near machine 960. The regional route segment may then be represented as a tensor that includes a series of route poses with x and y positions.

Encoder 1020 may include a VectorNet (or another type of machine learning model) that converts the tensor into a vector gₜ∈ [symbol] corresponding to embedded features 944(4). These embedded features 944(4) may capture route information associated with global guidance 966 while providing flexibility to encode additional attributes (e.g., a final destination flag) that can facilitate navigation and/or other tasks by machine 960.

Next, self-attention module 1018 may fuse the latent state 948(2) zₜ and embedded features 944(4) gₜ into a policy state 948(10) pₜ. This policy state 948(10) may then be decoded by an MLP (or another type of machine learning model) implementing one or more action policies 950 into one or more actions 962(2) aₜ∈ [symbol] that specify linear and angular speeds in the x, y, and z directions and/or a navigation path p∈ [symbol] that includes five path poses in the local frame of reference for machine 960. This MLP may be trained using an L1 loss (or another measure of difference) that is computed between actions 962(2) and corresponding actions outputted by a teacher action policy (not shown) to cause the MLP to imitate the teacher action policy.

In some embodiments, generative world model 942 can be trained over multiple stages. During a first training stage, action policy module 1028 can be omitted, and actions from the teacher action policy are used to train observing module 1022, predicting module 1024, and decoding module 1026 using the corresponding losses. After training of observing module 1022, predicting module 1024, and decoding module 1026 is complete (e.g., after a certain number of training steps, iterations, batches, and/or epochs have been performed; parameters of machine learning models in observing module 1022, predicting module 1024, and decoding module 1026 converge; the losses fall below a threshold; and/or another condition is met), action policy module 1028 can be trained in an end-to-end fashion with observing module 1022, predicting module 1024, and decoding module 1026 during a second training stage.

While generative world model 942 is illustrated in FIG. 10A as processing two types of sensor data 964(1)-964(2) (e.g., images and robot states) and generating two types of outputs 952(1)-952(2) (e.g., images and semantic segmentations), it can be appreciated that generative world model 942 is capable of operating using various types and/or combinations of inputs. For example, sensor data 964 associated with the environment around machine 960 may include (but is not limited to) images, depth maps, point clouds, meshes, audio data, temperature data, weather data, traffic data, and/or proximity data. In another example, sensor data 964 associated with the state of machine 960 may include (but is not limited to) accelerometer data, gyroscope data, odometer data, log data, performance data, event data, and/or error data collected by machine 960. Each type of sensor data 964 may be converted by a different encoder into a corresponding set of embedded features. Various sets of embedded features may then be further aggregated, combined, and/or otherwise processed to produce a latent representation of observations for a corresponding time step.

In another example, different types of outputs 952 may be generated by various components included in decoding module 1026 and/or action policy module 1028 from corresponding latent states 948 produced by observing module 1022 and/or predicting module 1024. These outputs 952 may include (but are not limited to) reconstructions of images, depth maps, point clouds, and/or other sensor data 964 used to produce latent states 948. These outputs may also, or instead, include (but are not limited to) semantic segmentations, detected objects and/or instances, bounding shapes, occupancy maps, paths, trajectories, linear and/or angular velocities, obstacle and/or collision avoidance actions, failure handling actions, and/or other predictions and/or actions associated with sensor data 964.

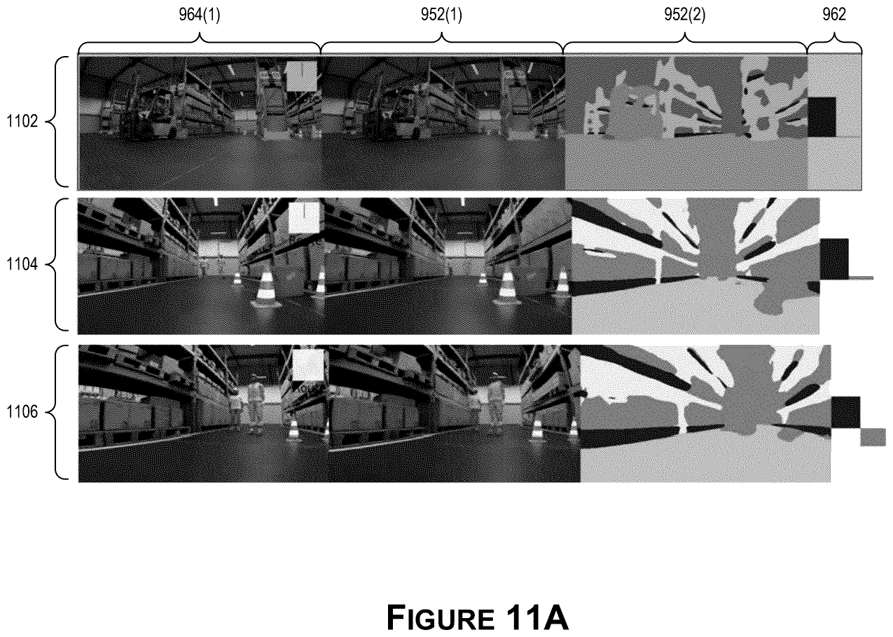

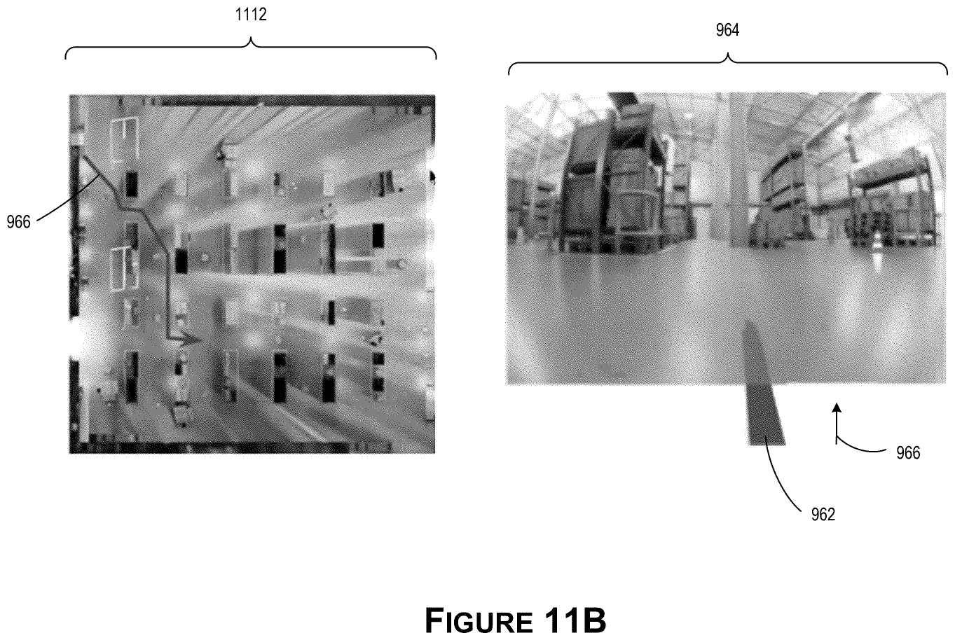

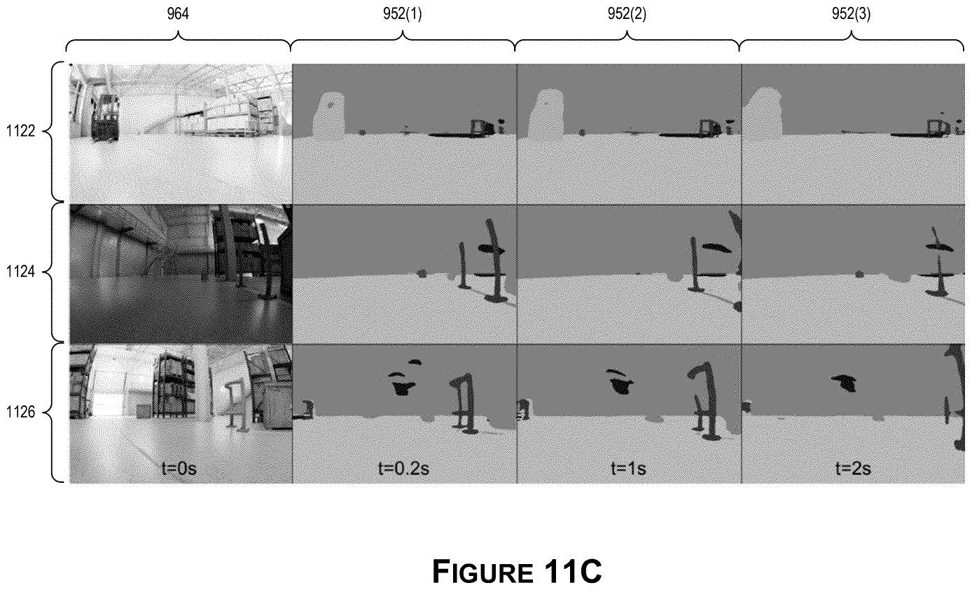

FIG. 11A illustrates an example set of inputs and outputs associated with generative world model 942 of FIG. 9, according to various embodiments. More specifically, FIG. 11A illustrates example sensor data 964(1), outputs 952(1)-952(2), and actions 962 associated with three different time steps 1102, 1104, and 1106.

Sensor data 964(1) includes images captured by a camera on machine 960 at each time step 1102, 1104, 1106. For example, each image may be captured by an AMR corresponding to machine 960 while the robot navigates within a warehouse environment.

Outputs 952(1) and 952(2) include reconstructions of the images and semantic segmentations associated with the images, respectively, for the same time steps 1102, 1104, and 1106. As discussed herein, outputs 952(1)-952(2) may be generated by decoders included in generative world model 942 from latent states 948 representing sensor data 964 associated with time steps 1102, 1104, and 1106.

Actions 962 include representations of linear velocities and angular velocities for time steps 1102, 1104, and 1106, which can be sent to machine 960 as commands during a navigation task. The magnitudes of the linear velocities are depicted in the bars to the left, and the magnitudes and directions of the angular velocities are depicted in the bars to the right.

FIG. 11B illustrates an example set of inputs and outputs associated with generative world model 942 of FIG. 9, according to various embodiments. The inputs include global guidance 966 in the form of a route to be taken by machine 960. Global guidance 966 may be specified in the context of a birds-eye view 1112 of the environment around machine 960, a map of the environment around machine 960, and/or another representation of the environment around machine 960 (e.g., in response to such a representation being available).

Given global guidance 966 and sensor data 964 that includes a camera view from machine 960 at a given time step, generative world model 942 can generate an action 962 to be performed for that time step. Action 962 may include a linear and/or angular velocity, a path, a trajectory, and/or another indication of motion associated with machine 960. As shown in FIG. 11B, the path corresponding to action 962 differs slightly from global guidance 966. Thus, global guidance 966 may be used to inform the navigation task that is performed using generative world model 942 without requiring the navigation task to adhere strictly to the specified route.

FIG. 11C illustrates an example set of inputs and outputs associated with generative world model 942 of FIG. 9, according to various embodiments. More specifically, FIG. 11C illustrates example sensor data 964 and outputs 952(1)-952(3) associated with three different environments 1122, 1124, and 1126 around machine 960. Sensor data 964 includes images of environments 1122, 1124, and 1126 (e.g., as captured by a camera on machine 960). Outputs 952(1) include semantic segmentations generated by decoding latent states 948 associated with time steps that are 0.2 seconds after the times at which the corresponding images were captured. Outputs 952(2) include semantic segmentations generated by latent states 948 associated with time steps that are one second after the times at which the corresponding images were captured. Outputs 952(3) include semantic segmentations generated by latent states 948 associated with time steps that are two seconds after the times at which the corresponding images were captured. These latent states 948 may be generated by prior estimator 1014 as representations of a “future” world around machine 960 based on sensor data 964 received from, for example, the machine 960. Within the semantic segmentations, different regions may represent navigable surfaces, fences, pallets, forklifts, signs, and/or other types of objects depicted in the images.

Latent states 948 representing future time steps and the corresponding decoded outputs 952 may be used to train various components of generative world model 942. After training is complete, observing module 1022 and action policy module 1028 may be used to perform inference during a given task (e.g., navigation) by machine 960 based on sensor data 964 received from the machine 960 corresponding to observations from machine 960. Latent states 948 generated by predicting module 1024 and/or corresponding outputs 952 for future time steps may be used to perform tasks such as (but not limited to) running simulations, conducting safety checks (e.g., detect and respond to potential hazards), and/or interpreting and/or explaining predictions generated by generative world model 942 and/or the behavior of machine 960.

It should be understood that this and other arrangements described herein are set forth only as examples. Other arrangements, components, features, and elements (e.g., machines, interfaces, functions, orders, groupings of functions, etc.) may be used in addition to or instead of those shown, and some elements may be omitted altogether. Further, many of the arrangements, components, features, elements, etc. described herein are functional entities that may be implemented as discrete or distributed components or in conjunction with other components, and in any suitable combination and location (e.g., on a local device, vehicle, or machine at the edge, on-premises—such as locally hosted servers, remotely located—such as in one or more computing or server devices in one or more data centers in the cloud, and/or at other locations). Various functions described herein as being performed by entities may be carried out by hardware, firmware, and/or software. For instance, various functions may be carried out using one or more processors (e.g., central processing units (CPU(s)), graphics processing units (GPU(s)), microprocessors, microcontrollers, embedded processors, digital signal processors (DSPs), image signal processors (ISPs), physics processing units (PPUs), field-programmable gate arrays (FPGAs), accelerator(s) (e.g., deep learning accelerators (DLAs), deep learning accelerator cluster (XNNs), neural network accelerators (NNAs), and/or neural processing units (NPUs), programmable vision accelerators (PVAs), optical flow accelerators (OFAs), etc.), application specific integrated circuits (ASICs), data processing units (DPUs), quantum processors, etc.) executing instructions stored in memory. In some embodiments, the systems, methods, and processes described herein may be executed using similar components, features, and/or functionality to those of example machine 1700 of FIGS. 17A-17E, example computing ecosystem 1800 of FIG. 18, example generative language model system 1900 of FIG. 19, and/or example computing device 2000 of FIG. 20.

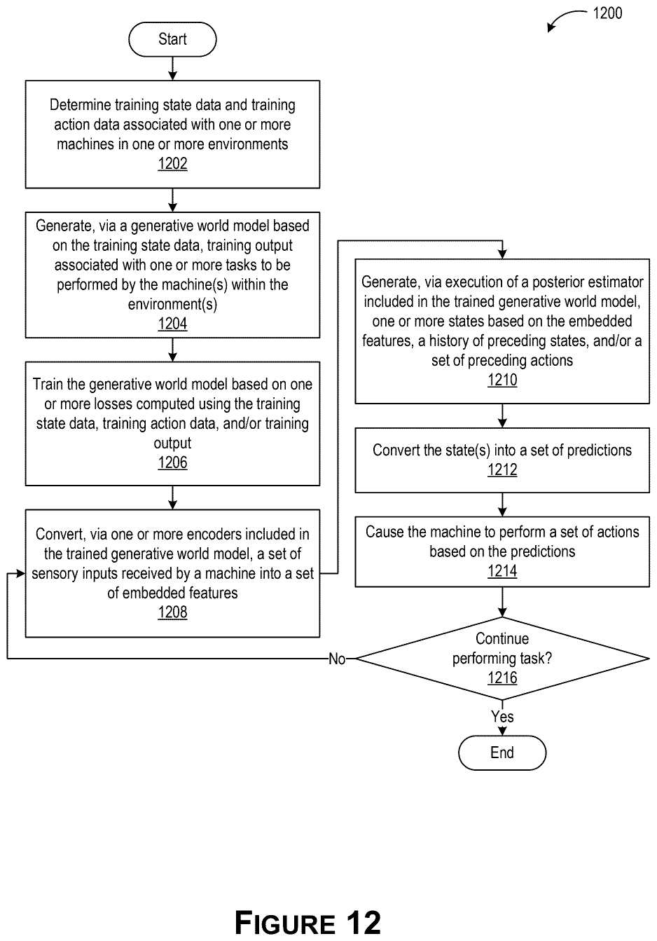

Now referring to FIG. 12, each block of method 1200, described herein, includes a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 1200 is described, by way of example, with respect to the system of FIGS. 1-3 or FIG. 9. However, this method may additionally or alternatively be executed by any one system, or any combination of systems, including, but not limited to, those described herein. Further, the operations in method 1200 may be omitted, repeated, and/or performed in any order without departing from the scope of the present disclosure.

FIG. 12 illustrates a flow diagram of a method 1200 for performing end-to-end navigation using a generative world model, according to various embodiments. As shown in FIG. 12, method 1200 begins with operation 1202, in which training engine 904 can determine training state data and training action data associated with one or more machines in one or more environments. For example, training engine 904 may receive the training state data and training action from data-generation pipeline 902, one or more datasets collected from real-world machines interacting with real-world environments, one or more datasets of synthetic data, and/or other sources of data. The training state data may characterize the machine and/or the environment around the machine. The training action data may include a ground truth action policy for the machine, actions to be performed by the machine based on corresponding state data, and/or other indications of the desired behavior of the machine in performing one or more tasks.

In operation 1204, training engine 904 can generate, via a generative world model (e.g., generative world model 942) based on the training state data (e.g., training state data 912), training output (e.g., training output 918) associated with one or more tasks to be performed by the machine(s) within the environment(s). For example, training engine 904 may input the training state data into the generative world model. Training engine 904 may also use the generative world model to generate embedded features, states, decoded outputs, actions, and/or other training output from the inputted training state data.

In operation 1206, training engine 904 can train the generative world model based on one or more losses (e.g., losses 920) computed using the training state data, training action data (e.g., training action data 910), and/or training output. Continuing with the above example, training engine 904 may compute an L1 loss, MSE, cross entropy loss, and/or another measure of difference between the decoded outputs and/or actions and the corresponding ground truth values. Training engine 904 may also, or instead, compute a KL divergence and/or another measure of difference between a posterior distribution associated with states output by a posterior estimator in the generative world model and a prior distribution associated with states output by a prior estimator in the generative world model. Training engine 904 may further update parameters of various components of the generative world model based on the corresponding losses.

In various embodiments, training engine 904 may train the generative world model over multiple training stages. During a first training stage, training engine 904 may train neural networks and/or other machine learning models included in an observing module, decoding module, and/or predicting module within the generative world model using one or more losses. After the first training stage is complete, training engine 904 may perform a second training stage that trains an action policy module in the generative world model and the observing module, decoding module, and predicting module in an end-to-end fashion using the corresponding losses.

In operation 1208, execution engine 906 can convert, via one or more encoders (e.g., encoder 1002, 1004, 1020) included in the trained generative world model, a set of sensory inputs received by a machine into a set of embedded features. For example, execution engine 906 may use a different encoder to convert each type of sensory input into a corresponding set of embedded features in a lower-dimensional latent space. Execution engine 906 may also use a feature compressor to aggregate and/or otherwise combine multiple sets of embedded features corresponding to multiple types of sensory inputs into a single set of embedded features representing all observations made by the machine for a current time step.

In operation 1210, execution engine 906 can generate, via execution of a posterior estimator (e.g., posterior estimator 1012) included in the trained generative world model, one or more states based on the embedded features, a history of preceding states, and/or a set of preceding actions. For example, execution engine 906 may initially (e.g., during each time step included in a certain number of starting time steps) convert only the embedded features into a latent state.

In operation 1212, execution engine 906 converts the state(s) into a set of predictions. Continuing with the above example, execution engine 906 may use the decoding module in the trained generative world model to convert the latent state into a reconstruction of an image, point cloud, and/or another representation of the environment around the machine. Execution engine 906 may also, or instead, use the decoding module and/or action policy module to convert the latent state into a semantic segmentation, set of actions, and/or another type of prediction associated with the machine and/or environment.

In operation 1214, execution engine 906 can cause the machine (e.g., robot 1700) to perform a set of actions based on the predictions. Continuing with the above example, execution engine 906 may transmit the predicted actions as commands related to linear velocity, angular velocity, and/or other types of motion (e.g., forward motion, backward motion, left turn, right turn, etc.) to the machine. The transmitted commands may be executed by the machine to advance the machine in performing the task.

In operation 1216, execution engine 906 can determine whether or not to continue perform a task using the machine and/or trained generative world model. For example, execution engine 906 may determine that a navigation (or another type of) task should continue to be performed using the machine and/or trained generative world model while the task is not complete and/or while a certain amount of time has not yet elapsed since the task was assigned to the machine. While execution engine 906 determines that the task should continue being performed, execution engine 906 repeats operations 1208, 1210, 1212, and 1214 to generate additional states, predictions, and/or actions for subsequent time steps. After a certain number of time steps have passed, execution engine 906 may perform operation 1210 by generating state(s) associated with a current time step using a history of preceding states up to a preceding time step, a set of preceding actions associated with the preceding time step, and a set of embedded features associated with the current time step. Execution engine 906 can perform operation 1216 after a certain number of time steps and/or according to another frequency to determine whether or not to continue performing the task. Execution engine 906 can use the generative world model and machine to perform the task until the task is complete, the task has “timed out,” and/or another condition is met.

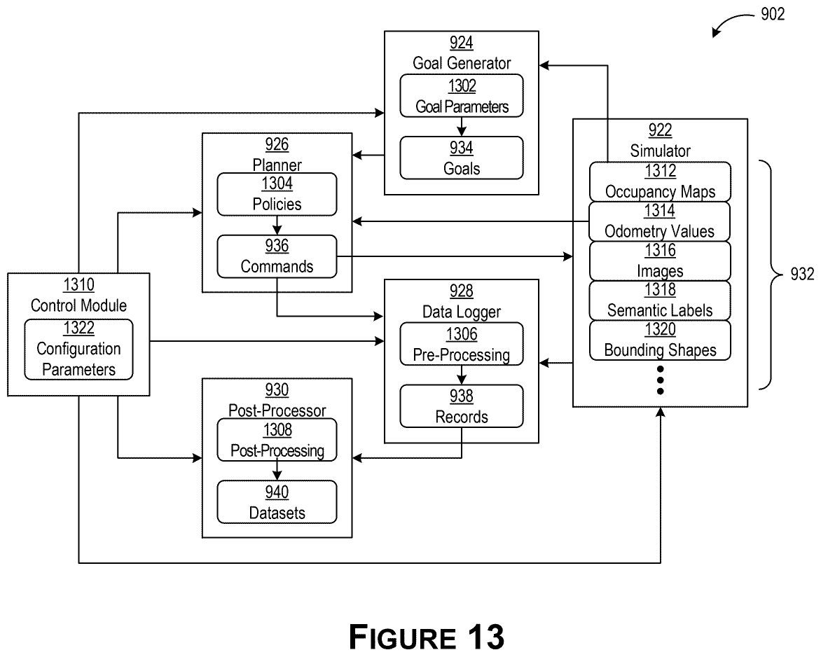

FIG. 13 is a more detailed illustration of data-generation pipeline 902 of FIG. 9, according to various embodiments. As discussed herein, data-generation pipeline 902 can generate synthetic data that can be used to train, evaluate, test, simulate, and/or otherwise operate generative world model 942, other types of machine learning models that can be used by AMRs and/or other machine types to perform tasks, hardware configurations for the machines, and/or other components of the machines.

Within data-generation pipeline 902, simulator 922 generates and/or updates simulation data 932 related to one or more machines and/or one or more environments around the machine(s). As shown in FIG. 13, simulation data 932 may include (but is not limited to) occupancy maps 1312, odometry values 1314, images 1316, semantic labels 1318, and/or bounding shapes 1320 (e.g., boxes, squares, rectangles, polygons, etc.).

Occupancy maps 1312 can include representations of empty and occupied space within the environments. For example, an occupancy map 1312 associated with a given simulation may include a two-dimensional (2D) and/or three-dimensional (10D) grid representing the environment around a machine. Within the grid, each cell may be associated with a binary value indicating whether or not the corresponding region of space is occupied (e.g., by an obstacle, object, etc.). Each cell may also, or instead, be associated with a probability of the corresponding region of space being occupied. Each cell may also, or instead, be associated with a numeric “cost” that quantifies the difficulty in moving within the corresponding region of space. Occupancy maps 1312 may also, or instead, include and/or be substituted with point clouds, meshes, and/or other representations of “occupied space” in the environments.

Odometry values 1314 can include numeric values associated with motion by the machines. For example, odometry values 1314 for a machine within a given simulation may indicate a distance traveled by the machine, the position of the machine, the heading of the machine, the linear and/or angular velocity of the machine, the linear and/or angular acceleration of the machine, and/or other information that can be used to derive and/or estimate a position and/or orientation of the machine within a corresponding environment.

Images 1316 can include visual representations of the environments around the machines. For example, images 1316 may depict the environments from the perspectives of cameras and/or other sensor modalities on the machines. Images 1316 may also, or instead, include birds-eye views of the environments, perspective views of the environments, 10130-degree visualizations of the environments, and/or other depictions of the environments that are external to the machines and/or individual cameras on the machines. Images 1316 may include per-pixel color values, depth values, normal values, motion vectors (e.g., between consecutive frames of video), LiDAR intensity values, and/or other types of information that can be used to characterize the environments.

Semantic labels 1318 can include indications of classes, objects, and/or other properties that assist with understanding of the environments. For example, semantic labels 1318 may include semantic segmentations that label individual pixels within images 1316, points within point clouds, polygons within meshes, and/or other representations of the environments with the corresponding classes. Semantic labels 1318 may also, or instead, identify objects, instances of objects, and/or other entities that are found within individual images, point clouds, meshes, and/or other representations of the environments.

Bounding shapes 1320 can include representations of the locations and/or sizes of objects within the environments. For example, bounding shapes 1320 may include rectangular outlines for the objects within images 1316. Bounding shapes 1320 may also, or instead, include parallelepiped outlines for the objects within point clouds and/or other 10D representations of the environments. Each bounding shape may be associated with a class label, instance, and/or another indication of a corresponding object.

In one or more embodiments, simulator 922 can generate at least a portion of simulation data 932 using physics simulations and/or photorealistic renderings of the machines and/or environments. These physics simulations and/or photorealistic renderings may be performed using a physically based virtual environment such as NVIDIA ISAAC Sim (NVIDIA ISAAC Sim™, NVIDIA ISAAC Gym™, and/or NVIDIA Drive Sim™, which are registered trademarks of NVIDIA Corporation) that is built on an NVIDIA Omniverse (NVIDIA Omniverse Sim™ is a registered trademark of NVIDIA Corporation) platform. The simulation environment may support loading of robot models (e.g., quadruped robots, humanoid robots, differential drive systems, Ackermann drive systems, forklifts, etc.) and/or sensors (e.g., cameras, LiDAR, IMUs, etc.), randomization of environments and/or environmental attributes (e.g., lighting, reflection, color, position, etc.), addition of objects to the environments, and/or the specification of physics, material, and/or collision properties of the objects.

As discussed herein, goal generator 924 can determine one or more goals 934 associated with simulation data 932. For example, goal generator 924 may generate, within a given occupancy map output by simulator 922, a target location to navigate to within a corresponding environment.

In some embodiments, goal generator 924 can generate some or all goals 934 based on corresponding goal parameters 1302. For example, goal parameters 1302 may specify that navigation-based goals are to be randomly sampled from the navigable free space within occupancy maps 1312 generated by simulator 922. Goal parameters 1302 may also, or instead, specify one or more regions within occupancy maps 1312 from which goals 934 are to be preferentially sampled and/or attributes of these regions (e.g., regions with more “detail” and/or obstacles). Goal generator 924 may use these goal parameters 1302 to sample goals 934 more frequently from the corresponding regions, thereby increasing coverage of tasks associated with the regions in the synthetic data.

Planner 926 can use one or more policies 1304 to generate commands 936 that instruct machines in simulations performed by simulator 922 to perform actions related to goals 934. For example, planner 926 may implement and/or carry out action policies 1304 that generate commands 936 based on goals 934 from goal generator 924 and odometry values 1314 and/or other information from simulator 922. Each policy may include a planning stack, teacher policy, and/or another component that generates commands 936 to operate a machine based on a state of the machine and/or the environment around the machine. These commands 936 may (but are not limited to) a linear and/or angular velocity, trajectory, path, and/or another indication of motion that advances a machine toward a certain goal 934 from goal generator 924 while avoiding obstacles in a corresponding simulated environment.

Each set of commands 936 output by planner 926 may be sent to simulator 922, which updates simulation data 932 based on the corresponding action. For example, planner 926 may generate a given set of commands 936 based on simulation data 932 associated with a given time step in a simulation. These commands 936 may be transmitted to simulator 922, which generates updated simulation data 932 for the next time step. The simulation data 932 for the next time step may reflect changes to the machine and/or environment after the machine performs actions corresponding to commands 936. Simulator 922 may then send some or all of the updated simulation data 932 to planner 926 to allow planner 926 to generate a new set of commands 936 based on the updated simulation data 932 and the corresponding goal 934 from goal generator 924. This process may be repeated until goal 934 is reached, a certain number of time steps has been executed within the simulation, and/or another condition indicating the end of the simulation is met.

Data logger 928 can aggregate simulation data 932, goals 934, commands 936, and/or other data generated by simulator 922, goal generator 924, and planner 926 into records 938 of events associated with the corresponding time steps. For example, simulator 922, goal generator 924, and/or planner 926 may include and/or be associated with nodes that implement publishers in a publish-subscribe messaging system such as Robot Operating System (ROS). Each publisher may publish messages and/or events associated with a corresponding component of data-generation pipeline 902 (e.g., simulator 922, goal generator 924, planner 926, etc.) to one or more topics. Data logger 928 may include and/or be associated with nodes that implement subscribers to these topic(s) within the publish-subscribe messaging system. Each subscriber may receive messages from one or more corresponding topics. Data logger 928 may log data from the received messages by pre-processing 1306 the data and storing the pre-processed data in records 938.

In one or more embodiments, pre-processing 1306 can include determining an order in which data and/or events occur within a given simulation; generating records 938 that span a certain time interval and/or at a certain frequency; downsampling some or all of the logged data; and/or other data-processing operations associated with data from simulator 922, goal generator 924, and/or planner 926. For example, data logger 928 may synchronize data that is published at different frequencies by simulator 922, goal generator 924, and planner 926 by associating the published data with individual “frames” of time, time intervals, time steps, and/or other discrete measures of time within each simulation. Data logger 928 may also store the data associated with each discrete measure of time in one or more records corresponding to that measure of time. In another example, data logger 928 may downsample images 1316, semantic labels 1318, bounding shapes 1320, and/or other high-resolution data from simulator 922 prior to storing the data in records 938. In a third example, data logger 928 may store records 938 associated with a given scenario (e.g., a combination of a particular environment, machine, goal, policy, simulation, etc.) with a path and/or directory corresponding to the scenario. Data logger 928 may also, or instead, associate individual records 938 with unique identifiers and/or names for the corresponding scenarios.

In some embodiments, data logger 928 can generate visualizations and/or charts of data in records 938 as records 938 are created. For example, data logger 928 may output, in a graphical user interface, images 1316, semantic labels 1318, bounding shapes 1320, occupancy maps 1312, odometry values 1314, and/or other visual representations of simulation data 932. Data logger 928 may also, or instead, output “map pins,” routes, and/or other representations of goals 934 and/or guidance related to goals 934 within the corresponding occupancy maps 1312, birds-eye views of environments in simulations, and/or other visual depictions of the environments. Data logger 928 may also, or instead, output paths, trajectories, and/or other visual representations of commands 936 and/or actions performed based on commands 936 as overlays on images 1316, maps, and/or other representations of the environments. This output information may allow users to visually review the logged data, determine whether or not the logged data accurately reflects the corresponding scenarios, and/or determine whether or not the logged data can be used with various use cases and/or applications.

Post-processor 930 can perform post-processing 1308 that adapts records 938 and/or other data generated by the other components of data-generation pipeline 902 to various machine learning models and/or use cases. For example, Post-processor 930 may resample, compress, smooth, format, and/or otherwise convert data in a given set of records 938 into a form (e.g., file format, schema, etc.) that can be used to train, test, and/or evaluate a machine learning model, hardware configuration, digital twin, and/or other components of a physical and/or virtualized machine. Post-processor 930 may also, or instead, store each set of records 938 that has been post-processed for a given purpose and/or in a certain way in one or more corresponding datasets 940.

In some embodiments, Post-processor 930 can generate and store metadata that is associated with logged data in datasets 940. For example, Post-processor 930 may store, in associated with a dataset for a given scenario, a number of instances of object types (e.g., forklifts, shelves, people, etc.) in the scenario, time intervals between consecutive frames represented by records 938 in the dataset, a distance covered by a machine in the scenario, a distribution of actions performed by the machine, and/or other metrics and/or statistics associated with the simulated operation of the machine in the scenario. In another example, Post-processor 930 may specify, in metadata for a given dataset, goal parameters 1302, policies 1304, pre-processing 1306 and/or post-processing 1308 techniques, and/or other types of configuration parameters 1322 used to generate the dataset.

In some embodiments, some or all components of data-generation pipeline 902 can be configured and/or customized via configuration parameters 1322 provided by a control module 1310. For example, configuration parameters 1322 may specify a machine type and/or model, an initial pose for the machine, a scene, one or more objects within the scene, properties of the objects, and/or other information that can be used by simulator 922 to conduct simulations. Configuration parameters 1322 may also, or instead, include goal parameters 1302 that are used to control the generation of goals 934 by goal generator 924. These goal parameters 1302 may specify the types of goals 934 to be generated (e.g., location-based goals, tasks, etc.), sampling techniques used to generate goals 934, regions within environments from which goals 934 are to be preferentially sampled, attributes of regions within environments from which goals 934 are to be preferentially sampled, weights and/or other measures of importance associated with sampling goals 934 from various regions within the environments, times at which one or more new goals 934 are to be sampled (e.g., after one or more existing goals 934 have been reached), and/or other parameters that can be used to control and/or modify the generation of goals 934 by goal generator 924. Configuration parameters 1322 may also, or instead, include specific policies 1304 to be used by planner 926 in generating commands 936, behavioral attributes (e.g., a level of aggressiveness and/or conservatism in performing a task and/or reaching a goal; types of commands 936 to be generated; minimum, maximum, and/or valid values associated with commands 936; etc.) associated with those policies 1304, text- and/or code-based instructions for policies 1304, platforms and/or frameworks used to implement policies 1304, and/or other information that can be used to implement policies 1304 and/or generate commands 936. Configuration parameters 1322 may also, or instead, include parameters related to publishing and/or subscribing to topics by components of data-generation pipeline 902. Configuration parameters 1322 may also, or instead, include identifiers, paths, logging frequencies, downsampling parameters, resampling parameters, file formats, schemas, visualization types, and/or other information that can be used to perform pre-processing 1306 and/or post-processing 1308 associated with data in records 938 and/or datasets 940.

Configuration parameters 1322 may be defined and/or updated using various techniques. For example, configuration parameters 1322 may be provided by one or more users via one or more configuration files, application programming interfaces (APIs), user interfaces, and/or other mechanisms. Some or all configuration parameters 1322 may also, or instead, be randomly generated (e.g., by sampling from distributions, ranges, and/or sets of valid configuration parameters 1322). Some or all configuration parameters 1322 may also, or instead, be generated and/or updated using machine learning, optimization, and/or search techniques (e.g., to increase coverage of environments and/or scenarios by datasets 940 and/or generate synthetic data related to specific environments and/or scenarios). Control module 1310 may transmit configuration parameters 1322 to simulator 922, goal generator 924, planner 926, data logger 928, and/or Post-processor 930. Control module 1310 may also, or instead, configure the operation of simulator 922, goal generator 924, planner 926, data logger 928, and/or Post-processor 930 using the corresponding configuration parameters 1322.

In some embodiments, configuration parameters 1322 can include a unique name and/or identifier for a given scenario (e.g., a combination of a particular environment, machine, goal, policy, etc.) under which data is to be generated and collected. Configuration parameters 1322 may also be used to customize and/or randomize the environment and/or type of machine to be simulated, the goal, the type of policy, the type of data to log, the frequency with which the data is logged, and/or the way in which the logged data is converted into a format that is suitable for training and/or evaluating a machine learning model and/or another component of the machine.

In some embodiments, different sets of configuration parameters 1322 can be used to launch different instances of data-generation pipeline 902 to generate data that depicts different scenarios related to navigation and/or other types of tasks performed by machines in environments. For example, multiple instances of data-generation pipeline 902 may be launched in parallel on multiple nodes of a cloud computing system using an NVIDIA One-system-to-many-others (OSMO) workflow. Each instance may be used to generate and/or collect simulation data 932, goals 934, commands 936, records 938, and/or datasets 940 associated with a given scenario and/or set of scenarios. The number of instances of data-generation pipeline 902 and/or the number of nodes on which a given instance of data-generation pipeline 902 is deployed may be scaled to accommodate requirements and/or preferences associated with the amount of synthetic data to generate; applications and/or use cases associated with the synthetic data; coverage of environments, machines, policies 1304, goals 934, and/or scenarios associated with the synthetic data; and/or other factors. Additional OSMO workflows may also be used to launch pipelines that are used to train, test, and/or evaluate machine learning models, policies, hardware configurations, software stacks, twins, and/or other components or representations of machines using the generated simulation data 932, goals 934, commands 936, records 938, and/or datasets 940.

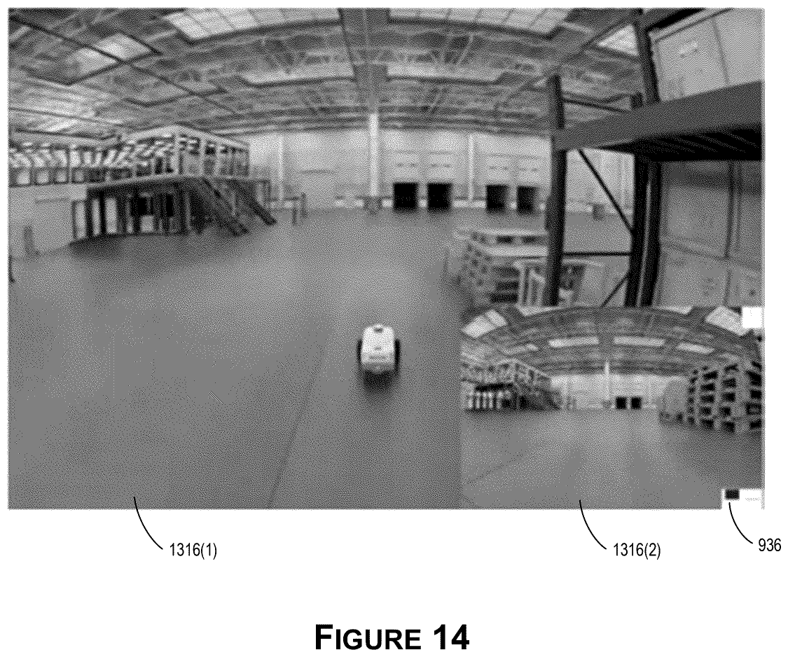

FIG. 14 illustrates example synthetic data generated by data-generation pipeline 902 of FIG. 9, according to various embodiments. As shown in FIG. 14, the synthetic data includes two images 1316(1)-1316(2) that depict a warehouse environment around a machine at a given time step within a simulation. Image 1316(1) includes a perspective view of the environment from a point that is behind the machine, and image 1316(2) includes a view from a camera on the machine. These images 1316(1)-1316(2) may be rendered by simulator 922 based on a 10D scene representing the environment, odometry values 1314 associated with the machine at the time step, and/or other simulation data 932.

The synthetic data can include a set of commands 936 associated with the same time step. These commands 936 can include a linear velocity with a magnitude that is depicted in the bar to the left and an angular velocity with a magnitude and direction that are depicted in the bar to the right. These commands 936 may be used to update the state of the robot and/or the environment within the simulation. The updated state(s) may then be used to generate new images 1316, other simulation data 932, and/or commands 936 for the next time step in the simulation.

It should be understood that this and other arrangements described herein are set forth only as examples. Other arrangements, components, features, and elements (e.g., machines, interfaces, functions, orders, groupings of functions, etc.) may be used in addition to or instead of those shown, and some elements may be omitted altogether. Further, many of the arrangements, components, features, elements, etc. described herein are functional entities that may be implemented as discrete or distributed components or in conjunction with other components, and in any suitable combination and location (e.g., on a local device, vehicle, or machine at the edge, on-premises—such as locally hosted servers, remotely located—such as in one or more computing or server devices in one or more data centers in the cloud, and/or at other locations). Various functions described herein as being performed by entities may be carried out by hardware, firmware, and/or software. For instance, various functions may be carried out using one or more processors (e.g., central processing units (CPU(s)), graphics processing units (GPU(s)), microprocessors, microcontrollers, embedded processors, digital signal processors (DSPs), image signal processors (ISPs), physics processing units (PPUs), field-programmable gate arrays (FPGAs), accelerator(s) (e.g., deep learning accelerators (DLAs), deep learning accelerator cluster (XNNs), neural network accelerators (NNAs), and/or neural processing units (NPUs), programmable vision accelerators (PVAs), optical flow accelerators (OFAs), etc.), application specific integrated circuits (ASICs), data processing units (DPUs), quantum processors, etc.) executing instructions stored in memory. In some embodiments, the systems, methods, and processes described herein may be executed using similar components, features, and/or functionality to those of example machine 1700 of FIGS. 17A-17E, example computing ecosystem 1800 of FIG. 18, example generative language model system 1900 of FIG. 19, and/or example computing device 2000 of FIG. 20.

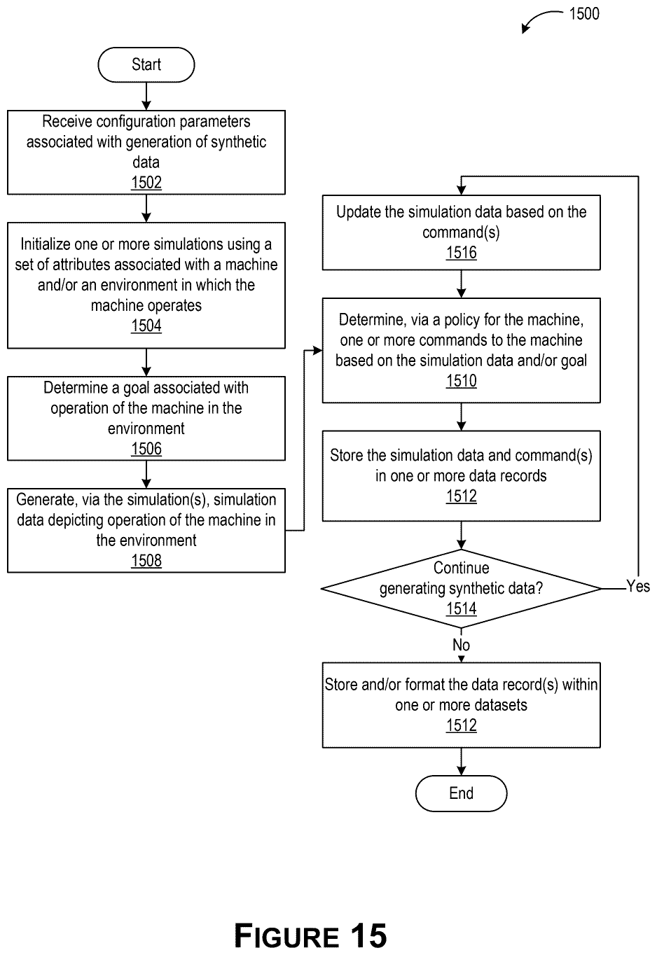

Now referring to FIG. 15, each block of method 1500, described herein, can include a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few. In addition, method 1500 is described by way of example, with respect to the system of FIG. 9. However, these methods may additionally or alternatively be executed by any one system, or any combination of systems, including, but not limited to, those described herein.

FIG. 15 illustrates a flow diagram of a method 1500 for generating synthetic data associated with a machine in an environment, according to various embodiments. As shown in FIG. 15, method 1500 can begin with operation 1502, in which data-generation pipeline 902 receives configuration parameters associated with generation of the synthetic data. For example, data-generation pipeline 902 may receive the configuration parameters via one or more configuration files, API calls, and/or user interfaces. The configuration parameters may be used to configure and/or customize the generation of the synthetic data. For example, the configuration parameters include a unique name and/or identifier for a given scenario (e.g., a combination of a particular environment, machine, goal, policy, etc.) under which data is to be generated and collected. The parameters may also be used to customize the environment and/or type of machine to be simulated, the goal, the policy, the type of data to log, the frequency with which the data is logged, and/or the way in which the logged data is converted into a format that is suitable for training and/or evaluating a machine learning model and/or another component of the machine.

In operation 1504, data-generation pipeline 902 can initialize one or more simulations using a set of attributes associated with the machine and/or the environment in which the machine operates. For example, data-generation pipeline 902 may use the configuration parameters to determine and/or randomize the machine type, machine model, and/or initial pose of the machine in the environment. Data-generation pipeline 902 may also, or instead, obtain, generate, and/or randomize a 10D scene corresponding to the environment and/or an occupancy map of the 10D scene. Data-generation pipeline 902 may also, or instead, add one or more objects to the 10D scene and/or set physics, material, and/or collision properties of the object(s).

In operation 1506, data-generation pipeline 902 can determine a goal associated with operation of the machine in the environment. For example, data-generation pipeline 902 may generate a navigation-based goal by sampling a location to which the machine is to navigate within the environment from unoccupied space within the environment. This sampling may be performed preferentially for certain regions within the environment that are specified in the configuration parameters and/or for certain regions with attributes that are specified in the configuration parameters.

In operation 1508, data-generation pipeline 902 can generate, via the simulation(s), simulation data depicting the operation of the machine in the environment. For example, data-generation pipeline 902 may render one or more images of the environment from the perspective of one or more cameras on the machine, one or more locations that are external to the machine, and/or other viewpoints. Data-generation pipeline 902 may also, or instead, generate point clouds, IMU measurements, and/or other sensor measurements associated with sensors on the machine.

In operation 1510, data-generation pipeline 902 can determine, via a policy for the machine, one or more commands to the machine based on the simulation data and/or goal. For example, data-generation pipeline 902 may input the simulation data and/or goal into a planning stack, neural network, and/or another component implementing the policy. Given the inputted data, the component may generate commands that specify linear and/or angular velocities for the machine. The component may also, or instead, generate one or more distributions of commands from which the command(s) are sampled.

In operation 1512, data-generation pipeline 902 can store the simulation data and command(s) in one or more data records. For example, data-generation pipeline 902 may associate the simulation data generated in operation 1508 and the commands generated in operation 1510 with the same time step and/or “frame” within the simulation(s). Data-generation pipeline 902 may also log the simulation data and command(s) in one or more data records associated with the time step and/or frame.

In operation 1514, data-generation pipeline 902 can determine whether or not to continue generating synthetic data. For example, data-generation pipeline 902 may determine that generation of synthetic data is to continue until the goal is reached by the machine, the simulation(s) have run for a certain number of time steps, and/or another condition is met. If data-generation pipeline 902 determines that generation of synthetic data is to continue, data-generation pipeline 902 performs operation 1516, in which data-generation pipeline updates the simulation data based on the command(s). For example, data-generation pipeline 902 may update the position, heading, velocity, and/or another state of the machine to reflect execution of the command(s) by the machine. Data-generation pipeline 902 may also, or instead, generate new images and/or sensor data that reflect the updated machine state.

Data-generation pipeline 902 can repeat operation 1510 to generate new commands based on the updated simulation data. Data-generation pipeline 902 similarly repeats operation 1512 to store the updated simulation data and command(s) in one or more additional data records. For example, data-generation pipeline 902 may store the updated simulation data and command(s) in association with a new (e.g., incremented) time step and/or frame. After a given set of simulation data and command(s) has been stored in one or more data records, data-generation pipeline 902 repeats operation 1514 to determine whether or not to continue generating synthetic data.

After data-generation pipeline 902 determines in operation 1514 that generation of synthetic data is to be discontinued, data-generation pipeline 902 can perform operation 1516, in which data-generation pipeline 902 stores and/or formats the data record(s) within one or more datasets. For example, data-generation pipeline 902 may generate a different dataset for each use case and/or application associated with the synthetic data. Within a given dataset, data-generation pipeline 902 may resample, format, and/or otherwise post-process the corresponding data records to adapt the data records to the corresponding use case and/or application. Data-generation pipeline 902 may then provide the dataset for use in training, testing, and/or evaluating machine learning models, hardware configurations, policies, digital twins, and/or other components and/or representations of machines in various environments.

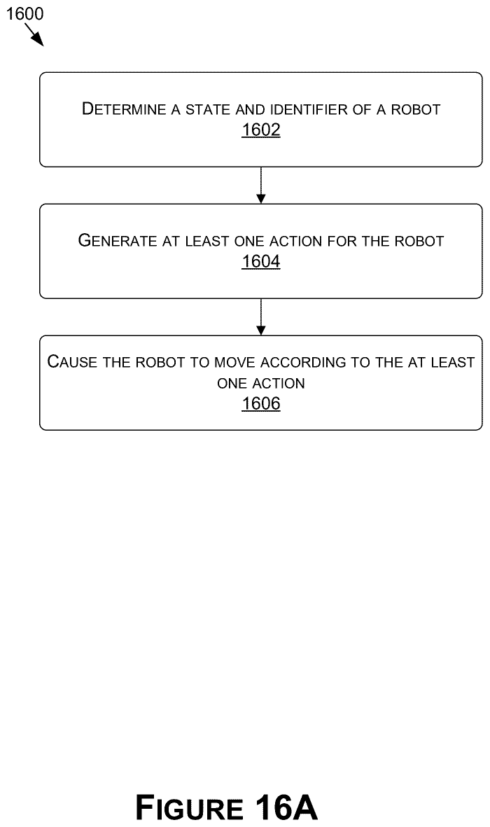

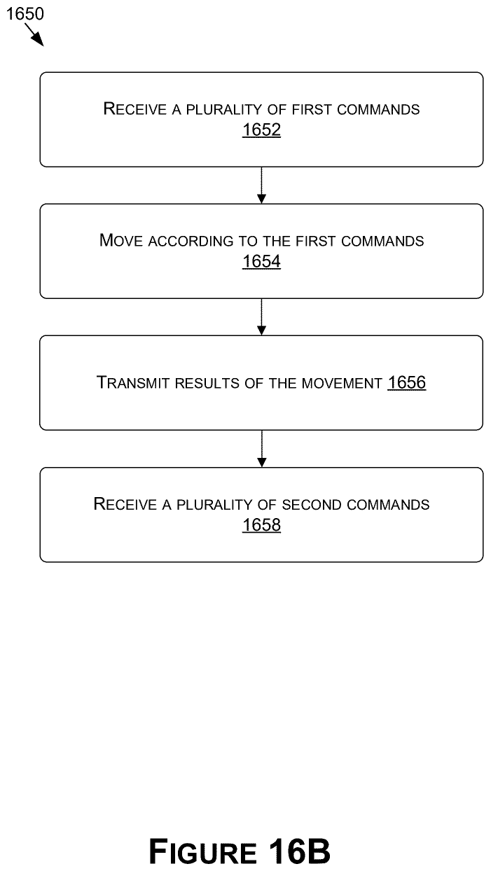

Now referring to FIG. 16A, each block of method 1600, described herein, comprises a computing process that may be performed using any combination of hardware, firmware, and/or software. For instance, various functions may be carried out using one or more processors (such as, but not limited to, those described herein) executing instructions stored in one or more memories or memory systems. In some embodiments, the computer processes may also be embodied as computer-usable instructions stored on computer storage media. The methods may be provided by a standalone application, a service or hosted service (standalone or in combination with another hosted service), an application programming interface (API) and/or a plug-in to another product, etc. In addition, method 1600 is described, by way of example, with respect to FIG. 1-3 or 9. However, these methods may additionally or alternatively be executed by any one system, or any combination of systems, including, but not limited to, those described herein.

FIG. 16A is a flow diagram showing a method 1600 for generating and transmitting at least one action to a robot, in accordance with some embodiments of the present disclosure. The method 1600, at block 1602, may include determining a state (e.g., policy token 208) and identifier (e.g., type embedding 306) of a robot (e.g., robot 1700). The state can be determined using a world model (e.g., world model 110) and the identifier can be indicative of a type of the robot (e.g., robot type 304). The state of the robot can include at least one of an environment of the robot, velocities of each joint of the robot, or a goal of the robot. The identifier can be same for robots of the plurality of robots of a same type. The identifier can include a one-hot morphology encoding indicating the robot type. The identifier can correspond to an embedding in an embedding space that identifies the robot as the type of robot from the plurality of types of robots. The type of the robot can include at least one of humanoid, wheeled, or quadruped robots

The method 1600 at block 1604 may include generating at least one action for the robot. The action can be generated by a generalist action policy (e.g., general action policy 130) processing the state and the identifier. The state and the identifier can be input into the action policy, and the action policy can output the action based on the state and the embedding. The generalist action policy can be generated using a combination of a base action policy (e.g., base policy 104) corresponding to the plurality of types of robots and one or more specialist action policies (e.g., specialist policy 122) individually corresponding to different robot types of the plurality of types of robots. The base action policy can be updated using imitation learning and a world model, the base action policy to receive at least one state of the robot as an input and output a base action to move the robot. The one or more specialist action policies can be updated using residual reinforcement learning, the one or more specialist action policies to receive the at least one state of the robot as an input and output a specialist action to move the robot. The one or more specialist action policies can be updated based at least on the base action policy, the specialist action being a combination of the base action and a residual action, the residual action to adapt the base action to a robot type of the robot.

In various embodiments, to generate the generalist action policy the combination of the base action policy and the one or more specialist action policies can be distilled. To generate the generalist action policy, the method 1600 can include generating, using each of the one or more specialist action policies, a plurality of specialist actions (e.g., specialist action 214) for the robot. The specialist actions can be generated using residual reinforcement learning. The residual reinforcement learning can include at least one reward (e.g., reward 226) and the method 1600 can further include generating the at least one reward based on results of the at least one robot type-specific action. The results can include at least one of a progress to the at least one goal, collision avoidance, and completion of the at least one goal, the at least one reward used to update the plurality of robot type-specific action policies.

In various embodiment, the method 1600 can include generating a plurality of normal distributions over the plurality of specialist actions using each of the one or more specialist action policies. The method 1600 can include combining the plurality of normal distributions. The method 1600 can include distilling the combination of the plurality of normal distributions into the generalist action policy by at least minimizing a divergence of the combination of the plurality of normal distributions.

The method 1600 at block 1606 may include causing the robot to move according to the action. Transmission of the action can direct and move the robot. In various embodiments, the at least one action includes a plurality of velocity commands each corresponding to a joint of the robot. To execute the at least one action, each of the plurality of velocity commands can be mapped to a respective joint of the robot. The plurality of types of robots can include at least a humanoid robot, an autonomous mobile robot (AMR), a wheeled robot, a warehouse vehicle or machine, or a quadruped robot. In various embodiments, the action is transmitted to at least one or more joints, actuators, or motors of the robot.

In various embodiments, causing the robot to move can include causing performance of a robot. In various embodiments, the method 1600 can include causing performance of one or more control operations associated with a robot based at least on one or more actions generated using the generalist action policy. The generalist action policy can generate the one or more actions (i) while conditioned using an embedding indicating a robot type from a plurality of robot types corresponding to the robot and (ii) based at least on the generalist action policy processing state information corresponding to the robot and an environment of the robot.

In various embodiments, the generalist action policy is trained using a teacher dataset generated using action outputs and latent states corresponding to specialist action policies associated with individual robot types of the plurality of robot types. The embedding can include a one-hot morphology encoding indicating the robot type. State information can be represented using at least a world model. The one or more control operations can correspond to one or more joints, actuators, or motors of the robot.

FIG. 16B is a flow diagram showing a method 1650 for a robot receiving and moving according to commands, in accordance with some embodiments of the present disclosure. The method 1650, at block 1652, may include receiving a plurality of first commands (e.g., action output by general action policy 130). The first commands can be received by a robot (e.g., robot 1700), and each of the first commands can be mapped to at least one of a joint, actuator, or motor of the robot. The first commands can be generated by a generalist action policy which can be generated based on a combination of a base action policy corresponding to a plurality of robots and one or more specialist action policies. The generalist action policy can correspond to the plurality of robots, and the one or more specialist action policies can be for one type of the plurality of robots. The generalist action policy can generate a action based on a state and an identifier of the robot. The identifier can indicate at least a type of the robot, and the state can indicate at least one of an environment of a robot, velocities of each joint of the robot, or a goal of the robot. The identifier can be an embedding and can be same for robots of a same type. The identifier can correspond to an embedding in an embedding space that identifies the robot as the type of robot from the plurality of types of robots. Following generations of the action, the generalist action policy can transmit the action to the robot which can be a plurality of first commands. The action can include a plurality of first commands which can be velocity commands and each can correspond to at least one of a joint, actuator, or motor of the robot.

In various embodiments, the base action policy is updated using imitation learning and a world model. The base action policy can receive at least one state of at least one of the plurality of robots as an input and output a base action to move the at least one of the plurality of robots. The plurality of specialist action policies can be updated using residual reinforcement learning. The plurality of specialist action policies can receive the at least one state of at least one of the plurality of robots as an input and output a specialist action to move the at least one of the plurality of robots. The plurality of specialist action policies can be updated based on the base action policy. The specialist action can be a combination of the base action and a residual action, the residual action to adapt the base action to the type of the at least one of the plurality of robots. To generate the generalist action policy, the combination of the base action policy and the one or more specialist action policies can be distilled.

In various embodiments, the type of the at least one of the plurality of robots can include at least a humanoid robot, an autonomous mobile robot (AMR), a wheeled robot, a warehouse vehicle or machine, or a quadruped robot. To generate the generalist action policy, the method 1650 can include generating, using the plurality of specialist action policies, a plurality of specialist actions for the at least one of the plurality of robots by inputting a plurality of states into the plurality of specialist action policies. The method 1650 can include generating, using each of the plurality of specialist action policies, a plurality of normal distributions over the plurality of specialist actions. The method 1600 can include combining the plurality of normal distributions and distilling the combination of the plurality of normal distributions into the generalist action policy by at least minimizing a divergence of the combination of the plurality of normal distributions.

The method 1650, at block 1654, can include moving according to the first commands. The robot can receive the first commands, and move according to the first commands. For example, to execute the action, the method 1650 can include each of the first commands being mapped to a respective joint of the robot, and each joint of the robot can move according to a respective first command.

The method 1650, at block 1656, may include transmitting results (e.g., results 222) of the movement. As the robot is moving according to the first commands, at least one of a controller or the robot can record the movement of the robot, and once movement according to the first commands is complete, the at least one of the controller or the robot can transmit the results of the movement to, for example, the system 100. The results can include at least one of a goal completion, route progress of the robot according to the first commands, and collisions.

The method 1650, at block 1658, can receive a plurality of second commands. The third action policy can generate the second commands according to the results, and a next state of the robot. The next state of the robot can be a result (e.g., ending position) of the robot as a result of moving according to the first commands.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, watercraft, shuttles (e.g., robotaxis), emergency response vehicles, motorcycles, electric or motorized bicycles, aircraft, construction vehicles, underwater craft (e.g., piloted or unpiloted submarines), drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets (e.g., NVIDIA's Omniverse), cloud computing, and/or any other suitable applications.

Disclosed embodiments may be comprised in a variety of different systems such as automotive systems (e.g., a control system for an autonomous or semi-autonomous machine, a perception system for an autonomous or semi-autonomous machine, etc.), systems implemented using a robot, aerial systems, medial systems, boating systems, smart area monitoring systems, systems for performing deep learning operations, systems for performing simulation operations, systems for performing digital twin operations, systems implemented using an edge device, systems implementing language models—such as large language models (LLMs), vision language models (VLMs), vision-language-action (VLA) models, and/or multi-modal language models (MMLMs), systems using or deploying one or more inference microservices, systems that incorporate deploy one or more machine learning models in a service or microservice along with an OS-level virtualization package (e.g., a container), a system for performing one or more wireless cellular transmissions using a wireless cellular network, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

### Example Autonomous or Semi-Autonomous Machine

FIG. 17A is an example of sensor locations having corresponding fields of view or sensory fields for an autonomous or semi-autonomous vehicle 1700a, an autonomous mobile robot (AMR) 1700b, and a humanoid robot 1700c, in accordance with some embodiments of the present disclosure. Although three types of machines 1700 are illustrated, this is not intended to be limiting, and the machine(s) 1700 described herein may include a vehicle, a car, a truck, a bus, a first responder vehicle, a shuttle, an electric or motorized bicycle, a motorcycle, a fire truck, a police or emergency vehicle, an ambulance, a watercraft, a construction vehicle, an underwater craft, a robot (e.g., AMR, humanoid, robotic arm, end-effector, forklift, etc.), a drone, an aircraft, a vehicle coupled to a trailer (e.g., a semi-tractor-trailer truck used for hauling cargo), and/or another type of vehicle or machine (e.g., that is unmanned and/or that accommodates one or more passengers). The vehicle 1700a, AMR 1700b, humanoid robot 1700c, and/or other machine types may be referred to herein collectively as machine 1700, in some instances.

With respect to vehicles 1700A, autonomous and semi-autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The machine 1700 may be capable of functionality in accordance with one or more of Level 3-Level 5 of the autonomous driving levels. The machine 1700 may be capable of functionality in accordance with one or more of Level 1-Level 5 of the autonomous driving levels. For example, the machine 1700 may be capable of driver assistance (Level 1), partial automation (Level 2, Level 2+, Level 2++), conditional automation (Level 3), high automation (Level 4), and/or full automation (Level 5), depending on the embodiment. The term “autonomous,” as used herein, may include any and/or all types of autonomy for the machine 1700 or other machine, such as being fully autonomous, being highly autonomous, being conditionally autonomous, being partially autonomous, providing assistive autonomy, being semi-autonomous, being primarily autonomous, or other designation.

With respect to FIG. 17A, the sensors and their respective fields of view (not illustrated for clarity purposes) or sensory fields (not illustrated for clarity purposes) are one example embodiment and are not intended to be limiting. Although not illustrated, each sensor may have a corresponding field of view (e.g., a 360 degree field of view of a surround camera 1768D, a 180 degree field of view of a wide-view camera 1770, a 360 degree sensory field of a LiDAR sensor 1764, etc.). For example, only a subset of the sensors illustrated may be included, additional sensors may be included, alternative sensors may be included, the number of each sensor modality may differ, the sensor modalities may differ (e.g., may not include LiDAR or RADAR, may include SONAR, thermal sensors, etc.), the sensor locations may be different from those illustrated on the vehicle 1700a, AMR 1700b, and/or humanoid robot 1700c, etc. For example, with respect to the vehicle 1700a, depending on the type (e.g., SUV, truck, sedan, robot, motorcycle, etc.), size (e.g., 18-wheeler, moving van, small sedan, etc.), and related functionality (e.g., L2 vs. L5), the locations, numbers, modalities, and/or other sensor information may differ. Similarly, for the AMR 1700b and/or humanoid robot 1700c, the shape, size, purpose, embodiment, model, etc. may dictate the number and types of sensors used.

As illustrated in FIG. 11A, the autonomous or semi-autonomous vehicle 1700A, the AMR 1700B, and the humanoid robot 1700C may include different sensor types, number, and locations. For a non-limiting example, the vehicle 1700A may include twelve cameras 1764, such as a front wide camera (e.g., 120 degree field of view (FOV)), a front telephoto camera (e.g., 30 degree FOV), a side rear left camera (e.g., 70 degree FOV), a side rear right camera (e.g., 70 degree FOV), a front fisheye camera (e.g., 200 degree FOV), a rear fisheye camera (e.g., 200 degree FOV), a left fisheye camera (e.g., 200 degree FOV), a right fisheye camera (e.g., 200 degree FOV), a front telephoto satellite camera (e.g., 30 degree FOV), a rear telephoto camera (e.g., 30 degree FOV), a cross left camera (e.g., 120 degree FOV), and a cross right camera (e.g., 120 degree FOV). The camera(s) 1764 may use, in embodiments, a gigabit multimedia serial link (GMSL) interface—such as GMSL2—as input/output (I/O).

In some embodiments, although not illustrated in FIG. 17A, the vehicle 1700A may include an in-cabin occupant and/or driver monitoring system, that may include various different sensors. For example, the in-cabin sensors may include various cameras 1768, such as a driver monitoring camera (e.g., 55 degree FOV positioned forward of and facing toward the driver seat), a front occupant monitoring camera (e.g., 190 degree FOV positioned forward of and facing the front occupant(s) seat(s)), and a rear occupant monitoring camera (e.g., 190 degrees positioned forward of and facing the rear occupant(s) seat(s)). Similar to the external facing camera(s) 1768, the internal camera(s) 1768 may, in embodiments, use a GMSL (such as GMSL2) interface for I/O.

As another non-limiting example, the vehicle 1700A may further include nine RADAR sensors 1760. For example, the vehicle 1700A may include a front center imaging RADAR sensor (e.g., 120 degree FOV or sensory field), a corner front left RADAR sensor (e.g., 160 degree FOV or sensory field), a corner front right RADAR sensor (e.g., 160 degree FOV or sensory field), a corner rear right RADAR sensor (e.g., 160 degree FOV or sensory field), a side left RADAR sensor (e.g., 160 degree FOV or sensory field), a side right RADAR sensor (e.g., 160 degree FOV or sensory field), a rear left RADAR sensor (e.g., 50 degree FOV or sensory field), and rear right RADAR sensor (e.g., 50 degree FOV or sensory field). The RADAR sensor(s) 1760 may use, in embodiments, an Ethernet interface as I/O.

The vehicle(s) 1700A may further include, as a non-limiting example, twelve ultrasonic sensors 1762. As illustrated in FIG. 17A, the ultrasonic sensors may be positioned along the front and rear bumpers of the vehicle 1700A, and along the side of the vehicle 1700A, and may be used to detect objects (static and dynamic) in close proximity to the vehicle 1700A. In some embodiments, the ultrasonic sensor(s) 1762 may use a DS13 interface as I/O.

The vehicle(s) 1700A may further include, as a non-limiting example, a LiDAR sensor 1764, such as a front center LiDAR sensor (e.g., 120 degree horizontal FOV or sensory field and 30 degree vertical FOV or sensor field). In some embodiments, such as where additional or alternative LiDAR sensors are used, the LiDAR sensor may have differing horizontal and vertical fields of view or sensory fields. For example, a LiDAR sensor 1764 may include a 360 degree horizontal FOV or sensory field (such as in a spinning LiDAR sensor) and a 90 degree vertical FOV or sensory field. In some embodiment, the LiDAR sensor(s) 1764 may use an Ethernet interface as I/O.

The autonomous mobile robot (AMR) 1700B may include, as a non-limiting example, three LiDAR sensors 1764. For example, the top-most illustrated LiDAR sensor 1764 may include a beam or 3D LiDAR sensor (e.g., 360 degree horizontal and 90 degree vertical FOV or sensory field), and the front and rear LiDAR sensors may include planar or 2D LiDAR sensors (e.g., 180 degree horizontal FOV or sensory field).

The AMR 1700B may further include, as a non-limiting embodiment, eight cameras 1768, such as a front stereo camera (e.g., 120 degree FOV), a rear stereo camera (e.g., 120 degree FOV), a left stereo camera (e.g., 120 degree FOV), a right stereo camera (e.g., 120 degree FOV), a front fisheye camera (e.g., 202 degree+−3 degree FOV), a rear fisheye camera (e.g., 202 degree+−3 degree FOV), a left fisheye camera (e.g., 202 degree+−3 degree FOV), and a right fisheye camera (e.g., 202 degree+−3 degree FOV).

The AMR 1700B may further include a charging port, charging port contacts, a status indicator light, one or more (e.g., four) RGB LEDs, one or more IMU sensors 1766, a magnetometer, and a barometer. The AMR 1700B is capable of high-precision time synchronization between sensors using hardware time stamping, and PTP over Ethernet with less than 10 microseconds for sensor acquisition time. The AMR 1700B provides simultaneous camera capture across all cameras 1768 within 100 microseconds from a single hardware trigger, in embodiments, and can write to disk at 4 GB/second for sensor capture to bag writing (e.g., writing to ROSbags for the robot operation system (ROS)). As such, the AMR 1700B is capable of running the ROS (such as NVIDIA's ISAAC ROS), can be teleoperated (as described herein), can map an environment, and can navigate within an environment using visual cameras 1768, LiDARs 1764, and/or other sensor types or modalities.

The humanoid robot 1700C may include, as a non-limiting example, one LiDAR sensor 1764. For example, the LiDAR sensor 1764 may include a beam or 3D LiDAR sensor (e.g., 360 degree horizontal and 90 degree vertical FOV or sensory field), or may include a planar or 2D LiDAR sensor (e.g., 180 degree horizontal FOV or sensory field).

The humanoid robot 1700C may further include, as a non-limiting embodiment, four cameras 1768, such as a front stereo camera (e.g., 120 degree FOV), a rear stereo camera (e.g., 120 degree FOV), a front fisheye camera (e.g., 202 degree+−3 degree FOV), and a rear fisheye camera (e.g., 202 degree+−3 degree FOV).

The humanoid robot 1700C may further include, as a non-limiting embodiment, four ultrasonic sensors 1762, such as a left arm ultrasonic sensor, a right arm ultrasonic sensor, a left leg ultrasonic sensor, and right leg ultrasonic sensor.

The humanoid robot 1700C may further include any number of actuators—such as to allow control and maneuverability of joints. For example, the humanoid robot 1700C may include actuators that allow for various degrees of freedom (DoF) depending on the design. In a non-limiting embodiment, the humanoid robot 1700C may have 40 total degrees of freedom (DoF) (e.g., 6 DoF×2 for the arms, 6 DoF×2 for the hands, 6 DoF×2 for the legs, 2 DoF for the torso, and 2 DoF for the neck). The actuators may convert energy into physical motion, allowing for actions such as joint movements, locomotion, and gripping/manipulation. For example, joint movements may be performed using motors and servos to control the rotation of joints in an arm or manipulator, and to allow for reaching, grabbing, and manipulating objects. Locomotion may be accomplished using wheels, tracks, or other locomotion devices (robotic legs) to move around the environment. Gripping and manipulation may be performed using end-effectors or hands/fingers, which may be equipped with actuators to grip objects, apply force, and perform specific tasks. In some examples, the humanoid robot 1700C may include position and orientation sensors, such as encoders, gyroscopes, and the like, to determine the position of the robot 1700C in space, allowing for location determination and movement tracking. The humanoid robot 1700C may include force and pressure sensors, in embodiments, to detect environment interactions, allowing the robot 1700C to grasp objects with the right force and to avoid obstacles along the way. The perception sensors (e.g., cameras, LiDARs, RADARs, ultrasonic, SONAR, etc.) may be used along with tactile sensors to allow the robot 1700C to perceive objects, shapes, and textures, and to understand when touch is initiated and stopped (along with force sensors that regulate the force used during touch). As a non-limiting example, the humanoid robot 1700C may have a height of about 1-2 meters (e.g., 1.7 meters or 5′ 6″), a weight of 50-70 kg, be capable of moving at a speed of 8 or more km/h, and be able to carry payloads anywhere from 20-100 kg, depending on the design and requirements of the system.

The humanoid robot 1700C, in embodiments, may include a conversational system—such as a conversational system powered by language models (e.g., LLMs, VLMs, MMLMs, VLAs, etc.)—in order to help understand the environment, reason, and communicate with humans, animals, devices, and/or other robots, and/or make planning, control, and navigation decisions. As such, in addition to performing various tasks, the humanoid robot 1700C may use onboard sensors, microphones, and speakers to understanding speech, audio and visual cues, etc., while also being able to communicate back to the environment.

With reference to cameras 1768 of the machine(s) 1700, the camera types for the cameras 1768 may include, but are not limited to, digital cameras that may be adapted for use with the components and/or systems of the machine 1700. For a vehicle 1700a embodiment, the camera(s) 1768 may operate at automotive safety integrity level (ASIL) B and/or at another ASIL. The camera types may be capable of any image capture rate, such as 30 frames per second (fps), 60 fps, 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

Cameras with a field of view that include portions of the environment in front of the machine 1700 (e.g., front-facing cameras) may be used for surround view, to help identify forward facing paths and obstacles, as well aid in, with the help of one or more controllers 1736 and/or control SoCs, providing information critical to generating an occupancy grid and/or determining the preferred machine movements, trajectories, and/or paths. Front-facing cameras may be used to perform many of the same ADAS functions as LiDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 1768B that may be used to perceive objects coming into view from the periphery (e.g., pedestrians, warehouse vehicles, other robots, crossing traffic, or bicycles). In addition, any number of long-range camera(s) 1768E (e.g., a long-view stereo camera pair) may be used for depth-based object detection, especially for objects for which a neural network has not yet been trained. The long-range camera(s) 1768E may also be used for object detection and classification, as well as basic object tracking.

Any number of stereo cameras 1768A may also be included in a front-facing and/or other (e.g., rear-facing) configuration. In at least one embodiment, one or more of stereo camera(s) 1768A may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the machine's 1700 environment, including a distance estimate for points in the image (e.g., a disparity or depth image). An alternative stereo camera(s) 1768A may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 1768A may be used in addition to, or alternatively from, those described herein. For example, in some embodiments, stereo depth estimation may be performed using other than stereo cameras, such as two monocular cameras having at least partially overlapping fields of view.

Cameras with a field of view that include portions of the environment to the side of the machine 1700 (e.g., side-view cameras) may be used, for example, for surround view, providing information used to create and update the occupancy grid, as well as to generate side impact collision warnings and/or to indicate to an AMR 1700B or humanoid robot 1700C, for example, that there are objects, features, and/or persons present to the side. For example, surround camera(s) 1768D may be positioned on the machine 1700. The surround camera(s) 1768D may include wide-view camera(s) 1768B, fisheye camera(s), 360 degree camera(s), and/or the like. For example, four fisheye cameras may be positioned on the machine's 1700 front, rear, and sides. In an alternative arrangement, the machine 1700 may use three surround camera(s) 1768D (e.g., left, right, and rear), and may leverage one or more other camera(s) (e.g., a forward-facing camera) as a fourth surround view camera.

Cameras 1768 with a field of view that include portions of the environment to the rear of the machine 1700 (e.g., rear-view cameras) may be used for gaining an understanding of objects, features, persons, and/or other information to the rear of the machine 1700, such as for park assistance, surround view, rear collision warnings, planning, control, and navigation determinations, and/or creating and updating an occupancy grid, BEV image representing the environment, height map, etc. A wide variety of cameras 1768 may be used including, but not limited to, cameras 1768 that are also suitable as a front-facing camera(s) (e.g., long-range and/or mid-range camera(s) 1768E, stereo camera(s) 1768A), infrared camera(s) 1768C, etc.), rear-facing camera(s), side-facing camera(s), downward facing camera(s), upward facing camera(s), and/or the like, as described herein.

Similarly, for LiDAR sensors 1764, RADAR sensors 1760, ultrasonic sensors 1762, and/or other sensor modalities or types, the location and placement of the sensors, and their corresponding fields of view or sensory fields may be determined based on the use case, embodiment, or design of the particular machine 1700.

For example, the machine(s) 1700 include RADAR sensor(s) 1760 that may be used by the machine 1700 for long-range object detection, even in darkness and/or severe weather conditions. RADAR functional safety levels may be ASIL B, in embodiments. The RADAR sensor(s) 1760 may use the CAN and/or the bus 1702 (e.g., to transmit data generated by the RADAR sensor(s) 1760) for control and to access object tracking data, with access to Ethernet to access raw data in some examples. A wide variety of RADAR sensor types may be used. For example, and without limitation, the RADAR sensor(s) 1760 may be suitable for front, rear, and side RADAR use. In some example, Pulse Doppler RADAR sensor(s) are used.

The RADAR sensor(s) 1760 may include different configurations, such as long range with narrow field of view, short range with wide field of view, short range side coverage, etc. In some examples, long-range RADAR may be used for adaptive cruise control (ACC) functionality. The long-range RADAR systems may provide a broad field of view realized by two or more independent scans, such as within a 250 m range. The RADAR sensor(s) 1760 may help in distinguishing between static and moving objects, and may be used by ADAS systems for emergency brake assist and forward collision warning, by robots for detecting dynamic objects in various environments—such as those with lower or no lighting. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the machine's 1700 surroundings at higher speeds with minimal interference from the periphery (e.g., from traffic in adjacent lanes). The other two antennae may expand the field of view, making it possible to quickly detect objects entering or leaving the machine's immediate path (e.g., lane).

Mid-range RADAR systems may include, as an example, a range of up to 1760 m (front) or 80 m (rear), and a field of view of up to 42 degrees (front) or 150 degrees (rear). Short-range RADAR systems may include, without limitation, RADAR sensors designed to be installed at both ends of a lateral surface (e.g., a rear bumper) such that two beams may be used to constantly monitor the blind spot in the rear and next to the machine 1700 (e.g., vehicle, robot, etc.). As such, short-range RADAR systems may be used in an ADAS system for blind spot detection and/or lane change assist.

The machine 1700 may further include ultrasonic sensor(s) 1762. The ultrasonic sensor(s) 1762, which may be positioned at the front, back, and/or the sides of the machine 1700, may be used for assisting with near-field perception, such as for park assist, collision avoidance (e.g., for robotic parts), and/or to create and update an occupancy grid, evidence grid map (EGM), height map, BEV image, and/or other representation of objects and features in an environment of the machine 1700. A wide variety of ultrasonic sensor(s) 1762 may be used, and different ultrasonic sensor(s) 1762 may be used for different ranges of detection (e.g., 2.5 m, 4 m). The ultrasonic sensor(s) 1762 may operate at functional safety levels of ASIL B, as an example.

The machine 1700 may include LiDAR sensor(s) 1764. The LiDAR sensor(s) 1764 may be used for object and feature detection, pedestrian and other robot detection, emergency braking, collision avoidance, simultaneous localization and mapping (SLAM), free-space detection, and/or other functions. The LiDAR sensor(s) 1764 may be functional safety level ASIL B, in embodiments. In some examples, the machine 1700 may include multiple LiDAR sensors 1764 (e.g., two, four, six, etc.) that may use Ethernet (e.g., to provide data to a Gigabit Ethernet switch).

In some examples, the LiDAR sensor(s) 1764 may be capable of providing a list of objects and their distances for a 360-degree field of view. Commercially available LiDAR sensor(s) 1764 may have an advertised range of approximately 1700 m, with an accuracy of 2 cm-3 cm, and with support for a 1700 Mbps Ethernet connection, for example. In some examples, one or more non-protruding LiDAR sensors 1764 may be used. In such examples, the LiDAR sensor(s) 1764 may be implemented as a small device that may be embedded into the front, rear, sides, top, and/or corners of the machine 1700. The LiDAR sensor(s) 1764, in such examples, may provide up to a 120-degree horizontal and 35-degree vertical field-of-view, with a 200 m range even for low-reflectivity objects. Front-mounted LiDAR sensor(s) 1764 may be configured for a horizontal field of view between 45 degrees and 135 degrees.

In some examples, LiDAR technologies, such as 3D flash LiDAR, may also be used. 3D Flash LiDAR uses a flash of a laser as a transmission source, to illuminate vehicle surroundings up to approximately 200 m. A flash LiDAR unit includes a receptor, which records the laser pulse transit time and the reflected light on each pixel, which in turn corresponds to the range from the vehicle to the objects. Flash LiDAR may allow for highly accurate and distortion-free images of the surroundings to be generated with every laser flash. In some examples, four flash LiDAR sensors may be deployed, one at each side of the machine 1700. Available 3D flash LiDAR systems include a solid-state 3D staring array LiDAR camera with no moving parts other than a fan (e.g., a non-scanning LiDAR device). The flash LiDAR device may use a 5 nanosecond class I (eye-safe) laser pulse per frame and may capture the reflected laser light in the form of 3D range point clouds and co-registered intensity data. By using flash LiDAR, and because flash LiDAR is a solid-state device with no moving parts, the LiDAR sensor(s) 1764 may be less susceptible to motion blur, vibration, and/or shock.

FIG. 17B is an illustration of sensor and component locations of an example autonomous or semi-autonomous vehicle 1700A (alternatively referred to herein as “vehicle 1700,” “ego-vehicle 1700,” “ego-machine 1700,” or “machine 1700,”), in accordance with some embodiments of the present disclosure. Although the vehicle 1700A is illustrated, this is not intended to be limiting, and similar components and/or sensors may be included on any other machine type without departing from the scope of the present disclosure. For example, similar sensors and/or components may be used for a vehicle, a car, a truck, a bus, a first responder vehicle, a shuttle, an electric or motorized bicycle, a motorcycle, a fire truck, a police vehicle, an ambulance, a watercraft, a construction vehicle, an underwater craft, a robot (e.g., AMR, humanoid, robotic arm, end-effector, forklift, etc.), a drone, an aircraft, a vehicle coupled to a trailer (e.g., a semi-tractor-trailer truck used for hauling cargo), and/or another type of vehicle or machine (e.g., that is unmanned and/or that accommodates one or more passengers).

FIG. 17C is a block diagram of an example system architecture for a machine 1700, such as autonomous or semi-autonomous vehicle 1700A, autonomous mobile robot (AMR) 1700B, humanoid robot 1700C, and/or other types of machines, in accordance with some embodiments of the present disclosure. It should be understood that this and other arrangements described herein are set forth only as examples. Other arrangements, components, features, and elements (e.g., machines, interfaces, functions, orders, groupings of functions, etc.) may be used in addition to or instead of those shown, and some elements may be omitted altogether. Further, many of the arrangements, components, features, elements, etc. described herein are functional entities that may be implemented as discrete or distributed components or in conjunction with other components, and in any suitable combination and location (e.g., on a local device, vehicle, or machine at the edge, on-premises—such as locally hosted servers, remotely located—such as in one or more computing or server devices in one or more data centers in the cloud, and/or at other locations). Various functions described herein as being performed by entities may be carried out by hardware, firmware, and/or software. For instance, various functions may be carried out using one or more processors (e.g., central processing units (CPU(s)), graphics processing units (GPU(s)), microprocessors, microcontrollers, embedded processors, digital signal processors (DSPs), image signal processors (ISPs), physics processing units (PPUs), field-programmable gate arrays (FPGAs), accelerator(s) (e.g., deep learning accelerators (DLAs, deep learning accelerator cluster (XNNs), neural network accelerators (NNAs), and/or neural processing units (NPUs), programmable vision accelerators (PVAs), optical flow accelerators (OFAs), etc.), application-specific integrated circuits (ASICs), data processing units (DPUs), quantum processors, etc.) executing instructions stored in memory. In some embodiments, the systems, methods, and processes described herein may be executed using similar components, features, and/or functionality to those of example machine 1700 of FIGS. 17A-17E, example computing ecosystem 1800 of FIG. 18, example generative language model system 1900 of FIG. 19, and/or example computing device 2000 of FIG. 20.

Each of the components, features, and systems of the machine 1700 in FIG. 17C are illustrated as being connected via bus 1702 (alternatively referred to as a “machine communications network 1702,” or just “communications network 1702”). The bus 1702 may include a Controller Area Network (CAN) data interface (alternatively referred to herein as a “CAN bus”). A CAN may be a network inside the machine 1700 used to aid in control of various features and functionality of the machine 1700, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant. In some embodiments, in addition to or alternatively from a CAN bus, the bus 1702 may include FlexRay, an embedded bus (e.g., SPI, I2C), local interconnect link (LIN), NVIDIA's NVLink, ultra accelerator Link (UALink), USB (2.0, 3.0, onward), radio frequency (RF), Ethernet (e.g., 10BASE/100BASE, 1000BASE, 10G, etc.), and/or another communication protocol or functionality. Additionally, although a single line is used to represent the bus 1702, this is not intended to be limiting. For example, there may be any number of busses 1702, which may include one or more CAN busses, one or more FlexRay busses, one or more Ethernet busses, and/or one or more other types of busses using a different protocol. In some examples, two or more busses 1702 may be used to perform different functions, and/or may be used for redundancy. For example, a first bus 1702 may be used for collision avoidance functionality and a second bus 1702 may be used for actuation control. In any example, each bus 1702 may communicate with any of the components of the machine 1700, and two or more busses 1702 may communicate with the same components. In some examples, each SoC 1704, each controller 1736, and/or each computer or compute engine within the machine 1700 may have access to the same input data (e.g., inputs from sensors of the machine 1700), and may be connected to a common bus, such as a CAN bus.

The machine 1700 may include components such as a chassis, a vehicle body, wheels (e.g., 2, 4, 6, 8, 18, etc.), tires, axles, batteries, side-view mirrors, and/or other components of a vehicle or machine. The machine 1700 may include a propulsion system 1750, such as an internal combustion engine, hybrid electric power plant, an all-electric engine, a hydrogen-fueled engine, and/or another propulsion system type. The propulsion system 1750 may be connected to a drive train of the machine 1700, which may include a transmission, to enable the propulsion of the machine 1700. The propulsion system 1750 may be controlled in response to receiving signals from the throttle/accelerator 1752.

A steering system 1754, which may include a steering wheel and/or other steering device (e.g., remote steering and/or local steering), may be used to steer the machine 1700 (e.g., along a desired path or route) when the propulsion system 1750 is operating (e.g., when the vehicle is in motion). The steering system 1754 may receive signals from a steering actuator 1756. In some embodiments, a steering wheel or other steering mechanism may not be included, such as for a machine 1700 capable of full automation (e.g., Level 5) functionality.

The brake sensor system 1746 may be used to operate the vehicle brakes in response to receiving signals from the brake actuators 1748 and/or brake sensors.

The machine 1700 may include one or more controller(s) 1736, such as those described herein with respect to FIG. 17A. The controller(s) 1736 may be used for a variety of functions, and may be coupled to any of the various other components and systems of the machine 1700. For example, the controllers 1736 may be used for control of the machine 1700, artificial intelligence executing on the machine 1700, infotainment for the machine 1700, and/or the like. For example, one controller 1736 may be used for some or all of the functionality, or different controllers 1736 may be used for different functionalities—e.g., to ensure availability and a safety separation between various controllers for different tasks. For example, the controller(s) 1736 may use plans computed by the system—e.g., paths or trajectories for vehicles 1700A or AMRs 1700B, or movements, components trajectories, movement locations or displacements, etc. for joints or components (e.g., of manipulators, end effectors, limbs, hands, fingers, legs, feet, etc.), of a humanoid robot 1700C—to control the machine(s) 1700 in the environment. In some instances, the controller(s) 1736 may include a proportional-integral-derivative (PID) controller, a fuzzy logic controller, a neural controller (e.g., a controller embodied as one or more neural networks), a force control controller, a programmable logic controller (PLC), and/or another type of controller. In a humanoid robot 1700C, for example, the controller(s) 1736 may act as the brain, responsible for analyzing sensor data, making decisions, and sending commands to the actuators. The controller(s) 1736 may include a low-level controller that handles basic motor control, ensuring accurate and precise movements of individual joints and actuators. The controller(s) 1736 may include a high-level controller to coordinate multiple actuators and sensors, planning complex motions and adapting to changing environments.

The controller(s) 1736 may include an artificial intelligence controller, in embodiments, that may use AI algorithms (e.g., DNNs, MLMs, etc.) to learn, make decisions, and autonomously perform tasks for the machine 1700. In some embodiments, the controller(s) 1736 may use an open-loop control algorithm that is fixed and does not adjust actions to the environment. In other embodiments, closed-loop control may be used that incorporates feedback mechanisms to monitor the robot's performance and make necessary adjustments. In examples, the controller(s) 1736 may implement reactive control in order to respond directly to sensory inputs, allowing for quick reflexes and real-time changes. Further, deliberative control may be implemented in some examples, using internal models and planning algorithms to generate high-level actions, which may be suited for complex tasks that require reasoning, decision making, and long-term planning.

Controller(s) 1736, which may include one or more systems on chip (SoCs) 1704 (FIGS. 17C and 17D), CPUs, GPU(s), accelerator(s), etc., may provide signals (e.g., representative of commands or messages) to one or more components and/or systems of the machine 1700. Although the controller(s) 1736 is listed separately from the SoC(s) 1704, this is not intended to be limiting, and in some embodiments one or more components of the SoC(s) 1704 may perform the operations of the controller(s) 1736. For example, the controller(s) may send signals to operate the machine brakes via one or more brake actuators 1748, to operate the steering system 1754 via one or more steering actuators 1756, to operate the propulsion system 1750 via one or more throttle/accelerators 1752, etc. The controller(s) 1736 may include one or more onboard (e.g., integrated) computing devices (e.g., supercomputers) that process sensor signals, and output operation commands (e.g., signals representing commands) to enable autonomous or semi-autonomous navigation and movement and/or to assist a human operator using the machine 1700. The controller(s) 1736 may include a first controller 1736 for autonomous control and navigation functions, a second controller 1736 for functional safety functions, a third controller 1736 for artificial intelligence functionality (e.g., computer vision), a fourth controller 1736 for infotainment functionality, a fifth controller 1736 for redundancy in emergency conditions, and/or other controllers. For example, the hardware used for safety monitoring and other safety functions (such as a functional safety island) may be discrete or partitioned (physically or via separation of processing) with respect to hardware used for processing sensor data for perception and making vehicle control decisions. Similarly, hardware (e.g., a controller, an SOC, etc.) for controlling in-vehicle infotainment and/or in-cabin monitoring may be discrete or separate from the hardware used for vehicle perception and control. In some examples, a single controller 1736 may handle two or more of the above functionalities, two or more controllers 1736 may handle a single functionality, and/or any combination thereof.

The controller(s) 1736 may provide the signals for controlling one or more components and/or systems of the machine 1700 in response to sensor data received from one or more sensors (e.g., sensor inputs). The sensor data may be received from, for example and without limitation, global navigation satellite systems (“GNSS”) sensor(s) 1758 (e.g., Global Positioning System sensor(s)), RADAR sensor(s) 1760, ultrasonic sensor(s) 1762, LiDAR sensor(s) 1764, inertial measurement unit (IMU) sensor(s) 1766 (e.g., accelerometer(s), gyroscope(s), magnetic compass(es), magnetometer(s), etc.), microphone(s) 1796, camera(s) 1768 (e.g., stereo camera(s) 1768A, wide-view camera(s) 1768B (e.g., fisheye cameras), infrared camera(s) 1768C, surround camera(s) 1768D (e.g., 360 degree cameras), long-range and/or mid-range camera(s) 1768E, and/or other camera types), speed sensor(s) 1744 (e.g., for measuring the speed of the machine 1700), vibration sensor(s) 1742, steering sensor(s) 1740, brake sensor(s) (e.g., as part of the brake sensor system 1746), actuators, and/or other sensor types.

One or more of the controller(s) 1736 may receive inputs (e.g., represented by input data) from an instrument cluster 1732 of the machine 1700 and provide outputs (e.g., represented by output data, display data, etc.) via a human-machine interface (HMI) display 1734 (e.g., screen, heads-up display, mirror display, facial display, robotic display, etc.), an audible annunciator, a loudspeaker, a speaker, and/or via other components of the machine 1700. The outputs may include information such as machine velocity, speed, time, map data corresponding to a map(s) 1722 of FIG. 17C (e.g., from a navigation map, a Standard Definition (SD) map, a High Definition (“HD”) map, etc.), location data (e.g., the machine's 1700 location, such as on a map 1722), direction, location of other vehicles (e.g., an occupancy map, height map, bird's eye view (BEV) image, grid, etc.), information about objects and status of objects as perceived by the system, system status information, etc. For example, the HMI display(s) 1734 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The machine 1700 may include one or more systems on a chip (SoCs) 1704 (described in more detail in FIG. 17D). The SoC(s) 1704 may include CPU(s) 1706, GPU(s) 1708, processor(s) 1710, cache(s) 1712, accelerator(s) 1714, data store(s) 1716, and/or other components and features. The SoC(s) 1704 may be used to process and provide data for various operations, such as navigation, planning, reasoning, inference, perception, control, and/or actuation operations of the machine 1700 in a variety of platforms and systems. For example, the SoC(s) 1704 may process live perception data (e.g., from camera, LiDAR, RADAR, ultrasonic, etc.) in addition to map data corresponding to one or more maps 1722 (e.g., HD map, SD map, navigational map, occupancy map, etc.) in order to make or aid in performing various operations of the machine 1700. Where a map and/or AI is used, map and/or AI (e.g., model parameter updates, fine-tuning, etc.) refreshes and/or updates via a network interface 1724 from one or more servers (e.g., server(s) 1778 of FIG. 17E)—such as one or more servers of a cloud-based data center.

Although an SoC(s) 1704 is illustrated throughout FIGS. 17A-17E, additional or alternative components and/or architectures may be used—such as multi-chip modules (MCMs), application-specific integrated circuits (ASICs), system-in-packages (SiPs), field programmable gate arrays (FPGAs), heterogeneous integration (HI), single-board computers (SBCs)—without departing from the scope of the present disclosure. For example, depending on the type of machine 1700, use of the machine 1700, model of the machine 1700, and required capabilities of the machine 1700, one or more SoCs 1704 and/or alternative architectures and/or components may be used to satisfy the particular embodiment.

The machine 1700 may include a CPU(s) 1718 (e.g., discrete CPU(s), or dCPU(s)), that may be coupled to the SoC(s) 1704 via a high-speed interconnect (e.g., PCIe). The CPU(s) 1718 may include an X86 processor, for example. The CPU(s) 1718 may be used to perform any of a variety of functions, including arbitrating potentially inconsistent results between ADAS sensors and the SoC(s) 1704, and/or monitoring the status and health of the controller(s) 1736 and/or infotainment SoC 1730, for example.

The machine 1700 may include a GPU(s) 1720 (e.g., discrete GPU(s), or dGPU(s)), that may be coupled to the SoC(s) 1704 via a high-speed interconnect (e.g., NVIDIA's NVLink, ultra accelerator Link (UALink), etc.). The GPU(s) 1720 may provide additional artificial intelligence functionality, such as by executing redundant and/or different neural networks, and may be used to train and/or update neural networks based on input (e.g., sensor data) from sensors of the machine 1700.

The machine 1700 may further include the network interface 1724 which may include one or more wireless antennas 1726 and/or modems (e.g., one or more wireless antennas for different communication protocols, such as a cellular antenna, a Bluetooth antenna, etc.). The network interface 1724 may be used to enable wireless connectivity over the Internet with the cloud (e.g., with the server(s) 1778 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the machine 1700 information about vehicles in proximity to the machine 1700 (e.g., vehicles in front of, on the side of, and/or behind the machine 1700). This functionality may be part of a cooperative adaptive cruise control functionality of the machine 1700.

The network interface 1724 may include a SoC that provides modulation and demodulation functionality and enables the controller(s) 1736 to communicate over wireless networks. The network interface 1724 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. For example, the network interface 1724 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), fifth generation of mobile communications technology (5G), sixth generation of mobile communications technology (6G), and/or other cellular and/or wireless communication standards. The wireless antenna(s) 1726 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

The machine 1700 may further include data store(s) 1728 which may include off-chip (e.g., off the SoC(s) 1704) storage. The data store(s) 1728 may include one or more storage elements including RAM, SRAM, DRAM, VRAM, Flash, hard disks, and/or other components and/or devices that may store at least one bit of data.

The machine 1700 may further include GNSS sensor(s) 1758. The GNSS sensor(s) 1758 (e.g., GPS, assisted GPS sensors, differential GPS (DGPS) sensors, etc.), to assist in mapping, perception, occupancy grid generation, and/or path planning functions. Any number of GNSS sensor(s) 1758 may be used, including, for example and without limitation, a GPS using a USB connector with an Ethernet to Serial (RS-232) bridge.

The machine 1700 may further include IMU sensor(s) 1766. The IMU sensor(s) 1766 may be located at a center of the rear axle of the machine 1700, in some examples. The IMU sensor(s) 1766 may include, for example and without limitation, an accelerometer(s), a magnetometer(s), a gyroscope(s), a magnetic compass(es), and/or other sensor types. In some examples, such as in six-axis applications, the IMU sensor(s) 1766 may include accelerometers and gyroscopes, while in nine-axis applications, the IMU sensor(s) 1766 may include accelerometers, gyroscopes, and magnetometers.

In some embodiments, the IMU sensor(s) 1766 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 1766 may enable the machine 1700 to estimate heading without requiring input from a magnetic sensor by directly observing and correlating the changes in velocity from GPS to the IMU sensor(s) 1766. In some examples, the IMU sensor(s) 1766 and the GNSS sensor(s) 1758 may be combined in a single integrated unit.

The vehicle may include one or more microphone 1796 placed in and/or around the machine 1700. The microphone(s) 1796 may be used for emergency vehicle detection and identification, among other things.

The machine 1700 may further include vibration sensor(s) 1742. The vibration sensor(s) 1742 may measure vibrations of components of the machine, such as the arms or legs of a humanoid robot 1700C, or the axle(s) of a vehicle 1700A or AMR 1700B. For example, changes in vibrations may indicate a change in road, walking, or traversable surfaces. In another example, when two or more vibration sensors 1742 are used, the differences between the vibrations may be used to determine friction or slippage of the surface (e.g., when the difference in vibration is between a power-driven axle and a freely rotating axle).

The machine 1700 may include an ADAS system 1738—such as when the machine 1700 is a vehicle 1700A. The ADAS system 1738 may include a dedicated SoC(s), in some examples. The ADAS system 1738 may include autonomous/adaptive/automatic cruise control (ACC), cooperative adaptive cruise control (CACC), forward crash or collision warning (FCW), automatic emergency braking (AEB), lane departure warning (LDW), lane keep assist (LKA), blind spot warning (BSW), blind spot monitoring (BSM), rear cross-traffic warning (RCTW), pedestrian detection, driver monitoring, collision warning systems (CWS), traffic sign recognition, speed limit detection, automatic parking, lane centering (LC), high beam safety system, and/or other features and functionality.

The machine 1700 may further include the infotainment SoC 1730 (e.g., an in-vehicle infotainment system (IVI)). Although illustrated and described as a SoC, the infotainment system may not be an SoC, and may include one or more discrete components, such as multi-chip modules (MCMs), application-specific integrated circuits (ASICs), system-in-packages (SiPs), heterogeneous integration (HI), single-board computers (SBCs), etc. The infotainment SoC 1730 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., wireless, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the machine 1700. For example, the infotainment SoC 1730 may radios, disk players, navigation systems, video players, USB and Bluetooth connectivity, carputers, in-car entertainment, Wi-Fi, steering wheel audio controls, hands free voice control, a heads-up display (HUD), an HMI display 1734, a telematics device, a control panel (e.g., for controlling and/or interacting with various components, features, and/or systems), and/or other components. The infotainment SoC 1730 may further be used to provide information (e.g., visual and/or audible) to a user(s) of the vehicle, such as information from the ADAS system 1738, autonomous driving information such as planned vehicle maneuvers, trajectories, surrounding environment information (e.g., intersection information, vehicle information, road information, etc.), and/or other information.

The infotainment SoC 1730 may include GPU functionality. The infotainment SoC 1730 may communicate over the bus 1702 (e.g., CAN bus, Ethernet, etc.) with other devices, systems, and/or components of the machine 1700. In some examples, the infotainment SoC 1730 may be coupled to a supervisory MCU such that the GPU of the infotainment system may perform some self-driving functions in the event that the primary controller(s) 1736 (e.g., the primary and/or backup computers of the machine 1700) fail. In such an example, the infotainment SoC 1730 may put the machine 1700 into a chauffeur to safe stop mode, as described herein.

In some embodiments, the infotainment system may provide a digital or virtual assistant, that may be voice only, or may have a visual component (e.g., in the form of a digital human or digital avatar). The assistant may provide basic functions, like texting, adjusting vehicle settings, music or video control, navigation features, etc., and/or may provide more advanced features such as those supported by one or more language models—such as large language models (LLMs), vision language models (VLMs), multi-modal language models (MMLMs), etc. For example, the driver and/or occupants may be able to interact with the assistant similar to how a user may interact with a language model, such as to ask general questions, specific questions, to request restaurant, gas station, and/or other recommendations and/or locations, to learn about the vehicle functionality or troubleshooting (e.g., to ask tire pressure information, oil change information, battery exchange information, etc.). As such, the machine 1700—whether a vehicle 1700A, AMR 1700B, humanoid robot 1700C, and/or other type of machine—may include a locally stored language model(s) and/or communicate to a remotely hosted language model (e.g., via one or more APIs) to provide more detailed and in-depth communication features to the users of the machine(s) 1700.

In some examples, an infotainment SoC 1730, the SoC(s) 1704, and/or another SoC or computing/processing system may perform in-cabin driver and/or occupant monitoring. For example, the computing system may perform facial recognition and vehicle owner identification may use data from camera and/or other sensors to identify the presence of an authorized driver and/or owner of the machine 1700. The always on sensor processing engine may be used to unlock the vehicle when the owner approaches the driver door and turn on the lights, and, in security mode, to disable the vehicle when the owner leaves the vehicle. In this way, the SoC(s) 1704 provide for security against theft and/or carjacking.

In some embodiments, an in-cabin monitoring camera sensor may be monitored using one or more neural networks running on another or dedicated SoC—such as an in-vehicle infotainment or in-vehicle monitoring SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. The in-cabin system may further include one or more in-cabin AI agents or assistants, which may use one or more APIs or plug-ins to interact with one or more LLMs, VLMs, MMLMs, etc. in the cloud. For example, the in-cabin AI agents or assistants may provide directions, vehicle or machine feedback information, answer general questions, handle music/video and/or other requests, activate windows, doors, and/or other vehicle components, etc. As such, one or more dedicated SoCs and/or sets of processors may be used to perform the in-cabin infotainment and/or in-cabin monitoring (e.g., as an occupant monitoring system (OMS)) for the machine 1700.

The machine 1700 may further include an instrument cluster 1732 (e.g., a digital dash, an electronic instrument cluster, a digital instrument panel, etc.). The instrument cluster 1732 may include a controller and/or supercomputer (e.g., a discrete controller or supercomputer). The instrument cluster 1732 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 1730 and the instrument cluster 1732. In other words, the instrument cluster 1732 may be included as part of the infotainment SoC 1730, or vice versa.

FIG. 17D is a block diagram of an example architecture of a computing system (a subset of the system described with respect to FIG. 17C), in accordance with at least some embodiments of the present disclosure. Although illustrated as an SoC(s) 1704, this is not intended to be limiting, and the computing system may additionally or instead include multi-chip modules (MCMs), application-specific integrated circuits (ASICs), system-in-packages (SiPs), heterogeneous integration (HI), single-board computers (SBCs), and/or other components and/or architectures, without departing from the scope of the present disclosure.

The SoC(s) 1704 may be an end-to-end platform with a flexible architecture that spans automation levels 2-5, or the SoC(s) 1704 may be specifically designed for a specific automation level (e.g., a first SoC 1704 for level 2 to level 2++, a second SoC 1704 for level 3, a third SoC 1704 for level 4, etc.), thereby providing a comprehensive functional safety architecture that leverages and makes efficient use of computer vision, neural network inferencing, robotic planning, control, and navigation, ADAS techniques, and the like, with diversity and redundancy, to provide a platform for a flexible, reliable driving or robotic control software stack, along with deep learning tools. The SoC(s) 1704 may be faster, more reliable, and even more energy-efficient and space-efficient than conventional systems. For example, the accelerator(s) 1714, when combined with the CPU(s) 1706, the GPU(s) 1708, and the data store(s) 1716, may provide for a fast, efficient platform for level 2-5 autonomous vehicles as well as for safe planning, navigation, and control of AMRs 1700B, humanoid robots 1700C, and/or other robot or machine types.

In some embodiments, such as where the SoC(s) 1704 include a GPU 1708 with 2000 or more cores (e.g., 2048 cores), 60 or more tensor cores (e.g., 64 tensor cores), and a GPU max frequency of over 1 GHz (e.g., 1.3 GHZ), a CPU 1706 including 10 or more cores (e.g., 12 cores), with 64 bits, 3 MB L2 and 6 MB L3 cache memory, and a max frequency of 2 or more GHz (e.g., 2.2 GHZ), one or more deep learning accelerators (DLAs), deep learning accelerator clusters (XNNs), neural network accelerators (NNAs), or neural processing units (NPUs) 1709 (e.g., 2 DLAs/XNNs/NNAs/NPUs 1709), and a vision accelerator—such as a programmable vision accelerator (PVA) 1707, a single SoC 1704) may be capable of 275 tera operations per second (TOPS) of AI performance. For example, NVIDIA's Jetson AGX Orin 64 GB SoC satisfies these criteria, and achieves this performance.

Similarly, in embodiments where the SoC(s) 1704 include a GPU 1708 with 1700 or more cores (e.g., 1792 cores), 50 or more tensor cores (e.g., 56 tensor cores), and a GPU max frequency of over 900 MHz (e.g., 930 MHz), a CPU 1706 including 8 or more cores (e.g., 8 cores), with 64 bits, 2 MB L2 and 4 MB L3 cache memory, and a max frequency of 2 or more GHz (e.g., 2.2 GHz), one or more deep learning accelerators (DLAs), deep learning accelerator clusters (XNNs), neural network accelerators (NNAs), or neural processing units (NPUs) 1709 (e.g., 2 DLAs/XNNs/NNAs/NPUs 1709), and a vision accelerator—such as a programmable vision accelerator (PVA) 1707, a single SoC 1704) may be capable of 200 tera operations per second (TOPS) of AI performance. For example, NVIDIA's Jetson AGX Orin 32 GB SoC satisfies these criteria, and achieves this performance.

In some embodiments, such as where the SoC(s) 1704 include a GPU 1708 with 1000 or more cores (e.g., 1024 cores), 28 or more tensor cores (e.g., 32 tensor cores), and a GPU max frequency of over 900 MHz (e.g., 1173 MHz), a CPU 1706 including 8 or more cores (e.g., 8 cores), with 64 bits, 2 MB L2 and 4 MB L3 cache memory, and a max frequency of 2 or more GHz (e.g., 2 GHZ), one or more deep learning accelerators (DLAs), deep learning accelerator clusters (XNNs), neural network accelerators (NNAs), or neural processing units (NPUs) 1709 (e.g., 1 DLA/XNN/NNA/NPU 1709), and a vision accelerator—such as a programmable vision accelerator (PVA) 1707, a single SoC 1704) may be capable of 157 tera operations per second (TOPS) of AI performance. For example, NVIDIA's Jetson AGX Orin NX 16 GB SoC satisfies these criteria, and achieves this performance.

In various embodiments, such as where the SoC(s) 1704 include a GPU 1708 with 1000 or more cores (e.g., 1024 cores), 28 or more tensor cores (e.g., 32 tensor cores), and a GPU max frequency of over 900 MHz (e.g., 1020 MHz), a CPU 1706 including 6 or more cores (e.g., 6 cores), with 64 bits, 1.5 MB L2 and 4 MB L3 cache memory, and a max frequency of 1.5 or more GHz (e.g., 1.7 GHZ), a single SoC 1704) may be capable of 67 tera operations per second (TOPS) of AI performance. For example, NVIDIA's Jetson Orin Nano 8 GB SoC satisfies these criteria, and achieves this performance.

The SoC(s) 1704 may include one or more CPUs 1706. The CPU(s) 1706 may include a CPU cluster or CPU complex (alternatively referred to herein as a “CCPLEX”), in embodiments. The CPU(s) 1706 may include multiple cores and/or (e.g., L2, L3) caches. For example, in some embodiments, the CPU(s) 1706 may include twelve cores in a coherent multi-processor configuration. In some embodiments, the CPU(s) 1706 may include four dual-core clusters where each cluster has a dedicated L2 cache (e.g., a 3 MB L2 cache). The CPU(s) 1706 (e.g., the CCPLEX) may be configured to support simultaneous cluster operation enabling any combination of the clusters of the CPU(s) 1706 to be active at any given time.

The SoC(s) 1704 may include any type and number of GPUs 1708. For example, an integrated GPU(s) (alternatively referred to herein as an “iGPU(s)”) may be used in some embodiments. The GPU(s) 1708 may be programmable and may be efficient for parallel workloads. The GPU(s) 1708, in some examples, may use an enhanced tensor instruction set. The GPU(s) 1708 may include one or more streaming microprocessors, where each streaming microprocessor may include a cache (e.g., an L1 cache with at least 96 KB storage capacity), and two or more of the streaming microprocessors may share an L2 cache (e.g., an L2 cache with a 512 KB storage capacity). In some embodiments, the GPU(s) 1708 may include at least eight streaming microprocessors. The GPU(s) 1708 may use compute application programming interface(s) (API(s)). In addition, the GPU(s) 1708 may use one or more parallel computing platforms and/or programming models (e.g., NVIDIA's CUDA).

The GPU(s) 1708 may be power-optimized for best performance in automotive, robotics, and/or other embedded use cases. For example, the GPU(s) 1708 may be fabricated on a Fin field-effect transistor (FinFET). However, this is not intended to be limiting and the GPU(s) 1708 may be fabricated using other semiconductor manufacturing or fabrication processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an (e.g., L0) instruction cache, a warp scheduler, a dispatch unit, and/or a (e.g., 64 KB) register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 1708 may include a high bandwidth memory (HBM) and/or a (e.g., 16 GB) HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 1708 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 1708 to access the CPU(s) 1706 page tables directly. In such examples, when the GPU(s) 1708 memory management unit (MMU) experiences a miss, an address translation request may be transmitted to the CPU(s) 1706. In response, the CPU(s) 1706 may look in its page tables for the virtual-to-physical mapping for the address and transmits the translation back to the GPU(s) 1708. As such, unified memory technology may allow a single unified virtual address space for memory of both the CPU(s) 1706 and the GPU(s) 1708, thereby simplifying the GPU(s) 1708 programming and porting of applications to the GPU(s) 1708.

The SoC(s) 1704 may include any number of cache(s) 1712, including those described herein. For example, the cache(s) 1712 may include L0 caches, L1 caches, L2 caches, L3 caches (e.g., that are available to both the CPU(s) 1706 and the GPU(s) 1708 (e.g., that is connected both the CPU(s) 1706 and the GPU(s) 1708)), etc. The cache(s) 1712 may include a write-back cache that may keep track of states of lines, such as by using one or more cache coherence protocol (e.g., MEI, MESI, MSI, etc.). The (e.g., L3) cache may include 4 MB or more, depending on the embodiment, although smaller or larger cache sizes may be used.

The SoC(s) 1704 may include one or more arithmetic logic units (ALUs) 1765 which may be leveraged in performing processing with respect to any of the variety of tasks or operations of the machine 1700—such as computer vision, machine learning or deep learning processing, world model management, etc. In addition, the SoC(s) 1704 may include a floating point unit(s) (FPU(s)) 1767—or other math coprocessor or numeric coprocessor types—for performing mathematical operations within the system. For example, the SoC(s) 1704 may include one or more FPUs 1767 integrated as execution units within a CPU(s) 1706 and/or GPU(s) 1708.

The SoC(s) 1704 may include one or more accelerators 1714 (e.g., hardware accelerators, software accelerators, or a combination thereof). For example, the SoC(s) 1704 may include a hardware acceleration cluster that may include optimized hardware accelerators and/or large on-chip memory. The large on-chip memory 1715 (e.g., 4 MB of SRAM, 32 GB and/or 64 GB 256-bit LPDDR5 at 204.8 GB/s, 8 GB and/or 16 GB 128-bit LPDDR5 at 102.4 GB/s, and/or other memory types and sizes), may enable the hardware acceleration cluster to accelerate neural network processing, transformer processing, optical flow processing, vision processing, and/or other calculations or processing. The hardware acceleration cluster may be used to complement the GPU(s) 1708 and to off-load some of the tasks of the GPU(s) 1708 (e.g., to free up more cycles of the GPU(s) 1708 for performing other tasks). As an example, the accelerator(s) 1714 may be used for targeted workloads (e.g., perception, convolutional neural networks (CNNs), deep neural networks (DNNs), language models (LLMs, VLMs, MMLMs, VLAs, etc.), transformer models, diffusion models, encoder-only models, encoder-decoder models, etc. that are stable enough to be amenable to acceleration.

The accelerator(s) 1714 (e.g., the hardware acceleration cluster) may include a deep learning accelerator(s) (DLA) 1709 (alternatively referred to herein as “a deep learning accelerator cluster (XNN) 1709,” “neural network accelerator (NNA) 1709,” or “neural processing unit (NPU) 1709”). The DLA(s) 1709 may include one or more Tensor processing units (TPUs) 1741 that may be configured to provide an additional, e.g., ten trillion operations per second for deep learning applications and inferencing. The TPUs 1741 may be accelerators configured to, and optimized for, performing image processing functions (e.g., for CNNs, RCNNs, DNNs, etc.). The DLA(s) 1709 may further be optimized for a specific set of neural network types and floating point operations, as well as inferencing. The design of the DLA(s) may provide more performance per millimeter than a general-purpose GPU, and vastly exceeds the performance of a CPU. The TPU(s) 1741 may perform several functions, including a single-instance convolution function, supporting, for example, INT8, INT16, and FP16 data types for both features and weights, as well as post-processor functions. Although the TPU(s) 1741 are described as being included as part of the DLA(s) 1709, this is not intended to be limiting, and the TPU(s) 1741 may be included in additional or alternative accelerator(s) 1714 and/or other components, and/or may be included as a discrete processing component(s).

The DLA(s) 1709 may quickly and efficiently execute neural networks on processed or unprocessed data for any of a variety of functions, including, for example and without limitation: for object and feature identification and detection (e.g., vehicles, pedestrians, other robots, lane lines, road boundary lines, debris, potholes, boxes, warehouse items, etc.) using data from one or more sensor modalities; for distance estimation using data from one or more sensor modalities; for emergency vehicle detection and identification and detection using data from microphones and/or vision-based sensors; for facial recognition; for pick and place operations; for manipulation operations; for occupant monitoring; for vehicle owner identification; and/or other in-cabin operations using data from in-cabin cameras and/or other sensor types; and/or a for security and/or safety related events, to name a few.

The DLA(s) 1709 may perform any function of the GPU(s) 1708, and by using an inference accelerator, for example, a designer may target either the DLA(s) 1709 or the GPU(s) 1708 for any function. For example, the designer may focus processing of DNNs and floating point operations on the DLA(s) 1709 and leave other functions to the GPU(s) 1708 and/or other accelerator(s) 1714. The DLA(s) 1709 may be used to run any type of network to enhance control and safety, including for example, a neural network that outputs a measure of confidence for each object detection.

The accelerator(s) 1714 (e.g., the hardware acceleration cluster) may include a programmable vision accelerator(s) (PVA) 1707, which may alternatively be referred to herein as a computer vision accelerator or generally a vision accelerator. The PVA(s) 1707 may be designed and configured to accelerate computer vision algorithms for the advanced driver assistance systems (ADAS), semi-autonomous driving, autonomous driving, robotics applications, security and surveillance applications, augmented reality (AR), virtual reality (VR), and/or mixed reality (MR) applications, etc. The PVA(s) 1707 may provide a balance between performance and flexibility. For example, each PVA(s) 1707 may include, for example and without limitation, any number of reduced instruction set computer (RISC) cores, direct memory access (DMA) systems, pixel processing engines (PPEs), vector processors or vector processing units (VPUs), and/or other components. The PVA engine may include an advanced very long instruction word (VLIW), single instruction multiple data (SIMD) digital signal processor. The PVA(s) 1707 may be optimized for the tasks of image processing and computer vision algorithm acceleration. For example, the PVA(s) 1707 provides excellent performance with extremely low power consumption, and can be used asynchronously and concurrently with the CPU(s) 1706, GPU(s) 1708, and/or other accelerators in the system (e.g., vehicle, robot, etc.) as part of a heterogeneous compute pipeline.

The PVA(s) 1707 may include one or more (e.g., two) vector processing subsystems (VPS), where each VPS may include one or more vector processing unit (VPU) cores, one or more decoupled look-up units (DLUTs), one or more shared or vector memories (VMEMs), and one or more instruction caches (I-caches). The VPU core(s) may be the main processing unit, and may include a vector SIMD VLIW DSP 1743 optimized for computer vision. The VPU core(s) may fetch instructions through the I-cache(s), and may access data through the VMEM(s). The DLUT(s) may include a specialized hardware component that enhances the efficiency of parallel lookup operations. For example, the DLUT(s) allow parallel lookups using a single copy of the lookup table by executing these lookups in a decoupled pipeline, independent of the primary processor pipeline. By doing so, the DLUT(s) minimize or reduce memory usage and enhance throughput while avoiding data-dependent memory bank conflicts-ultimately leading to improved overall system performance. The VPU VMEM(s) may provide local data storage for the VPU, allowing efficient embodiment of various image processing and computer vision algorithms. The VPU VMEM(s) may support access from outside-VPS hosts such as direct memory access (DMA) and the CPU(s) 1706 (e.g., ARM Cortex-R5 processor), facilitating data exchange with the CPU(s) 1706 and other system-level components. The VPU I-cache may supply instruction data to the VPU(s) when requested, may request missing instruction data from system memory, and/or may maintain temporary instruction storage for the VPU. For each VPU task, the CPU(s) 1706 may configures the DMA system, optionally prefetch the VPU program into VPU I-cache, and/or kick off each VPU-DMA pair to process a task. The PVA(s) 1707 may also include an L2 SRAM memory to be shared between the one or more (e.g., two) sets of VPS and DMA. In some embodiments, one or more (e.g., two) DMA devices are used to move data among external memory, PVA L2 memory, the VMEMs (e.g., one in each VPS), CPU(s) tightly coupled memory (TCM), DMA descriptor memory, and/or PVA-level config registers. In a lightly loaded system, two parallel DMA accesses to DRAM can achieve a read/write bandwidth of up to 15 GB/s each and, in a heavily loaded system, this bandwidth can reach up to 10 GB/s each. With respect to compute compacity, the INT8 Giga Multiply-Accumulate Operations per Second (GMACs) may be 2048 or greater, excluding the DLUT. The FP32 GMACs may include 32 per PVA instance.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA system may enable components of the PVA(s) 1707 to access the system memory independently of the CPU(s) 1706. The DMA may support any number of features used to provide optimization to the PVA(s) 1707 including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors or VPUs may be programmable processors that may be designed to efficiently and flexibly execute programming for computer vision algorithms and provide signal processing capabilities. In some examples, the PVA(s) 1707 may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA(s) 1707, and may include one or more vector processing units (VPUs), one or more pixel processing engines (PPEs)—which may include a 2D layout of interconnected (e.g., for north, south, east, west intercommunication) processing elements, one or more instruction caches, and/or one or more shared or vector memories (e.g., VMEMs). A VPU core may include a digital signal processor such as, for example, a single instruction, multiple data (SIMD), very long instruction word (VLIW) digital signal processor. The combination of the SIMD and VLIW may enhance throughput and speed.

In some embodiments, each of the vector processors may include an instruction cache and may be coupled to dedicated memory. As a result, in some examples, each of the vector processors may be configured to execute independently of the other vector processors. In other examples, the vector processors that are included in a particular PVA(s) 1707 may be configured to employ data parallelism. For example, in some embodiments, the plurality of vector processors included in a single PVA(s) 1707 may execute the same computer vision algorithm, but on different regions of an image. In other examples, the vector processors included in a particular PVA(s) 1707 may simultaneously execute different computer vision algorithms, on the same image, or even execute different algorithms on sequential images or portions of an image. Among other things, any number of PVAs 1707 may be included in the hardware acceleration cluster and any number of vector processors may be included in each of the PVAs. In addition, the PVA(s) 1707 may include additional error correcting code (ECC) memory, to enhance overall system safety.

The accelerator(s) 1714 (e.g., the hardware accelerator cluster) have a wide array of uses for autonomous and semi-autonomous machine control. The PVA(s) 1707 may be a programmable vision accelerator that may be used for key processing stages in perception, robotics understanding and reasoning, ADAS, semi-autonomous, and autonomous vehicles, etc. The PVA's 1707 capabilities are a good match for algorithmic domains needing predictable processing, at low power and low latency. In other words, the PVA(s) 1707 performs well on semi-dense or dense regular computation, even on small data sets, which need predictable run-times with low latency and low power. Thus, in the context of platforms for autonomous vehicles and robotics, the PVAs 1707 are designed to run classic computer vision algorithms, as they are efficient at object detection and operating on integer math.

For example, according to one embodiment of the technology, the PVA 1707 is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA(s) 1707 may perform computer stereo vision function on inputs from two monocular cameras.

In some examples, the PVA(s) 1707 may be used to perform dense optical flow. According to process raw RADAR data (e.g., using a 4D Fast Fourier Transform) to provide Processed RADAR. In other examples, the PVA(s) 1707 is used for time-of-flight depth processing, by processing raw time of flight data to provide processed time of flight data, for example.

Although the VPU(s), DMA(s), RISC Core(s), VMEM(s), and decoupled co-processors (e.g., the DLUT(s)) are described as being included within the PVA(s) 1707, this is not intended to be limiting. In some embodiments, these components may be included in alternative or additional processing components and/or accelerator(s) 1714, and/or may be included as discrete components of the SoC(s) 1704 and/or other computing system architecture(s).

In some examples, the SoC(s) 1704 may include a real-time ray-tracing hardware accelerator (RTA) 1751 that may be used to quickly and efficiently determine the positions and extents of objects (e.g., within a world model), to generate real-time or near-real time visualization simulations, for RADAR signal interpretation, for sound propagation synthesis and/or analysis, for simulation of SONAR, RADAR, LiDAR, camera, and/or other sensor modalities within a simulation, for general wave propagation simulation, for comparison to LiDAR data for purposes of localization, to generate realistic training data for training neural networks, and/or other functions and uses. In some embodiments, one or more tree traversal units (TTUs) may be used for executing one or more ray-tracing related operations. For example, the machine 1700 (or another machine or device) may be simulated within a simulation environment, and the simulation environment may be generated using one or more light transport simulation algorithms (e.g., ray-tracing, path-tracing, etc.). These ray-tracing algorithms may thus be accelerated using a ray-tracing accelerator 1751 and/or a ray-tracing optimized GPU 1706—such as NVIDIA's RTX GPU.

The accelerator(s) 1714 (e.g., in the hardware acceleration cluster) may include one or more optical flow accelerators (OFAs) 1711. For example, the OFA(s) 1711 may be used for computing optical flow and stereo disparity between frames of sensor data (e.g., images). Optical flow may be accelerated on the OFA(s) 1711 for uses such as object detection and tracking, and/or for stereo depth estimation where used for computing stereo disparity between stereo image frames (e.g., two or more frames captured using two or more image sensors with at least partially overlapping fields of view).

The SoC(s) 1704 may include one or more camera serial interfaces (CSIs) 1723. For example, the CSI(s) 1723 may include a mobile industry processor interface (MIPI) camera serial interface (CSI) for receiving video and input from cameras, a high-speed interface, and/or a video input block that may be used for camera and related pixel input functions. The SoC(s) 1704 may further include an input/output controller(s) that may be controlled by software and may be used for receiving I/O signals that are uncommitted to a specific role. For example, the CSI 1723 may include a MIPI CSI-2 connector—e.g., a 16 lane MIPI CSI-2 connector, D-PHY 2.1 (up to 40 Gbps), and C-PHY 2.0 (up to 164 Gbps) for supporting 16 virtual channels and six or more cameras, an 8 lane MIPI CSI-2 connector, D-PHY 2.1 (up to 20 Gbps for supporting 8 virtual channels and 4 or more cameras, and/or a 2×MIPI CSI-2, 22 pin camera connector, depending on the embodiment and embodiment.

The accelerator(s) 1714 (e.g., the hardware acceleration cluster) may include a computer vision network on-chip (CVNOC) 1763 and SRAM, for providing a high-bandwidth, low latency SRAM for the accelerator(s) 1714. In some examples, the on-chip memory may include at least 4 MB SRAM, consisting of, for example and without limitation, eight field-configurable memory blocks, that may be accessible by the PVA 1707, OFA 1711, DLA 1709, and/or other accelerator(s) 1714. Each pair of memory blocks may include an advanced peripheral bus (APB) interface, configuration circuitry, a controller, and a multiplexer. Any type of memory 1715 may be used. The PVA 1707, OFA 1711, DLA 1709, and/or other accelerator(s) 1714 may access the memory via a backbone that provides the accelerator(s) 1714 with high-speed access to memory. The backbone may include a computer vision network on-chip that interconnects the accelerator(s) 1714 to the memory (e.g., using the APB).

The CVNOC 1763 may include an interface that determines, before transmission of any control signal/address/data, that the accelerator(s) 1714 provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

The SoC(s) 1704 may include data store(s) 1716 and/or memory 1715. The data store(s) 1716 may be on-chip memory 1715 of the SoC(s) 1704, which may store neural networks and/or other algorithms to be executed on the CPU(s) 1706, the GPU(s) 1708, and/or one or more of the accelerator(s) 1714. In some examples, the data store(s) 1716 may be large enough in capacity to store multiple instances of neural networks for redundancy and safety. The data store(s) 1712 may comprise L2 and/or L3 cache(s) 1712, for example. The memory(ies) 1715 may include SRAM, LPDDR5, and/or other memory types. For example, the memory(ies) 1715 may include 4 MB of SRAM, 32 GB and/or 64 GB 256-bit LPDDR5 at 204.8 GB/s, 8 GB and/or 16 GB 128-bit LPDDR5 at 102.4 GB/s, and/or other memory types and sizes. Reference to the data store(s) 1716 may include reference to the memory associated with the PVA 1707, OFA 1711, DLA 1709, and/or other accelerator(s) 1714, as described herein.

The data store(s) 1716 may include various storage types, such as eMMC, NVMe, etc. For example, the SoC(s) 1704 may include storage in the form of an embedded multimedia card (eMMC) (e.g., 64 GB eMMC 5.1) and/or an SD card slot, with external NVM express (NVMe) capability, e.g., via M.2 Key M. For example, the data store(s) 1716 and/or other storage may be accessed via, e.g., NVMe, using PCI Express (PCIe), RDMA, TCP, and/or other protocols.

The SoC(s) 1704 may include one or more processor(s) 1710 (e.g., embedded processors). The processor(s) 1710 may include a boot and power management processor (BPMP) 1753, that may be a dedicated processor and subsystem to handle boot power and management functions and related security enforcement. The BPMP 1753 may be a part of the SoC(s) 1704 boot sequence and may provide runtime power management services. The BPMP 1753 may provide clock and voltage programming, assistance in system low power state transitions, management of SoC(s) 1704 thermals and temperature sensors, and/or management of the SoC(s) 1704 power states. Each temperature sensor may be implemented as a ring-oscillator whose output frequency is proportional to temperature, and the SoC(s) 1704 may use the ring-oscillators to detect temperatures of the CPU(s) 1706, GPU(s) 1708, accelerator(s) 1714, and/or other components. If temperatures are determined to exceed a threshold, BPMP 1753 may enter a temperature fault routine and put the SoC(s) 1704 into a lower power state and/or put the machine 1700 into a chauffeur to safe stop mode (e.g., bring the machine 1700 to a safe stop).

The processor(s) 1710 may further include a set of embedded processors that may serve as an audio processing engine (APE) 1755. The APE 1755 may be an audio subsystem that enables full hardware support for multi-channel audio over multiple interfaces, and a broad and flexible range of audio I/O interfaces. In some examples, the APE 1755 is a dedicated processor core with a digital signal processor with dedicated RAM.

The processor(s) 1710 may further include an always on processor engine (AOPE) 1757 that may provide necessary hardware features to support low power sensor management and wake use cases. The AOPE 1757 may include a processor core, a tightly coupled RAM, supporting peripherals (e.g., timers and interrupt controllers), various I/O controller peripherals, and routing logic.

The processor(s) 1710 may further include a safety processor(s) 1713 (alternatively referred to as “safety island 1713”), which may include a safety cluster engine that includes a dedicated processor or processor subsystem to handle safety management for automotive, robotics, and/or other applications. The safety processor(s) 1713—and/or safety cluster engine—may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations. In some embodiments, the safety processor(s) 1713 may include a discrete processor(s), such that fault of other system components may not impact the performance and availability of the safety processor 1713.

The processor(s) 1710 may further include a real-time or near real-time sensor engine (SE) 1759 that may include a dedicated processor subsystem for handling real-time or near real-time camera, LiDAR, RADAR, and/or other sensor modality management.

The processor(s) 1710 may further include one or more image signal processors (ISPs) 1727, which may include a high-dynamic range signal processor and/or a hardware engine that is part of one or more sensor processing pipelines.

The processor(s) 1710 may include a video image compositor (VIC) 1761 that may be a processing block (e.g., implemented on a microprocessor) that implements video post-processing functions needed by a video playback application to produce the final image for the player window. The VIC 1761 may perform lens distortion correction on wide-view camera(s) 1768B, surround camera(s) 1768D, in-cabin monitoring camera sensors, and/or other camera sensors with distorted fields of view.

A VIC 1761 may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

A VIC 1761 may also be configured to perform stereo rectification on input stereo lens frames. The video image compositor may further be used for user interface composition when the operating system desktop is in use, and the GPU(s) 1708 is not required to continuously render new surfaces. Even when the GPU(s) 1708 is powered on and active doing 3D rendering, the video image compositor may be used to offload the GPU(s) 1708 to improve performance and responsiveness.

The SoC(s) 1704 may further include a broad range of peripheral interfaces for input/output (I/O) 1725, such as to enable communication with peripherals, audio codecs, power management, and/or other devices. The SoC(s) 1704 may be used to process data from cameras (e.g., connected over Gigabit Multimedia Serial Link and/or Ethernet), sensors (e.g., LiDAR sensor(s) 1764, RADAR sensor(s) 1760, etc. that may be connected over Ethernet), data from bus 1702 (e.g., speed of machine 1700, steering wheel position, etc.), data from GNSS sensor(s) 1758 (e.g., connected over Ethernet or CAN bus). The SoC(s) 1704 may further include dedicated high-performance mass storage controllers that may include their own DMA engines, and that may be used to free the CPU(s) 1706 from routine data management tasks. In some embodiments, the SoC(s) 1704 I/O 1725 may include a header (e.g., a 40 pin header, or 40 pin expansion header) with support for universal asynchronous receiver/transmitter (UART), serial peripheral interface (SPI), inter-integrated circuit sound (I2S), inter-integrated circuit (I2C), controller area network (CAN), pulse width modulation (PWM), digital microphone interface (DMIC), digital speaker station (DSPK), general purpose I/O (GPIO), etc., an automation header (e.g., 12 pin automation header), an audio panel header (e.g., a 10 pin audio panel header), a joint test action group (JTAG) header (e.g., a 10 pin JTAG header), a fan header (e.g., a 4 pin fan header), an RTC battery backup connector (e.g., a 2 pin battery backup connector), a microSD slot, a DC power jack, power, force, recovery, and reset buttons, one or more display connectors (e.g., DisplayPort (DP), such as a DP 1.4A (+MST), an eDP 1.41, an HDMI 2.1, and/or a 4K30 multi-model DP 1.2 (+MST) connector), and/or other I/O 1725 elements, components, or features.

The SoC(s) 1704 may include in-machine networking capability using, for example, Ethernet (e.g., automotive Ethernet), SERDES, controller area network (CAN), FlexRay, local interconnect network (LIN), low voltage differential signaling (LVDS), media oriented system transport (MOST), another networking type, and/or a combination thereof. For example, the SoC(s) 1704 may include an RJ45 connector with up to 10 GbE, a 1 GbE connector, and/or other networking connector types.

The SoC(s) 1704 may include one or more digital signal processors (DSPs) 1743. For example, the DSP(s) 1743 may include a dedicated or specialized microprocessor chip optimized for digital signal processing—such as in audio signal processing, telecommunications, digital image processing, RADAR, SONAR, LiDAR, and/or other sensor processing, speech recognition, and/or other applications.

The SoC(s) 1704 may include one or more video encoders 1719 and/or one or more video decoders 1721. For example, the video encoder(s) 1719 may include a hardware-based (e.g., as part of the GPU(s) 1708) video encoder (e.g., supporting H.264, H.265, etc., and being HEVC compliant, such as NVIDIA's NVENC) that may process image inputs (e.g., as YUV, RGB, etc.) to generate a video bit stream. The video decoder(s) 1721 may include a video decoder engine that may provide fully-accelerated hardware video decoding capabilities (e.g., supporting decoding of bitstreams in various formats, such as AV1, H.264, H.265, VP8, VP9, MPEG-1, MPEG-2, MPEG-4, VC-1, etc, and being HEVC compliant, such as NVIDIA's NVDEC). In some examples, the video decoder(s) 1721 may be hardware-based (e.g., as part of the GPU(s) 1708).

The SoC(s) 1704 may include one or more general compute acceleration clusters (GCAC(s)) 1729. For example, the GCAC(s) 1729 may include various processor types that may be used to accelerate compute, such as one or more vector microcode processors (VMPs) 1733, one or more multi-threaded processing clusters (MPCs) 1731, one or more programmable macro arrays (PMA(s)) 1735, and/or one or more other processor types. For example, the GCAC(s) 1729 may include a PMA 1735, two VMPs 1733, and 2 MPCs 1731.

The SoC(s) 1704 may include one or more vector microcode processors (VMPs) 1733. The VMP(s) 1733, in embodiments, may include a wide vector (very long instruction word (VLIW) and single instruction multiple data (SIMD)) machine with performing various operations, such as short integral type operations common in computer vision and deep learning algorithms.

The SoC(s) 1704 may include one or more multi-threaded processing clusters (MPCs) 1731. The MPC(s) 1731 may include a processing cluster that be, in embodiments, more versatile than a GPU, and with higher efficiency than a CPU. For example, the MPC(s) 1731 may include a multi-threaded processor that allows multiple threads to share resources and execute instructions concurrently.

The SoC(s) 1704 may include one or more programmable macro arrays (PMA(s)) 1735. The PMA(s) 1735 may include a coarse-grained reconfigurable architecture (CGRA) dataflow machine, having a unique architecture that delivers strong performance on dense computer vision and deep learning algorithms that may be unachievable in classic digital signal processing (DSP) architectures.

The SoC(s) 1704 may include one or more display processing units (DPUs) 1745 for performing hardware-accelerated image processing. For example, the DPU(s) 1745 may retrieve pixel data from memory 1715 and send it to a display peripheral through standard interfaces. As such, the DPU(s) 1745 may handle display processing and rendering for in-machine and/or on-machine displays.

The SoC(s) 1704 may include one or more application processing units (APUs) 1739. For example, the APU(s) 1739 may include a quad or dual-core processor with 48 KB/32 KB L1 cache with parity and ECC, along with a 1 MB L2 cache with ECC. The APU(s) 1739 may support NEON instructions and single and double precision floating point operations.

The SoC(s) 1704 may include one or more real-time processing units (RTPUs) 1769. The RTPU(s) 1769 may include a dual-core processor with 32 KB/32 KB L1 cache, and 256 KB TCM with ECC. The RTPU(s) 1769 may support single and double precision floating point operations.

The SoC(s) 1704 may include one or more built-in self-test (BIST) components 1737. For example, the BIST component(s) 1737 may include memory BIST (MBIST) to test memories of the system and/or logic BIST (LBIST) to test logic of the system. The BIST components 1737 may include embedded logic for directly testing logic and/or memory of the system.

The SoC(s) 1704 may include one or more dynamically reconfigurable processors (DRPs) 1771. For example, the DRP(s) 1771 may be used for accelerating various computing operations. For example, the DRP(s) 1771 may be combined, in embodiments, with a MAC unit for use as an AI accelerator. In embodiments, the DRP(s) 1771 may execute applications while dynamically switching the circuit connection configuration of the arithmetic units (e.g., ALUs) on the chip at each operating clock according to the content to be processed. Since only the necessary arithmetic circuits are used, the DRP(s) 1771 may consume less power than with CPU processing and can achieve higher speed. Furthermore, compared to CPUs, where frequent external memory accesses due to cache misses and other causes will degrade performance, the DRP(s) 1771 can build the necessary data paths in hardware ahead of time, resulting in less performance degradation and less variation in operating speed (jitter) due to memory accesses. The DRP(s) 1771 may include a dynamic loading function that switches the circuit connection information each time the algorithm changes, enabling processing with limited hardware resources, even in robotic/automotive applications that require processing of multiple algorithms.

In some embodiments, the accelerator(s) 1714 may include an OpenCV accelerator for speeding up processing of OpenCV, an open-source industry standard library for computer vision processing. In some embodiments, the combination of one or more DRP(s) 1771 deployed as an AI accelerator along with an OpenCV accelerator(s) may enhance AI computing and image processing algorithms, enabling complex and compute-heavy operations such as Visual simultaneous localization and mapping (SLAM).

In contrast to conventional systems, by providing a CPU complex, GPU complex, and a hardware acceleration cluster, the technology described herein allows for multiple neural networks to be performed simultaneously (e.g., at least partially in parallel) and/or sequentially, and for the results to be combined together to enable Level 2-5 autonomous driving functionality and/or autonomous robotics movement, control, planning, and/or navigation operations. In addition, because the SoC(s) 1704 may include various compute engines (e.g., processors 1710, CPUs 1706, GPU(s) 1708, accelerator(s) 1714, etc.), tasks may be distributed between and among the compute engines, in some instances without common cause failures due to the discrete footprint of the compute engines. Further, because the SoC(s) 1704 may include a dedicated safety processor(s) 1713 (or safety island 1713), critical safety or redundant operations may be performed without common cause failures from the main processing components or compute engines of the SoC(s) 1714. Due to these features, the SoC(s) 1704 and/or the underlying systems of the machine 1700 may be capable of satisfying higher levels of safety—such as automotive safety integrity level (ASIL) D from the ISO 26262 standard.

FIG. 17E is a system diagram for communication between a cloud-based server(s) (e.g., in a data center, such as those described herein) and the example autonomous or semi-autonomous vehicle or machine 1700 of FIG. 17A, in accordance with some embodiments of the present disclosure. The system 1776 may include a server(s) 1778, a network(s) 1790, and a machine(s) 1700. The server(s) 1778 may include a plurality of GPUs 1784(A)-1784(H) (collectively referred to herein as GPUs 1784), switches 1782(A)-1782(H) (such as PCIe 4.0/5.0/etc switches, M.2 slots, thunderbolt, USB4, NVIDIA's NVLink, NVIDIA's NVSwitch, GPUDirect RDMA, GPUDirect Storage, ultra accelerator Link (UALink), etc.), CPUs 1780(A)-1780(B) (collectively referred to herein as CPUs 1780), accelerators, and/or other processor types. The GPUs 1784, the CPUs 1780, and the PCIe switches may be interconnected with high-speed interconnects such as, for example and without limitation, NVLink interfaces 1788 developed by NVIDIA and/or PCIe connections 1786 and/or ultra accelerator Link (UALink). In some examples, the GPUs 1784 are connected via NVLink and/or NVSwitch SoC and the GPUs 1784 and the PCIe switches 1782 are connected via PCIe interconnects. Although eight GPUs 1784, two CPUs 1780, and two PCIe switches are illustrated, this is not intended to be limiting. Depending on the embodiment, each of the server(s) 1778 may include any number of GPUs 1784, CPUs 1780, and/or PCIe switches. For example, the server(s) 1778 may each include eight, sixteen, thirty-two, and/or more GPUs 1784.

The server(s) 1778 may receive, over the network(s) 1790 and from the machine(s) 1700, sensor data indicating information about new or previously unexplored locations, and/or sensor data indicating changes to previously seen/stored locations (e.g., unexpected or changed road conditions, such as recently commenced road-work). The server(s) 1778 may transmit, over the network(s) 1790 and to the machine(s) 1700, neural networks 1792, updated neural networks 1792, map information 1794, etc., including information regarding traffic and road conditions. The updates to the map information 1794 may include updates for the HD map 1722, SD map, navigation map, etc., such as information regarding construction sites, potholes, detours, flooding, and/or other obstructions. In some examples, the neural networks 1792, the updated neural networks 1792, the map information 1794, and/or the other information may have resulted from new training and/or experiences represented in data received from any number of machine(s) 1700 in the environment, and/or based on training performed at a datacenter (e.g., using the server(s) 1778 and/or other servers).

The server(s) 1778 may be used to train machine learning models (e.g., neural networks) based on training data. The training data may be generated by the machine(s) 1700, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the machine(s) 1700 (e.g., transmitted to the machine(s) 1700 over the network(s) 1790, and/or the machine learning models may be used by the server(s) 1778 to remotely monitor and/or control the machine(s) 1700.

In some examples, the server(s) 1778 may receive data from the machine(s) 1700 and apply the data to up-to-date real-time neural networks for real-time intelligent inferencing. The server(s) 1778 may include deep-learning supercomputers and/or dedicated AI computers powered by GPU(s) 1784, such as a DGX and DGX Station machines developed by NVIDIA. However, in some examples, the server(s) 1778 may include deep learning infrastructure that use only CPU-powered datacenters.

The deep-learning infrastructure of the server(s) 1778 may be capable of fast, real-time inferencing, and may use that capability to evaluate and verify the health of the processors, software, and/or associated hardware in the machine 1700. For example, the deep-learning infrastructure may receive periodic updates from the machine 1700, such as a sequence of images and/or objects that the machine 1700 has located in that sequence of images (e.g., via computer vision and/or other machine learning object classification techniques). The deep-learning infrastructure may run its own neural network to identify the objects and compare them with the objects identified by the machine 1700 and, if the results do not match and the infrastructure concludes that the AI in the machine 1700 is malfunctioning, the server(s) 1778 may transmit a signal to the machine 1700 instructing a fail-safe computer of the machine 1700 to assume control, notify the passengers, and complete a safety maneuver or operation—such as to slow down, hand control back to a driver, come to a stop, and/or pull over/shut down.

For inferencing, the server(s) 1778 may include the GPU(s) 1784 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Computing Ecosystem for Generating, Training, and Deploying AI

FIG. 18 is a system diagram illustrating a three computer ecosystem 1800, including a first computing system 1802 for generating or creating artificial intelligence (AI)—such as AI training and validation data, a second computing system 1804 for training artificial intelligence, and a third computing system 1806 (which may include or correspond to the SoC(s) 1704 of FIGS. 17A-17E) deploying the AI at the edge, in accordance with at least some embodiments of the present disclosure. For example, to develop and deploy embodied or physical AI, the three computer ecosystem 1800 may be used, including three accelerated computer systems to handle physical AI training, simulation, and runtime (e.g., edge deployment). These systems may generate training data for and train multimodal foundation models (and/or other model types) using scalable, physically based simulations of the machine(s) 1700 and their worlds. By doing so, simulation of machine(s) 1700 may be performed at scale, allowing for refinement, testing, and optimization of skills (e.g., robot skills) in a virtual world (e.g., using NVIDIA's OMNIVERSE) that mimics the laws of physics-helping to reduce real-world data acquisition costs and ensuring the machine(s) 1700 can perform safely in controlled settings.

The computing system 1804 (e.g., NVIDIA's DGX Platform) may be used to train and fine-tune powerful foundation and generative AI models. Models, such as general purpose foundation models (e.g., NVIDIA's Project GROOT), may be used to enable robots and other machine(s) 1700 to understand natural language and emulate movements by observing human actions. The computing system 1804 may include a platform that incorporates software, infrastructure, and expertise in a modern, unified AI development and training solution. The computing system 1804 may include individual computing devices 1810 (e.g., NVIDIA's DGX B200, H200, etc.) and/or any number of computing devices 1810 in a data center infrastructure 1812 (e.g., NVIDIA's DGX SuperPOD).

For example, the individual computing devices 1810 may include GPUs (e.g., 8 GPUs with 1,440 GB total GPU memory) and CPUs (e.g., 2 CPUs with 112 cores total, 2.1 GHZ, or 4 GHz (with boost)) that provide upwards of 72 petaFLOPS for training and 144 petaFLOPS for inference. The computing devices 1810 may include memory (e.g., 4 TB memory, and storage (e.g., OS storage of 2×1.9 TB NVMe M.2, and internal storage of 8×3.84 TB NVMe U.2). The computing devices 1810 may include various networking and network management components, such as OSFP ports (e.g., 4 OSFP ports) serving single-port smart host channel adapters (e.g., 8 single port ConnextX-7 virtual protocol interconnects (VPIs)), providing up to 400 GB/s Infiniband/Ethernet. The computing devices 1810 may further include, e.g., dual port quad small form-factor pluggable (QSFFP) data processing units (DPUs) (e.g., 2 dual-port QSFP112 DPUs—such as NVIDIA's BlueField-3 DPUs), providing up to 400 Gb/s InfiniBand/Ethernet. The computing device(s) 1810 may include an onboard network interface card (NIC) (e.g., 10 Gb/s onboard NIC with RJ45), a dual-port Ethernet NIC (e.g., 100 GB/s dual-port Ethernet NIC), and/or a host baseboard management controller (MBC) (e.g., with RJ45). In some embodiments, the NICs used for the computing device(s) 1810 may include SuperNICs (e.g., NVIDIA's ConnectX-8 SuperNIC) to provide up to 800 Gb/s of data throughput for in-network computing acceleration engines to deliver the performance and robust feature set needed to power trillion-parameter scale AI factories and scientific computing workloads. In other embodiments, the computing device(s) 1810 may include a smart host channel adapter (HCA) (e.g., NVIDIA's ConnectX-7) to provide ultra-low latency, 400 Gb/s throughput for in-network computing acceleration engines.

The data center infrastructure 1812 may include any number of the computing devices 1810, along with an operating system (OS) (e.g., DGX OS extensions for Linux distributions) to maximize system uptime, security, and reliability, network/storage acceleration libraries and management to accelerate end-to-end infrastructure performance, cluster management to scale and manage one node (e.g., one computing device 1810) to thousands, job scheduling and orchestration to ensure hassle-free execution of every developer's job, AI workflow management and machine learning operations (MLOps) to move more models from prototype to production, and enterprise software to speed developer success.

The computing system 1802 (e.g., NVIDIA's OVX servers) may provide a development and simulation platform for testing and optimizing physical AI with APIs and frameworks for simulation (e.g., NVIDIA's DriveSIM, ISAAC Sim, ISAAC Gym, ISAAC Labetc.). The computing system 1802 allows developers to use simulation frameworks to simulate and validate robot models, and/or to generate massive amounts of physically-based synthetic data to bootstrap model training. The computing system 1802 may support learning frameworks that power robot reinforcement learning and imitation learning, to accelerate robot policy training and refinement. For example, the computing system 1802 may be used to generate any number of simulations 1808—such as within NVIDIA's OMNIVERSE. The computing system 1802 may be used optimized for accelerating an entire software stack, from training, fine-tuning, and deploying generative AI to powering industrial digitalization within a content collaboration platform of APIs, software developer kits (SDKs), and services that allow for integration of OpenUSD, ray-tracing rendering technologies (e.g., NVIDIA's RTX), and generative physical AI into existing software tools and simulation workflows for, e.g., industrial and robotics use cases (e.g., NVIDIA's OMNIVERSE). As such, the computing system 1802 may host or support a native OpenUSD software platform enabling enterprises to connect 3D pipelines and develop advanced, real-time 3D applications for industrial digitalization. With powerful ray-tracing-accelerated AI and graphics capabilities, the computing system 1802 delivers powerful performance for workloads like extended reality (XR), multi-user design collaboration, and digital twins. This allows creation of physically accurate models with high-fidelity ray-traced and path-traced rendering of materials, operation of large-scale, AI-enabled simulations, and generation of photorealistic 3D synthetic data for training. The computing system 1802 may include individual computing devices 1814 (e.g., NVIDIA's OVX L40S Server) and/or any number of computing devices 1814 in a data center infrastructure 1816 (e.g., NVIDIA's OVX Systems).

The computing device(s) 1814 (which may include a server) may include CPUs (e.g., 2 CPUs with 32 cores each), and GPUs (e.g., 4 or 8 GPUs, each including 48 GB GDDR6 with ECC memory, 864 GB/s memory bandwidth, PCIe Gen4×16:64 GB/s bidirectional interconnect interface, 18,176 CUDA cores, 142 ray tracing (RT) cores, and 568 tensor cores).

The computing devices 1814 may include various networking and network management components, such as smart host channel adapters (HCA) (e.g., 2 or 4 single port ConnextX-7 at 200 Gb/s each, providing up to 800 Gb/s Infiniband/Ethernet), one or more DPUs (e.g., a dual-port QSFP112 DPUs—such as an NVIDIA BlueField-3 DPU), providing up to 400 Gb/s InfiniBand/Ethernet. In some embodiments, the NICs used for the computing device(s) 1814 may include SuperNICs (e.g., NVIDIA's ConnectX-8 SuperNIC) to provide up to 800 Gb/s of data throughput for in-network computing acceleration engines to deliver the performance and robust feature set needed to power trillion-parameter scale AI factories and scientific computing workloads. In other embodiments, the computing device(s) 1814 may include a smart host channel adapter (HCA) (e.g., NVIDIA's ConnectX-7) to provide ultra-low latency, 400 Gb/s throughput for in-network computing acceleration engines. The computing device(s) 1814 may include a host memory (e.g., 384 Gb DDR5 ECC for 4 GPUs, or 768 Gb DDR5 ECC for 8 GPUs), and may include a dual in-line memory module (DIMM) slot(s), a host boot drive (e.g., 1 TB NVMe), and/or a host storage (e.g., 2 4 TB NVMe).

Similar to the data center infrastructure 1812, the data center infrastructure 1816 may allow for any number of computing device(s) 1814 to be combined in cluster configuration according to a reference architecture.

The computing system 1806 may be used to deploy trained AI models on a runtime computer—such as the SoC(s) 1704 described herein. For example, these computing systems 1806 may be designed for compact, on-board computing needs, including an ensemble of models for control policy, vision and language models, etc., deployed on a power-efficient on-board edge computing system 1806. Details of components, features, and capabilities of the computing system 1806 may be described in more detail herein with respect to FIGS. 17A-17E.

### Example Generative Models

In at least some embodiments, language models, such as large language models (LLMs), vision language models (VLMs), multi-modal language models (MMLMs), vision-language-action (VLA) models, and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases)—such as millions or billions of parameters. The LLMs/VLMs/MMLMs/etc. may be implemented for summarizing textual data, analyzing and extracting insights from data (e.g., textual, image, video, etc.), and generating new text/image/video/etc. n user specified styles, tones, and/or formats. The LLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio (sounds, synthetic speech, etc.), 2D and/or 3D data (e.g., in USD formats), and/or video. For example, vision language models (VLMs), or more generally multi-modal language models (MMLMs), may be implemented to accept image, video, sensor, audio, textual, 3D design (e.g., CAD), and/or other inputs data types and/or to generate or output image, video, audio, textual, 3D design, and/or other output data types.

Various types of LLMs/VLMs/MMLMs/etc. architectures may be implemented in various embodiments. For example, different architectures may be implemented that use different techniques for understanding and generating outputs—such as text, audio, video, image, 2D and/or 3D design or asset data, etc. In some embodiments, LLMs/VLMs/MMLMs/etc. architectures such as recurrent neural networks (RNNs) or long short-term memory networks (LSTMs) may be used, while in other embodiments transformer architectures—such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/VLMs/MMLMs/etc. may also include one or more diffusion block(s) (e.g., denoisers). The LLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/VLMs/MMLMs/etc. that include both encoder and decoder components like T5 (Text-to-Text Transformer) may be implemented to understand and generate content, such as for translation and summarization. These examples are not intended to be limiting, and any architecture type—including but not limited to those described herein—may be implemented depending on the particular embodiment and the task(s) being performed using the LLMs/VLMs/MMLMs/etc.

In various embodiments, the LLMs/VLMs/MMLMs/etc. may be trained using unsupervised learning, in which an LLMs/VLMs/MMLMs/etc. learns patterns from large amounts of unlabeled text/audio/video/image/design/USD/etc. data. Due to the extensive training, in embodiments, the models may not require task-specific or domain-specific training. LLMs/VLMs/MMLMs/etc. that have undergone extensive pre-training on vast amounts of unlabeled data may be referred to as foundation models and may be adept at a variety of tasks like question-answering, summarization, in filling missing information, translation, image/video/design/USD/data generation. Some LLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/VLMs/MMLMs/etc., and/or preventing the output or presentation (e.g., display, audio output, etc.) of information generating using the LLMs/VLMs/MMLMs/etc. In some embodiments, one or more additional models- or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/embodiment. As a result, the LLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/embodiment.

In some embodiments, the LLMs/VLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3rd party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources—such as APIs, plug-ins, and/or the like.

In some embodiments, multiple language models (e.g., LLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g. updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model—or version, instance, or agent—maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

FIG. 19 is a block diagram of an example generative language model system 1900 suitable for use in implementing at least some embodiments of the present disclosure. In the example illustrated in FIG. 19, the generative language model system 1900 includes a retrieval augmented generation (RAG) component 1992, an input processor 1905, a tokenizer 1910, an embedding component 1920, plug-ins/APIs 1995, and a generative language model (LM) 1930 (which may include an LLM, a VLM, a MMLM, a VLA model, etc.).

At a high level, the input processor 1905 may receive an input 1901 comprising text and/or other types of input data (e.g., audio data, video data, image data, sensor data (e.g., LiDAR, RADAR, ultrasonic, etc.), 3D design data, CAD data, universal scene descriptor (USD) data—such as OpenUSD, etc.), depending on the architecture of the generative LM 1930 (e.g., LLM/VLM/MMLM/etc.). In some embodiments, the input 1901 includes plain text in the form of one or more sentences, paragraphs, and/or documents. Additionally or alternatively, the input 1901 may include numerical sequences, precomputed embeddings (e.g., word or sentence embeddings), and/or structured data (e.g., in tabular formats, JSON, or XML). In some embodiments in which the generative LM 1930 is capable of processing multi-modal inputs, the input 1901 may combine text (or may omit text) with image data, audio data, video data, design data, USD data, and/or other types of input data, such as but not limited to those described herein. Taking raw input text as an example, the input processor 1905 may prepare raw input text in various ways. For example, the input processor 1905 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 1905 may remove stopwords to reduce noise and focus the generative LM 1930 on more meaningful content. The input processor 1905 may apply text normalization (TN), for example, by converting all characters to lowercase, removing accents, and/or or handling special cases like contractions or abbreviations to ensure consistency (e.g., converting ¼ to one quarter). Similarly, the input processor 1905 and/or a post-processor may perform inverse text normalization (ITN) in order to convert plain language back to canonical or other forms (e.g., to convert one quarter to ¼). These are just a few examples, and other types of input and/or output processing may be applied.

In some embodiments, a RAG component 1992 (which may include one or more RAG models, and/or may be performed using the generative LM 1930 itself) may be used to retrieve additional information to be used as part of the input 1901 or prompt. RAG may be used to enhance the input to the LLM/VLM/MMLM/etc. with external knowledge, so that answers to specific questions or queries or requests are more relevant—such as in a case where specific knowledge is required. The RAG component 1992 may fetch this additional information (e.g., grounding information, such as grounding text/image/video/audio/USD/CAD/etc.) from one or more external sources, which can then be fed to the LLM/VLM/MMLM/etc. along with the prompt to improve accuracy of the responses or outputs of the model.

For example, in some embodiments, the input 1901 may be generated using the query or input to the model (e.g., a question, a request, etc.) in addition to data retrieved using the RAG component 1992. In some embodiments, the input processor 1905 may analyze the input 1901 and communicate with the RAG component 1992 (or the RAG component 1992 may be part of the input processor 1905, in embodiments) in order to identify relevant text and/or other data to provide to the generative LM 1930 as additional context or sources of information from which to identify the response, answer, or output 1990, generally. For example, where the input indicates that the user is interested in a desired tire pressure for a particular make and model of vehicle, the RAG component 1992 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 1992 may retrieve a prior stored conversation history- or at least a summary thereof- and include the prior conversation history along with the current ask/request as part of the input 1901 to the generative LM 1930.

The RAG component 1992 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 1992 and the embeddings of the chunks along with the embeddings of the query may be compared to identify the most similar/related embeddings to the query, which may be supplied to the generative LM 1930 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/VLM/MMLM/etc. may summarize the results. In such an example, the graph may store relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 1992 may implement a plugin, API, user interface, and/or other functionality to perform RAG. For example, a graph RAG plug-in may be used by the LLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 1910 may segment the (e.g., processed) text data into smaller units (tokens) for subsequent analysis and processing. The tokens may represent individual words, subwords, characters, portions of audio/video/image/etc., depending on the embodiment. Word-based tokenization divides the text into individual words, treating each word as a separate token. Subword tokenization breaks down words into smaller meaningful units (e.g., prefixes, suffixes, stems), enabling the generative LM 1930 to understand morphological variations and handle out-of-vocabulary words more effectively. Character-based tokenization represents each character as a separate token, enabling the generative LM 1930 to process text at a fine-grained level. The choice of tokenization strategy may depend on factors such as the language being processed, the task at hand, and/or characteristics of the training dataset. As such, the tokenizer 1910 may convert the (e.g., processed) text into a structured format according to tokenization schema being implemented in the particular embodiment.

The embedding component 1920 may use any known embedding technique to transform discrete tokens into (e.g., dense, continuous vector) representations of semantic meaning. For example, the embedding component 1920 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some embodiments in which the input 1901 includes image data/video data/etc., the input processor 1901 may resize the data to a standard size compatible with format of a corresponding input channel and/or may normalize pixel values to a common range (e.g., 0 to 1) to ensure a consistent representation, and the embedding component 1920 may encode the image data using any known technique (e.g., using one or more convolutional neural networks (CNNs) to extract visual features). In some embodiments in which the input 1901 includes audio data, the input processor 1901 may resample an audio file to a consistent sampling rate for uniform processing, and the embedding component 1920 may use any known technique to extract and encode audio features—such as in the form of a spectrogram (e.g., a mel-spectrogram). In some embodiments in which the input 1901 includes video data, the input processor 1901 may extract frames or apply resizing to extracted frames, and the embedding component 1920 may extract features such as optical flow embeddings or video embeddings and/or may encode temporal information or sequences of frames. In some embodiments in which the input 1901 includes multi-modal data, the embedding component 1920 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 1930 and/or other components of the generative LM system 1900 may use different types of neural network architectures depending on the embodiment. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, linear-time sequence modeling with selective state space modeling (SSM) architectures (e.g., Mamba LLM architectures), and/or others. As such, depending on the embodiment and architecture, the embedding component 1920 may apply an encoded representation of the input 1901 to the generative LM 1930, and the generative LM 1930 may process the encoded representation of the input 1901 to generate an output 1990, which may include responsive text and/or other types of data.

As described herein, in some embodiments, the generative LM 1930 may be configured to access or use- or capable of accessing or using-plug-ins/APIs 1995 (which may include one or more plug-ins, application programming interfaces (APIs), databases, data stores, repositories, etc.). For example, for certain tasks or operations that the generative LM 1930 is not ideally suited for, the model may have instructions (e.g., as a result of training, and/or based on instructions in a given prompt, such as those retrieved using the RAG component 1992) to access one or more plug-ins/APIs 1995 (e.g., 3rd party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 1995 to the plug-in/API 1995, the plug-in/API 1995 may process the information and return an answer to the generative LM 1930, and the generative LM 1930 may use the response to generate the output 1990. This process may be repeated—e.g., recursively—for any number of iterations and using any number of plug-ins/APIs 1995 until an output 1990 that addresses each ask/question/request/process/operation/etc. from the input 1901 can be generated. As such, the model(s) may not only rely on its own knowledge from training on a large dataset(s) and/or from data retrieved using the RAG component 1992, but also on the expertise or optimized nature of one or more external resources—such as the plug-ins/APIs 1995.

In some embodiments, one or more transformer engines (TEs) may be implemented. The transformer engine may use micro-tensor scaling to optimize performance and accuracy—such as to enable 16-bit floating point (FP16), 8-bit floating point (FP8), and/or 4-bit floating point (FP4) artificial intelligence processing. For example, the transformer engine may use 16-bit or 8-bit floating point precision and an 8-bit or 4-bit floating point data format combined with software algorithms for increasing AI performance and capabilities. By reducing math operations to 8-bits or 4-bits, the TE allows for training larger networks faster without compromising accuracy. For example, the TEs may include a library for accelerating transformer models on processing devices—such as GPUs—to provide better performance with lower memory utilization in both training and inference. When the TE is combined with other technologies, such as high-speed interconnects between nodes (e.g., using switches—such as NVLink or ultra accelerator Link (UALink) Switches) and tensor cores (which enable mixed-precision computing, such as micro-scaling precision support), server clusters may be more capable of training enormous networks (e.g., billions of parameters) at high speeds. As such, tensor core precisions of FP64, TF32, BF16, FP16, FP8, INT8, FP6, and FP4 may be supported, as well as CUDA core precisions of FP64, FP32, FP16, and BF16.

These and other architectures for LLMs/VLMs/MMLMs/VLAs/etc. described herein are meant simply as examples, and other suitable architectures may be implemented within the scope of the present disclosure.

### Example Computing Device

FIG. 20 is a block diagram of an example computing device(s) 2000 suitable for use in implementing some embodiments of the present disclosure. Computing device 2000 may include an interconnect system 2002 that directly or indirectly couples the following devices: memory 2004, one or more central processing units (CPUs) 2006, one or more graphics processing units (GPUs) 2008, a communication interface 2010, input/output (I/O) ports 2012, input/output components 2014, a power supply 2016, one or more presentation components 2018 (e.g., display(s), speaker(s), etc.), and one or more logic units 2020. In at least one embodiment, the computing device(s) 2000 may comprise one or more virtual machines (VMs), and/or any of the components thereof may comprise virtual components (e.g., virtual hardware components). For non-limiting examples, one or more of the GPUs 2008 may comprise one or more vGPUs, one or more of the CPUs 2006 may comprise one or more vCPUs, and/or one or more of the logic units 2020 may comprise one or more virtual logic units. As such, a computing device(s) 2000 may include discrete components (e.g., a full GPU dedicated to the computing device 2000), virtual components (e.g., a portion of a GPU dedicated to the computing device 2000), or a combination thereof.

Although the various blocks of FIG. 20 are shown as connected via the interconnect system 2002 with lines, this is not intended to be limiting and is for clarity only. For example, in some embodiments, a presentation component 2018, such as a display device, may be considered an I/O component 2014 (e.g., if the display is a touch screen). As another example, the CPUs 2006 and/or GPUs 2008 may include memory (e.g., the memory 2004 may be representative of a storage device in addition to the memory of the GPUs 2008, the CPUs 2006, and/or other components). As such, the computing device of FIG. 20 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 20.

The interconnect system 2002 may represent one or more links or busses, such as an address bus, a data bus, a control bus, or a combination thereof. The interconnect system 2002 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 2006 may be directly connected to the memory 2004. Further, the CPU 2006 may be directly connected to the GPU 2008. Where there is direct, or point-to-point connection between components, the interconnect system 2002 may include a PCIe link to carry out the connection. In these examples, a PCI bus need not be included in the computing device 2000.

The memory 2004 may include any of a variety of computer-readable media. The computer-readable media may be any available media that may be accessed by the computing device 2000. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 2004 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 2000. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 2006 may be configured to execute at least some of the computer-readable instructions to control one or more components of the computing device 2000 to perform one or more of the methods and/or processes described herein. The CPU(s) 2006 may each include one or more cores (e.g., one, two, four, eight, twenty-eight, seventy-two, etc.) that are capable of handling a multitude of software threads simultaneously. The CPU(s) 2006 may include any type of processor, and may include different types of processors depending on the type of computing device 2000 implemented (e.g., processors with fewer cores for mobile devices and processors with more cores for servers). For example, depending on the type of computing device 2000, the processor may be an Advanced RISC Machines (ARM) processor implemented using Reduced Instruction Set Computing (RISC) or an x86 processor implemented using Complex Instruction Set Computing (CISC). The computing device 2000 may include one or more CPUs 2006 in addition to one or more microprocessors or supplementary co-processors, such as math co-processors.

In addition to or alternatively from the CPU(s) 2006, the GPU(s) 2008 may be configured to execute at least some of the computer-readable instructions to control one or more components of the computing device 2000 to perform one or more of the methods and/or processes described herein. One or more of the GPU(s) 2008 may be an integrated GPU (e.g., with one or more of the CPU(s) 2006 and/or one or more of the GPU(s) 2008 may be a discrete GPU. In embodiments, one or more of the GPU(s) 2008 may be a coprocessor of one or more of the CPU(s) 2006. The GPU(s) 2008 may be used by the computing device 2000 to render graphics (e.g., 3D graphics) or perform general purpose computations. For example, the GPU(s) 2008 may be used for General-Purpose computing on GPUs (GPGPU). The GPU(s) 2008 may include hundreds or thousands of cores that are capable of handling hundreds or thousands of software threads simultaneously. The GPU(s) 2008 may generate pixel data for output images in response to rendering commands (e.g., rendering commands from the CPU(s) 2006 received via a host interface). The GPU(s) 2008 may include graphics memory, such as display memory, for storing pixel data or any other suitable data, such as GPGPU data. The display memory may be included as part of the memory 2004. The GPU(s) 2008 may include two or more GPUs operating in parallel (e.g., via a link). The link may directly connect the GPUs (e.g., using NVLink, ultra accelerator Link (UALink), etc.) or may connect the GPUs through a switch (e.g., using NVSwitch). When combined together, each GPU 2008 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 2006 and/or the GPU(s) 2008, the logic unit(s) 2020 may be configured to execute at least some of the computer-readable instructions to control one or more components of the computing device 2000 to perform one or more of the methods and/or processes described herein. In embodiments, the CPU(s) 2006, the GPU(s) 2008, and/or the logic unit(s) 2020 may discretely or jointly perform any combination of the methods, processes and/or portions thereof. One or more of the logic units 2020 may be part of and/or integrated in one or more of the CPU(s) 2006 and/or the GPU(s) 2008 and/or one or more of the logic units 2020 may be discrete components or otherwise external to the CPU(s) 2006 and/or the GPU(s) 2008. In embodiments, one or more of the logic units 2020 may be a coprocessor of one or more of the CPU(s) 2006 and/or one or more of the GPU(s) 2008.

Examples of the logic unit(s) 2020 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Deep Learning Accelerator Clusters (XNNs), Neural Processing Units (NPUs), Neural Network Accelerators (NNAs), Programmable Vision Accelerators (PVAs)—which may include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 2010 may include one or more receivers, transmitters, and/or transceivers that allow the computing device 2000 to communicate with other computing devices via an electronic communication network, included wired and/or wireless communications. The communication interface 2010 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 2020 and/or communication interface 2010 may include one or more data processing units (DPUs) to transmit data received over a network and/or through interconnect system 2002 directly to (e.g., a memory of) one or more GPU(s) 2008.

The I/O ports 2012 may allow the computing device 2000 to be logically coupled to other devices including the I/O components 2014, the presentation component(s) 2018, and/or other components, some of which may be built in to (e.g., integrated in) the computing device 2000. Illustrative I/O components 2014 include a microphone, mouse, keyboard, joystick, game pad, game controller, satellite dish, scanner, printer, wireless device, etc. The I/O components 2014 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 2000. The computing device 2000 may be include depth cameras, such as stereoscopic camera systems, infrared camera systems, RGB camera systems, touchscreen technology, and combinations of these, for gesture detection and recognition. Additionally, the computing device 2000 may include accelerometers or gyroscopes (e.g., as part of an inertia measurement unit (IMU)) that allow detection of motion. In some examples, the output of the accelerometers or gyroscopes may be used by the computing device 2000 to render immersive augmented reality or virtual reality.

The power supply 2016 may include a hard-wired power supply, a battery power supply, or a combination thereof. The power supply 2016 may provide power to the computing device 2000 to allow the components of the computing device 2000 to operate.

The presentation component(s) 2018 may include a display (e.g., a monitor, a touch screen, a television screen, a heads-up-display (HUD), other display types, or a combination thereof), speakers, and/or other presentation components. The presentation component(s) 2018 may receive data from other components (e.g., the GPU(s) 2008, the CPU(s) 2006, DPUs, etc.), and output the data (e.g., as an image, video, sound, etc.).

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 2000 of FIG. 20—e.g., each device may include similar components, features, and/or functionality of the computing device(s) 2000. In addition, where backend devices (e.g., servers, NAS, etc.) are implemented, the backend devices may be included as part of a data center (such as, but not limited to, those described herein).

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment- and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 2000 described herein with respect to FIG. 20. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a talking kiosk, a remote control, an appliance, a consumer electronic device, a workstation, an edge device, any combination of these delineated devices, or any other suitable device.

### Example Clauses

The system can include one or more processors to generate, based on a combination of a first action policy for a plurality of robots and a plurality of second action policies, a third action policy for the plurality of robots, wherein each of the plurality of second action policies is for one type of the plurality of robots. The one or more processors can determine a state and an identifier of at least one of the plurality of robots, the identifier indicative of a type of the at least one of the plurality of robots. The one or more processors can generate, using the third action policy, based on the state and the identifier, at least one third action for the at least one of the plurality of robots, wherein the state and the identifier are input into the third action policy and the third action policy outputs the at least one third action. The one or more processors can transmit the at least one third action to the at least one of the plurality of robots, the at least one of the plurality of robots to move based on the at least one third action.

In various embodiments, the first action policy is updated using imitation learning and a world model, the first action policy to receive at least one state of at least one of the plurality of robots as an input and output a first action to move the at least one of the plurality of robots. The plurality of second action policies can be updated using residual reinforcement learning, the plurality of second action policies to receive at least one state of at least one of the plurality of robots as an input and output a second action to move the at least one of the plurality of robots. The plurality of second action policies can be updated based on the first action policy, the second action a combination of the first action and a fourth action, the fourth action to adapt the first action to the type of the at least one of the plurality of robots.

In various embodiments, to generate the third action policy, the combination of the first action policy and the plurality of second action policies can be distilled. To generate the third action policy, the one or more processors can generate, using the plurality of second action policies, a plurality of second actions for the at least one of the plurality of robots by inputting a plurality of states into the plurality of second action policies. The one or more processors can generate, using each of the plurality of second action policies, a plurality of normal distributions over the plurality of second actions. The one or more processors can combine the plurality of normal distributions. The one or more processors can distill the combination of the plurality of normal distributions into the third action policy by at least minimizing a divergence of the combination of the plurality of normal distributions.

In various embodiments, the state of the robot includes at least one of an environment of the robot, velocities of each joint of the robot, or a goal of the robot. The identifier of the type of the at least one of the plurality of robots can be an embedding, and can be same for robots of the plurality of robots of a same type. The at least one third action can include a plurality of velocity commands each corresponding to a joint of the at least one of the plurality of robots. To execute the at least one third action, each of the plurality of velocity commands can be mapped to a respective joint of the at least one of the plurality of robots. The type of the at least one of the plurality of robots can include at least one of humanoid, wheeled, or quadruped robots.

In various embodiments, the one or more processors are included in at least one of: a control system for an autonomous or semi-autonomous machine, a perception system for an autonomous or semi-autonomous machine, a system for performing one or more simulation operations, a system for performing one or more digital twin operations, a system for performing light transport simulation, a system for performing collaborative content creation for 3D assets, a system for performing one or more deep learning operations, a system implemented using an edge device, a system implemented using a robot, a system for performing one or more generative AI operations, a system for performing operations using one or more large language model (LLMs), a system for performing operations using one or more vision language models (VLMs), a system for performing operations using one or more multi-modal language models (MMLMs), a system for performing operations using one or more vision-language-action (VLA) models, a system for using or deploying one or more inference microservices, a system for performing one or more conversational AI operations, a system for generating synthetic data, a system for presenting at least one of virtual reality content, augmented reality content, or mixed reality content, a system incorporating one or more virtual machines (VMs), a system implemented at least partially in a data center, or a system implemented at least partially using cloud computing resources.

The systems and methods of the present disclosure include at least one method. The method can include determining, by one or more processors, a state and embedding of a robot, the state determined using a world model and the embedding indicative of a type of the robot. The method can include generating, by the one or more processors, using an action policy for a plurality of types of robots, a plurality of commands for each joint of the robot, where the state and the embedding are input into the action policy, and the action policy outputs the plurality of commands based on the state and the embedding, where the action policy includes a distilled combination of a plurality of robot type-specific action policies, where each of the plurality of robot type-specific action policies correspond to one type of the plurality of types of robots. The method can include transmitting, by the one or more processors, the plurality of commands to each joint of the robot to direct and move the robot.

In various embodiments, to generate the action policy, the method can further include generating, by the one or more processors, using each of the plurality of robot type-specific action policies, a plurality of normal distributions over a plurality of robot type-specific actions, where a plurality of states are input into each of the plurality of robot type-specific action policies and each of the plurality of robot type-specific action policies output the plurality of robot type-specific actions. The method can include combining, by the one or more processors, the plurality of normal distributions. The method can include distilling, by the one or more processors, the combination of the plurality of normal distributions into the action policy by at least minimizing a divergence of the combination of the plurality of normal distributions. The plurality of robot type-specific action policies can be updated using reinforcement learning, the one or more processors further to, during the reinforcement learning, record an input and an output for each of the plurality of robot type-specific action policies, the input and the output used to generate the plurality of normal distributions.

In various embodiments, weights of the plurality of robot type-specific action policies are updated to convergence and frozen prior to generating the plurality of normal distributions, the plurality of robot type-specific action policies updated using a base model updated using imitation learning and the world model, where weights of the base model are frozen prior to updating the plurality of robot type-specific action policies.

Systems and methods of the present disclosure include one or more processors including processing circuitry. The one or more processors can update weights of a plurality of specialist action policies for a plurality of robot types to convergence, where each of the plurality of specialist action policies correspond to one type of the plurality of robot types, where each of the plurality of specialist action policies receives at least one goal as an input and outputs at least one specialist action, where the at least one specialist action is output using a first action for the plurality of robot types and a second action for one type of the plurality of robot types. The one or more processors can generate a plurality of normal distributions over a plurality of specialist actions for each of the plurality of specialist action policies. The one or more processors can combine the plurality of normal distributions into a general action policy for the plurality of robot types, where the general action policy receives a state and type of a robot and outputs an action for the robot. The one or more processors can generate, using the general action policy, the action for the robot. The one or more processors can transmit the action on the robot to move the robot.

In various embodiments, the first action is generating using imitation learning and a world model, the world model to provide at least environment information. The plurality of specialist action policies can be updated to convergence and frozen in parallel or sequentially. The second action can be generated using residual reinforcement learning. The residual reinforcement learning can include at least one reward, the one or more processors further to generate the at least one reward based on results of the at least one specialist action, the results including at least one of a progress to the at least one goal, collision avoidance, and completion of the at least one goal, the at least one reward used to update the plurality of specialist action policies.

In various embodiments, the one or more processors can be in at least one of: a control system for an autonomous or semi-autonomous machine, a perception system for an autonomous or semi-autonomous machine, a system for performing one or more simulation operations, a system for performing one or more digital twin operations, a system for performing light transport simulation, a system for performing collaborative content creation for 3D assets, a system for performing one or more deep learning operations, a system implemented using an edge device, a system implemented using a robot, a system for performing one or more generative AI operations, a system for performing operations using one or more large language model (LLMs), a system for performing operations using one or more vision language models (VLMs), a system for performing operations using one or more multi-modal language models (MMLMs), a system for performing operations using one or more vision-language-action (VLA) models, a system for using or deploying one or more inference microservices, a system for performing one or more conversational AI operations, a system for generating synthetic data, a system for presenting at least one of virtual reality content, augmented reality content, or mixed reality content, a system incorporating one or more virtual machines (VMs), a system implemented at least partially in a data center or a system implemented at least partially using cloud computing resources.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A system comprising one or more processors to:
determine a state and an identifier of a robot, the identifier indicating a type of robot, from a plurality of types of robots, corresponding to the robot;
generate, based at least on a generalist action policy processing the state and the identifier, at least one action for the robot, wherein the generalist action policy was generated using a combination of a base action policy corresponding to the plurality of types of robots and one or more specialist action policies individually corresponding to different robot types of the plurality of types of robots; and
cause the robot to move according to the at least one action.

2. The system of claim 1, wherein:
the base action policy is updated using imitation learning and a world model, the base action policy to receive at least one state of the robot as an input and output a base action to move the robot, and
the one or more specialist action policies are updated using residual reinforcement learning, the one or more specialist action policies to receive the at least one state of the robot as an input and output a specialist action to move the robot.

3. The system of claim 2, wherein the one or more specialist action policies are updated based at least on the base action policy, the specialist action being a combination of the base action and a residual action, the residual action to adapt the base action to a robot type of the robot.

4. The system of claim 1, wherein to generate the generalist action policy the combination of the base action policy and the one or more specialist action policies is distilled.

5. The system of claim 4, wherein to generate the generalist action policy, the one or more processors are to:
generate, using the one or more specialist action policies, a plurality of specialist actions for the robot by inputting a plurality of states into the one or more specialist action policies;
generate, using each of the one or more specialist action policies, a plurality of normal distributions over the plurality of specialist actions;
combine the plurality of normal distributions; and
distill the combination of the plurality of normal distributions into the generalist action policy by at least minimizing a divergence of the combination of the plurality of normal distributions.

6. The system of claim 1, wherein the state comprises at least one of an environment of a robot, velocities of each joint of the robot, or a goal of the robot.

7. The system of claim 1, wherein the identifier corresponds to an embedding in an embedding space that identifies the robot as the type of robot from the plurality of types of robots.

8. The system of claim 1, wherein:
the at least one action comprises a plurality of velocity commands each corresponding to a joint of the robot, and
to execute the at least one action, each of the plurality of velocity commands are mapped to a respective joint of the robot.

9. The system of claim 1, wherein the plurality of types of robots includes at least a humanoid robot, an autonomous mobile robot (AMR), a wheeled robot, a warehouse vehicle or machine, or a quadruped robot.

10. The system of claim 1, wherein the one or more processors are comprised in at least one of:
a control system for an autonomous or semi-autonomous machine;
a perception system for an autonomous or semi-autonomous machine;
a system for performing one or more simulation operations;
a system for performing one or more digital twin operations;
a system for performing one or more light transport simulation;
a system for performing collaborative content creation for 3D assets;
a system for performing one or more wireless cellular transmissions using a wireless cellular network;
a system that provides one or more cloud gaming applications;
a system for performing one or more deep learning operations;
a system implemented using an edge device;
a system implemented using a robot;
a system for performing one or more generative AI operations;
a system for performing one or more conversational AI operations;
a system for performing operations using one or more large language models (LLMs);
a system for performing operations using one or more vision language models (VLMs);
a system for performing operations using one or more multi-modal language models (MMLMs);
a system for performing operations using one or more vision-language-action (VLA) models;
a system for performing one or more conversational AI operations;
a system for performing one or more synthetic data generation operations;
a system for presenting at least one of virtual reality content, augmented reality content, or mixed reality content;
systems using or deploying one or more inference microservices;
systems that incorporate deploy one or more machine learning models in a service or microservice along with an OS-level virtualization package (e.g., a container);
a system incorporating one or more virtual machines (VMs);
a system implemented at least partially in a data center; or
a system implemented at least partially using cloud computing resources.

11. A method, comprising:
determining, using one or more processors, a state and an embedding corresponding to a robot, the state determined using a world model and the embedding indicative of a type of the robot;
generating, using the one or more processors and based at least on an action policy trained for deployment on a plurality of types of robots, a plurality of commands for individual joints of the robot, the state and the embedding being processed using the action policy to generate the plurality of commands; and
transmitting, using the one or more processors, the plurality of commands to the individual joints of the robot to direct and move the robot.

12. The method of claim 11, wherein the action policy comprises a distilled combination of a plurality of robot type-specific action policies, wherein each of the plurality of robot type-specific action policies correspond to one type of the plurality of types of robots wherein, to generate the action policy, the method further comprises:
generating, by the one or more processors, using each of the plurality of robot type-specific action policies, a plurality of normal distributions over a plurality of robot type-specific actions, wherein a plurality of states are input into each of the plurality of robot type-specific action policies and each of the plurality of robot type-specific action policies output the plurality of robot type-specific actions;
combining, by the one or more processors, the plurality of normal distributions; and
distilling, by the one or more processors, the combination of the plurality of normal distributions into the action policy by at least minimizing a divergence of the combination of the plurality of normal distributions.

13. The method of claim 12, wherein the plurality of robot type-specific action policies are updated using reinforcement learning, the one or more processors further to, during the reinforcement learning, record an input and an output for each of the plurality of robot type-specific action policies, the input and the output used to generate the plurality of normal distributions.

14. The method of claim 12, wherein weights of the plurality of robot type-specific action policies are updated to convergence and frozen prior to generating the plurality of normal distributions, the plurality of robot type-specific action policies updated using a base model updated using imitation learning and the world model, wherein weights of the base model are frozen prior to updating the plurality of robot type-specific action policies.

15. One or more processors comprising processing circuitry to:
cause performance of one or more control operations associated with a robot based at least on one or more actions generated using a generalist action policy, the generalist action policy generating the one or more actions (i) while conditioned using an embedding indicating a robot type from a plurality of robot types corresponding to the robot and (ii) based at least on the generalist action policy processing state information corresponding to the robot and an environment of the robot.

16. The one or more processors of claim 15, wherein the generalist action policy is trained using a teacher dataset generated using action outputs and latent states corresponding to specialist action policies associated with individual robot types of the plurality of robot types.

17. The one or more processors of claim 15, wherein the embedding includes a one-hot morphology encoding indicating the robot type.

18. The one or more processors of claim 15, wherein state information is represented using at least a world model.

19. The one or more processors of claim 18, wherein the one or more control operations correspond to one or more joints, actuators, or motors of the robot.

20. The one or more processors of claim 15, wherein the one or more processors are comprised in at least one of:
a control system for an autonomous or semi-autonomous machine;
a perception system for an autonomous or semi-autonomous machine;
a system for performing one or more simulation operations;
a system for performing one or more digital twin operations;
a system for performing one or more light transport simulation;
a system for performing collaborative content creation for 3D assets;
a system for performing one or more wireless cellular transmissions using a wireless cellular network;
a system that provides one or more cloud gaming applications;
a system for performing one or more deep learning operations;
a system implemented using an edge device;
a system implemented using a robot;
a system for performing one or more generative AI operations;
a system for performing one or more conversational AI operations;
a system for performing operations using one or more large language models (LLMs);
a system for performing operations using one or more vision language models (VLMs);
a system for performing operations using one or more multi-modal language models (MMLMs);
a system for performing operations using one or more vision-language-action (VLA) models;
a system for performing one or more conversational AI operations;
a system for performing one or more synthetic data generation operations;
a system for presenting at least one of virtual reality content, augmented reality content, or mixed reality content;
systems using or deploying one or more inference microservices;
systems that incorporate deploy one or more machine learning models in a service or microservice along with an OS-level virtualization package (e.g., a container);
a system incorporating one or more virtual machines (VMs);
a system implemented at least partially in a data center; or
a system implemented at least partially using cloud computing resources.
